(19) United States
(12) Patent Application Publication
(10) Pub. No.: US 2025/0265789 A1
(43) Pub. Date: Aug. 21, 2025

(54) METHODS FOR PERFORMING OPERATIONS TO CHANGE AN APPEARANCE OF AN ENVIRONMENT

(71) Applicant: Apple Inc., Cupertino, CA (US)

(72) Inventors: Matthew D. HOLLANDS, Cambridge (GB); James E. PEDDER, Oxford (GB)

(21) Appl. No.: 19/054,524

(22) Filed: Feb. 14, 2025

Related U.S. Application Data
(60) Provisional application No. 63/554,904, filed on Feb. 16, 2024.

(51) Int. Cl. G06T 19/00; G06F 3/01

(52) U.S. Cl. CPC G06T 19/006; G06F 3/011; G06F 3/017; G06T 2200/24

(57) ABSTRACT

In some embodiments, a computer system performs an operation in an environment in response to detecting an input on a support element of the computer system. For example, the operation changes an appearance of at least a portion of the environment when viewed via an environment viewing component of the computer system.

### CROSS-REFERENCE TO RELATED APPLICATIONS

This application claims the benefit of U.S. Provisional Application No. 63/554,904, filed Feb. 16, 2024, the content of which is incorporated herein by reference in its entirety for all purposes.

### TECHNICAL FIELD

This relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system performs an operation in an environment in response to detecting an input on a support element of the computer system. For example, the operation changes an appearance of at least a portion of the environment when viewed via an environment viewing component of the computer system.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7X illustrate examples of a computer system performing an operation in an environment in response to detecting an input on a support element of the computer system.

FIG. 8 is a flowchart illustrating an exemplary method of performing an operation in an environment in response to detecting an input on a support element of a computer system.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, while an environment is visible via an environment viewing component of a computer system from a current viewpoint of a user of the computer system, the computer system detects, via one or more input devices, a first input on a support element of the computer system corresponding to a request to perform an operation that changes an appearance of at least a portion of the environment when viewed via the environment viewing component. In some embodiments, in response to detecting the first input, in accordance with a determination that the first input includes contact on a first surface of the support element, the computer system performs a first operation that changes an appearance of at least a portion of the environment when viewed via the environment viewing component. In some embodiments, in response to detecting the first input, in accordance with a determination that the first input includes contact on a second surface different from the first surface of the support element, the computer system performs a second operation, different from the first operation, that changes an appearance of at least a portion of the environment when viewed via the environment viewing component.

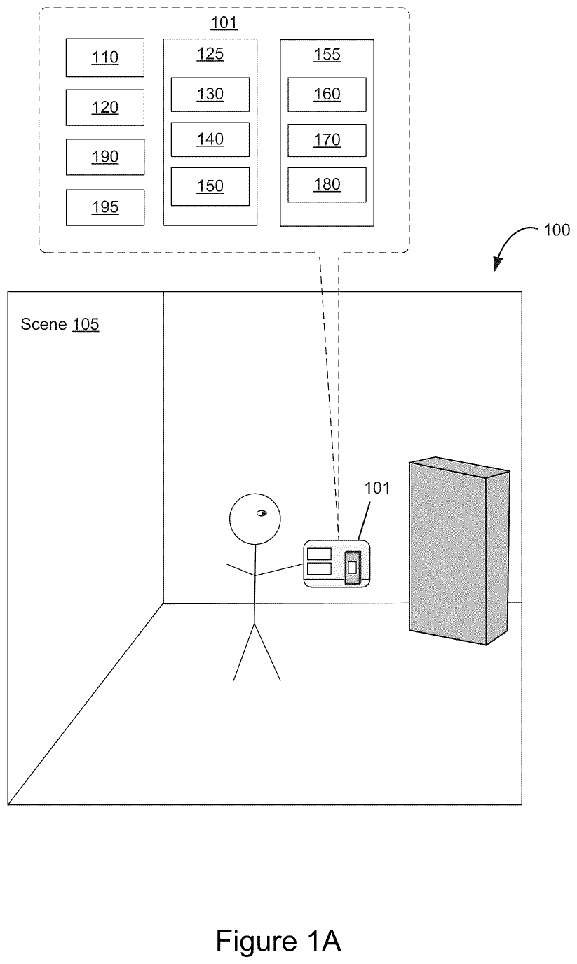

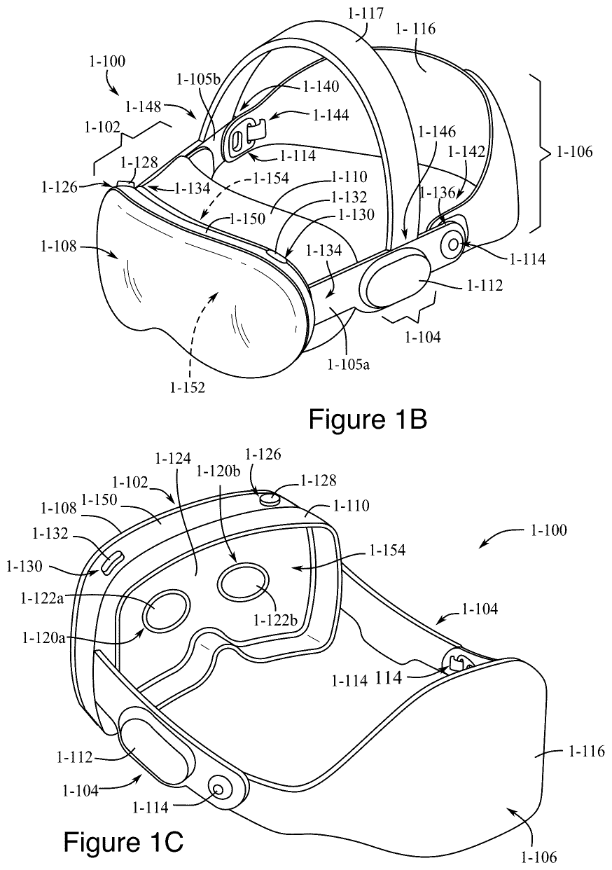

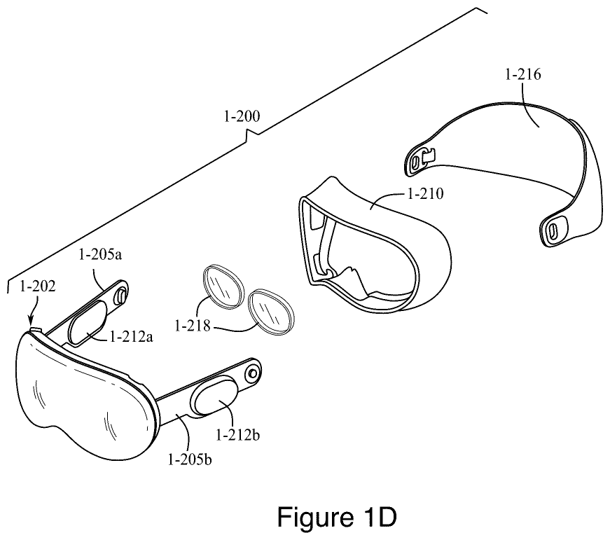

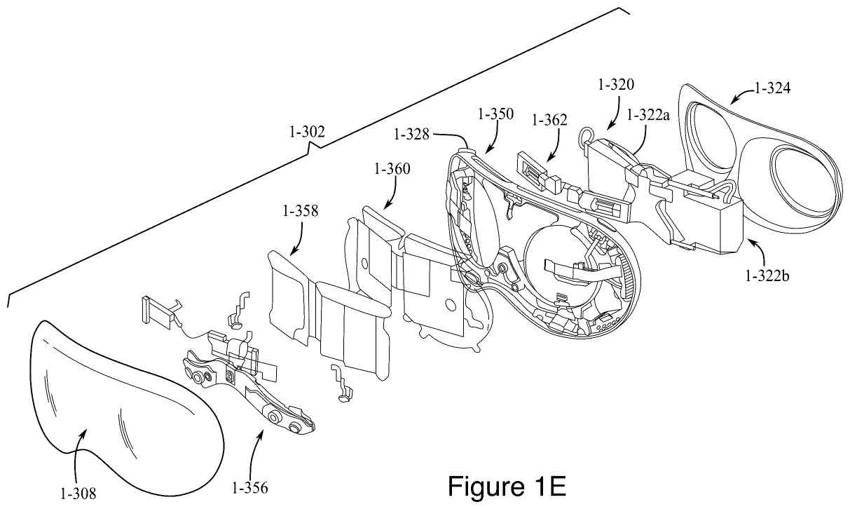

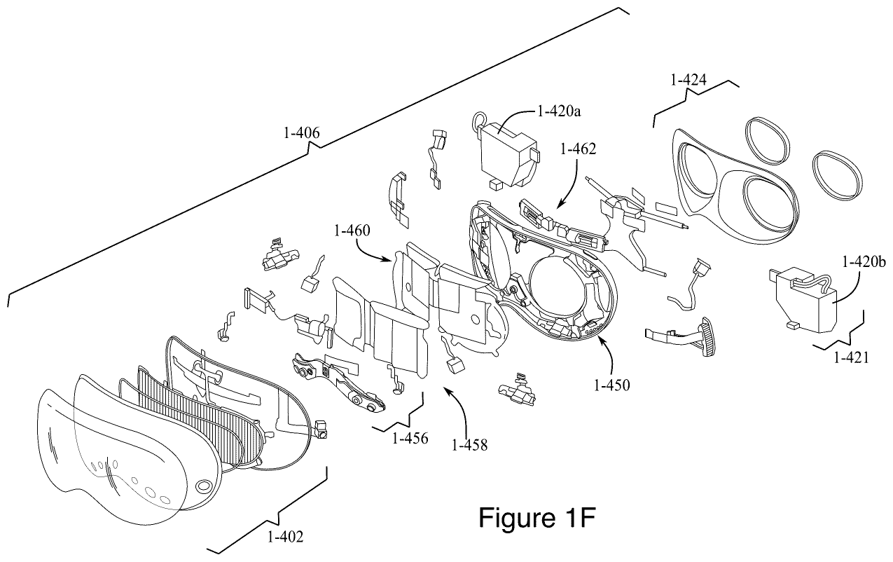

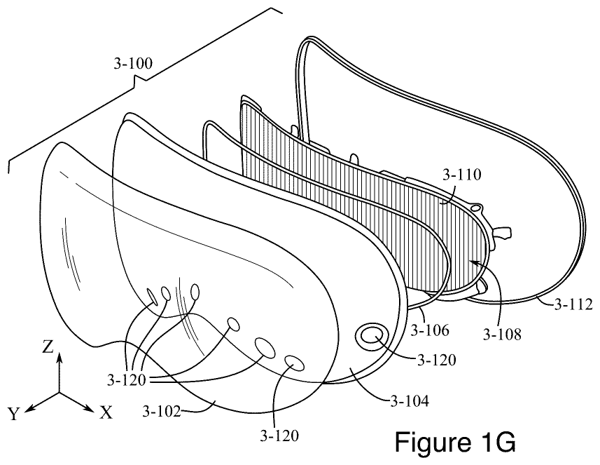

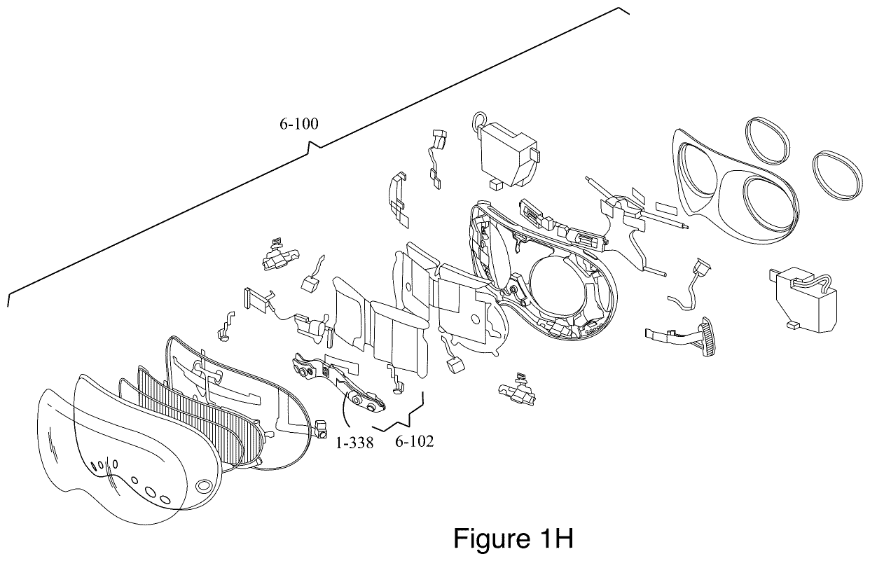

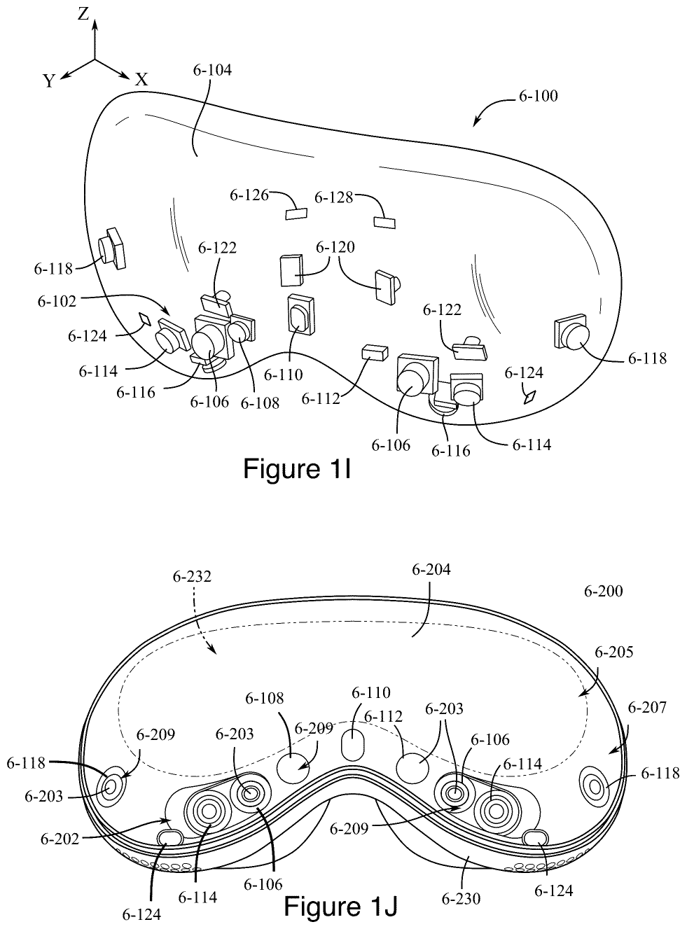

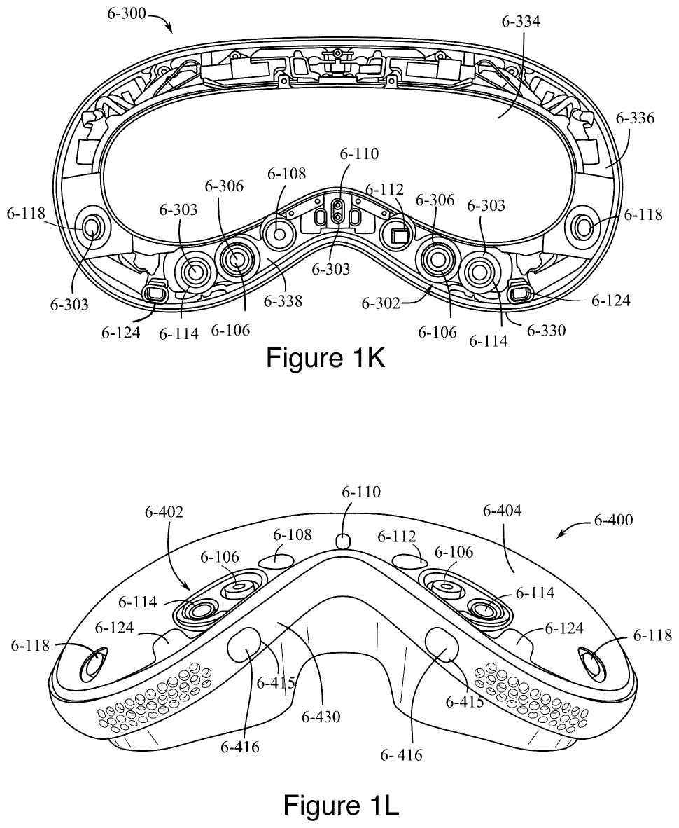

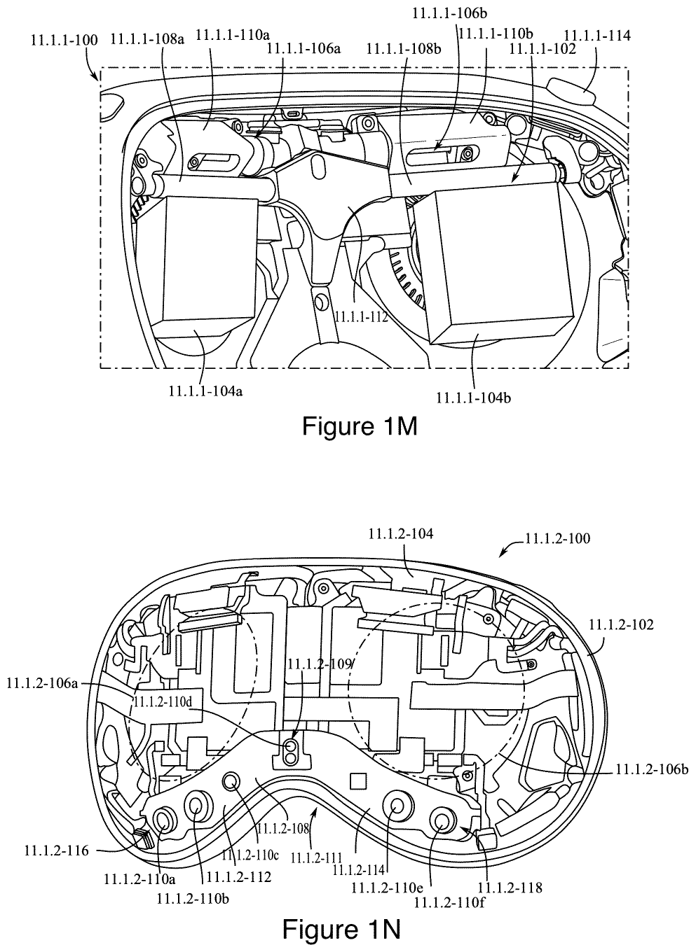

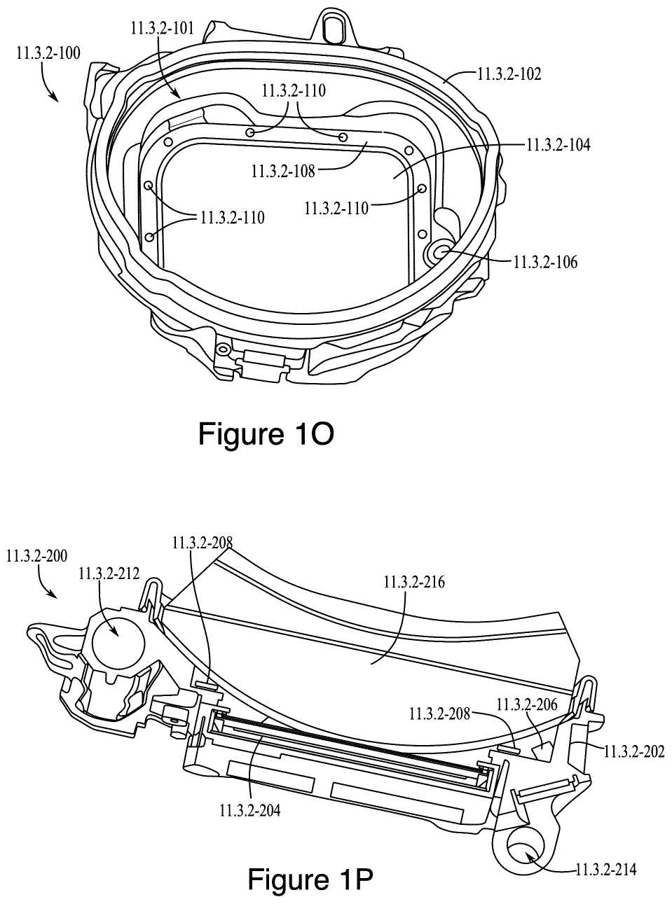

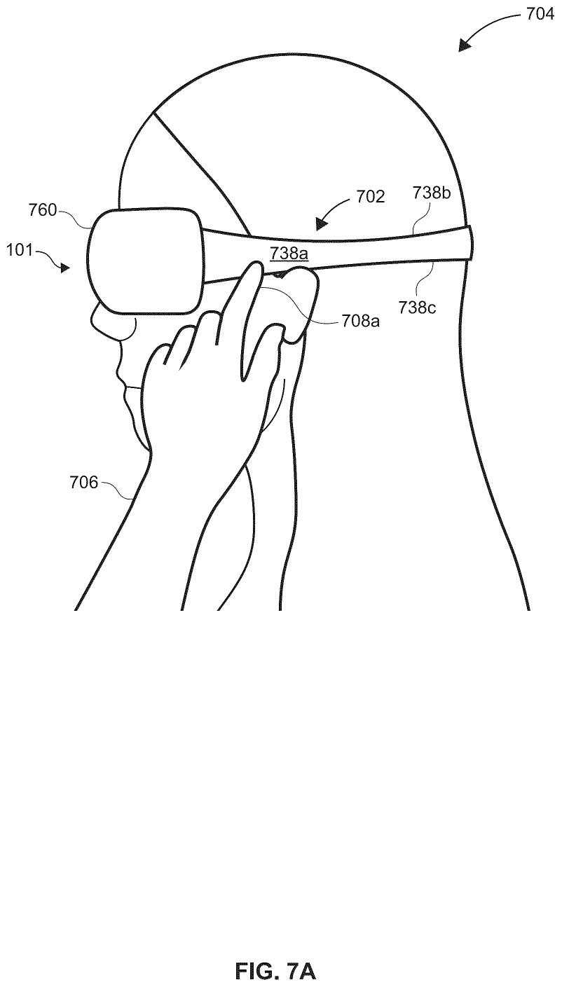

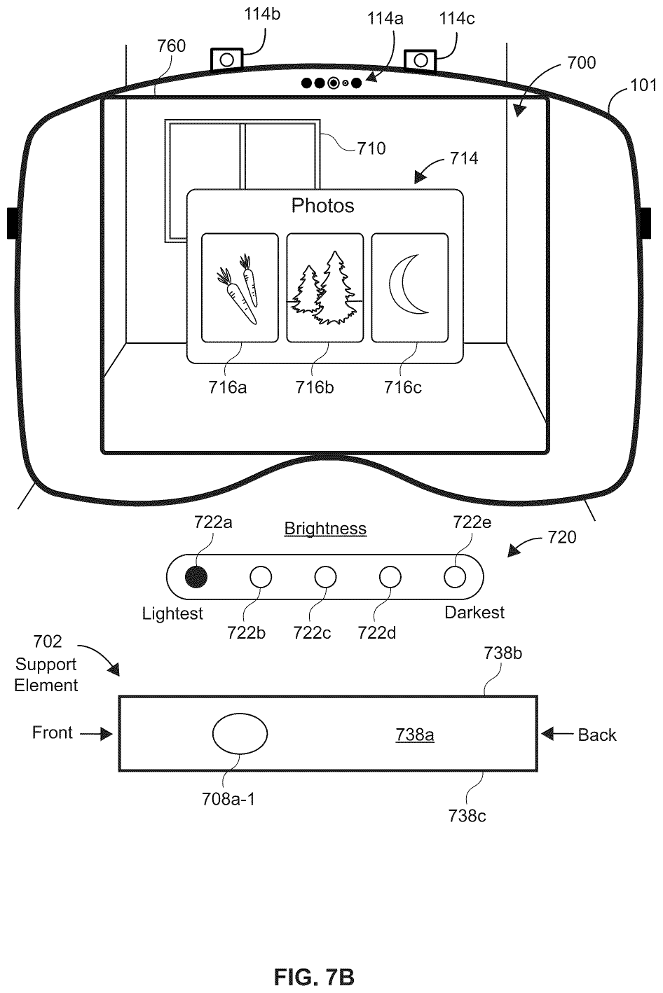

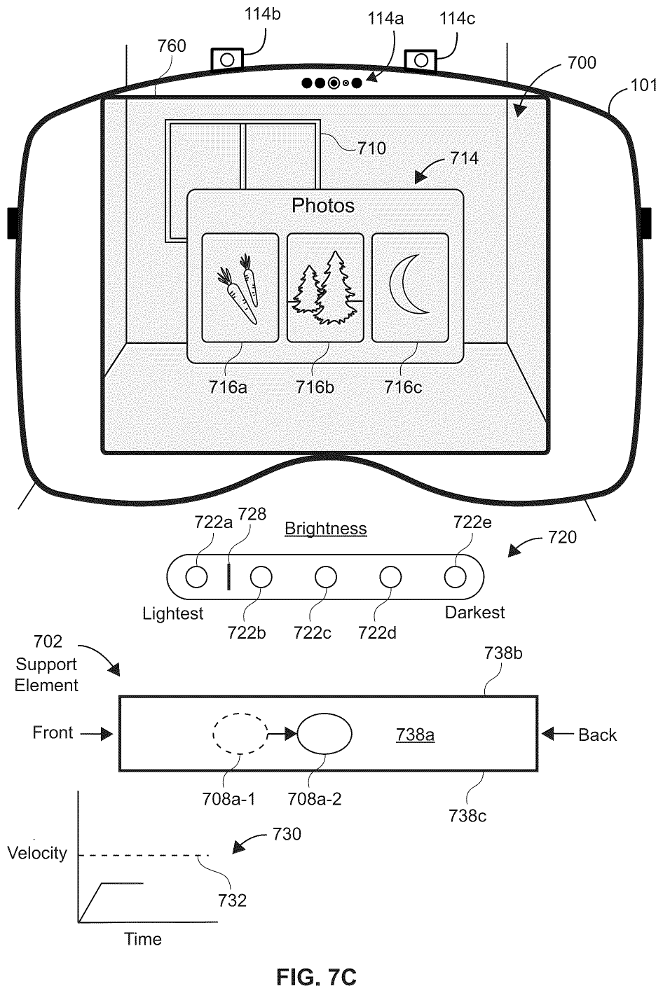

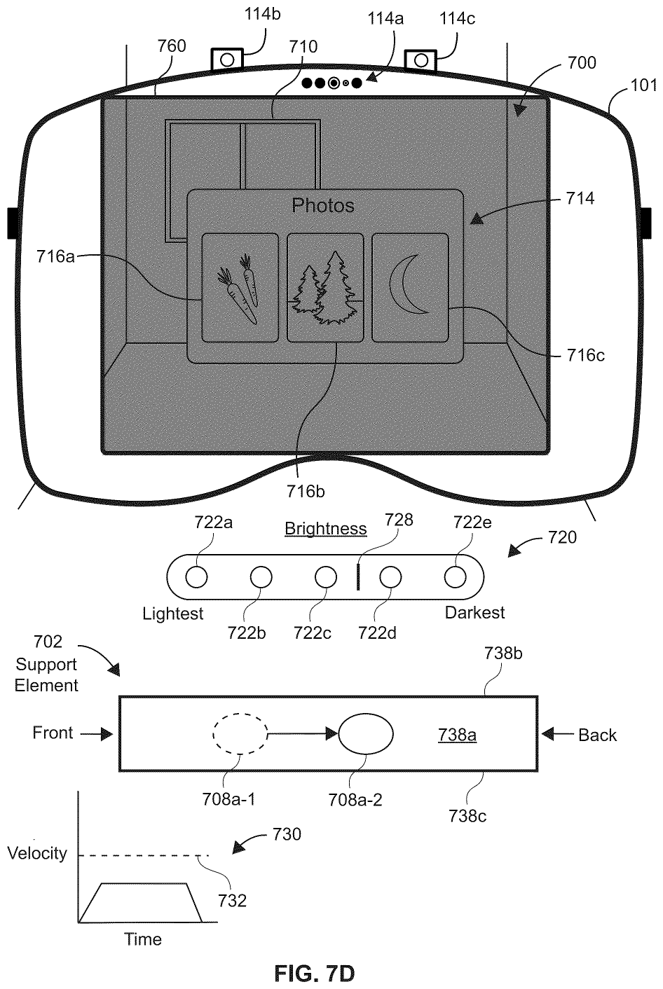

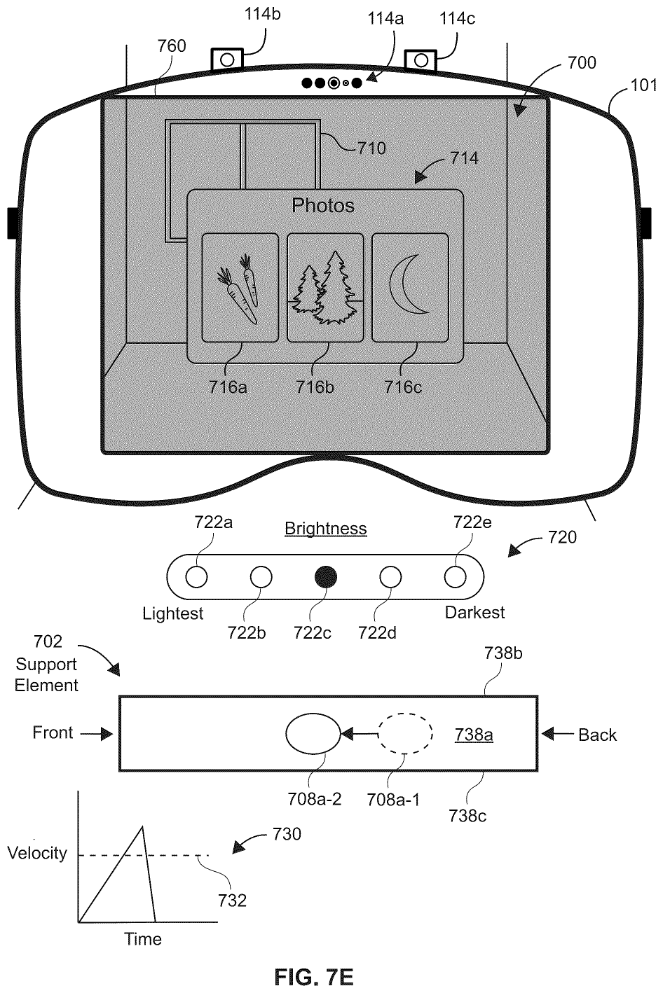

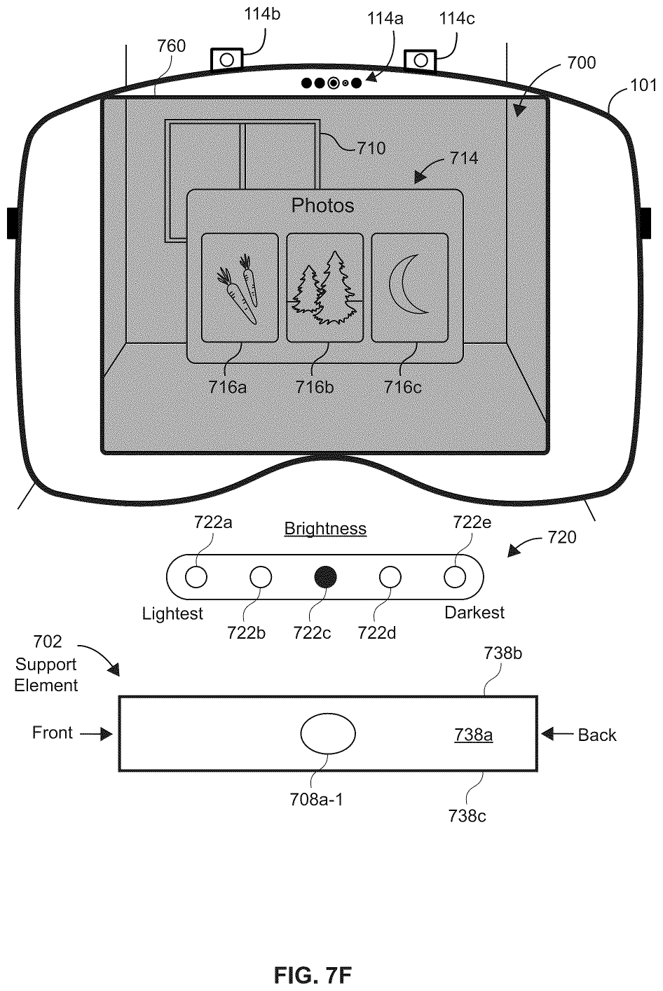

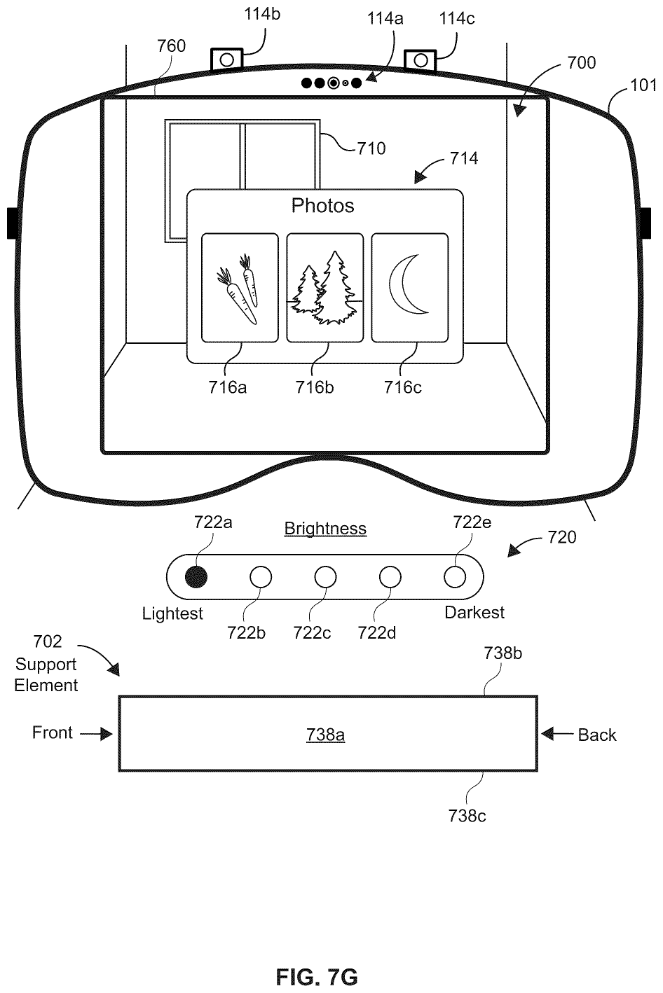

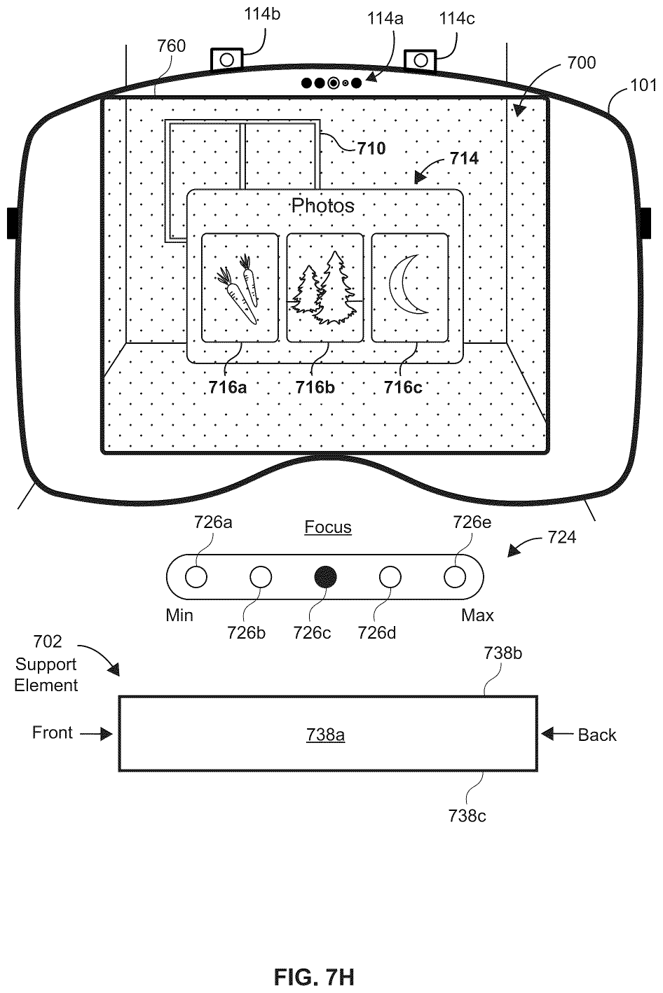

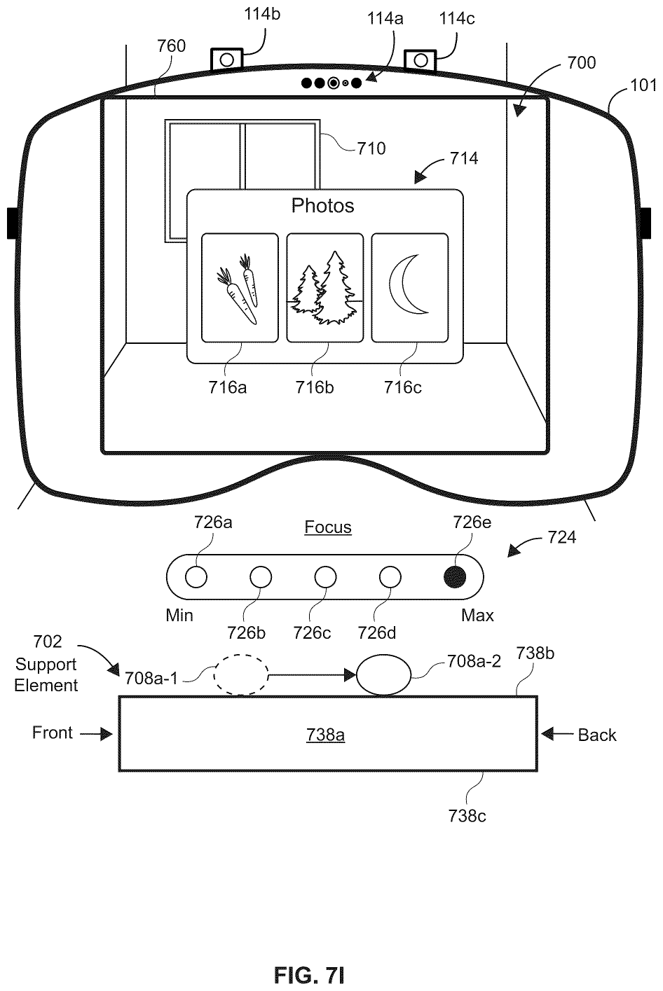

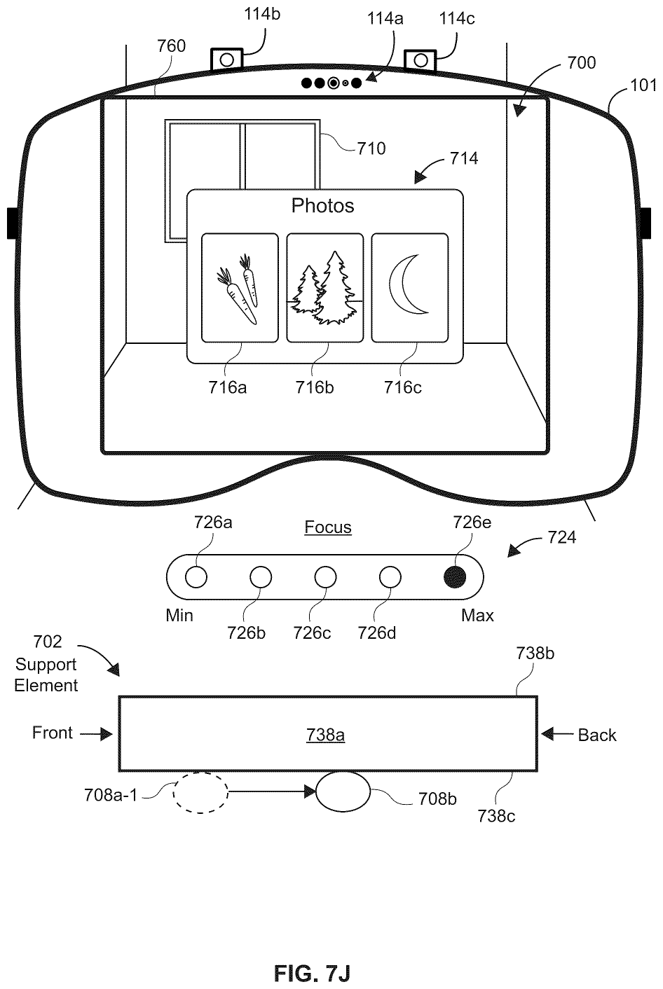

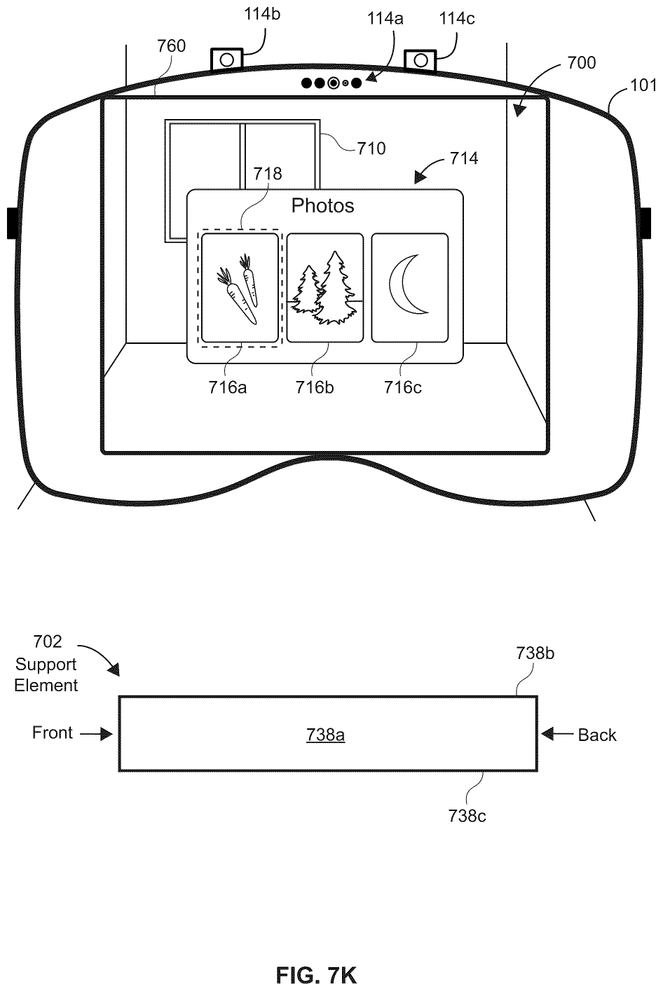

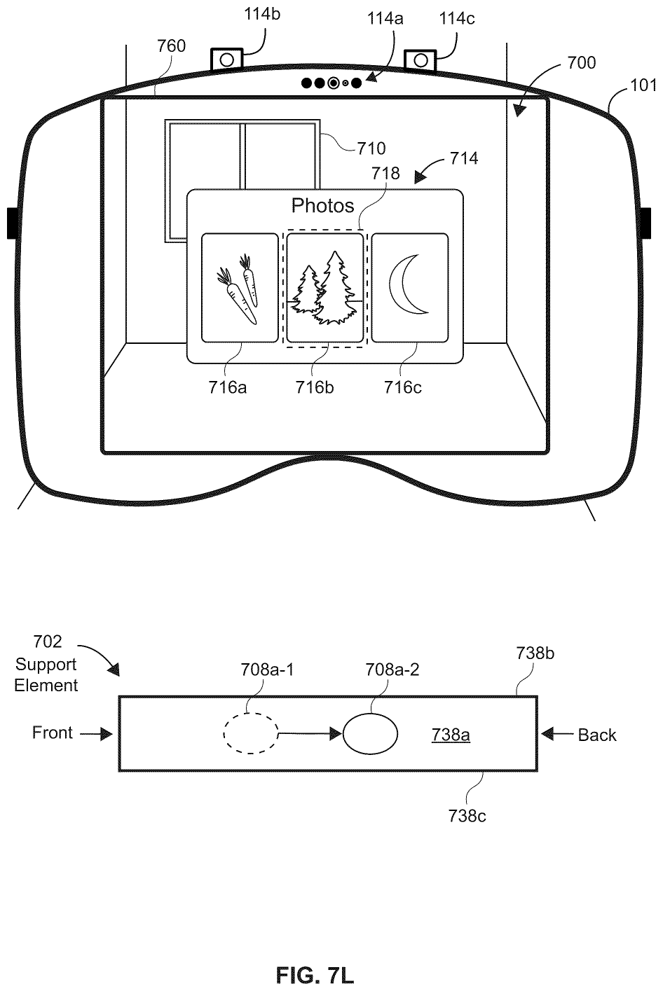

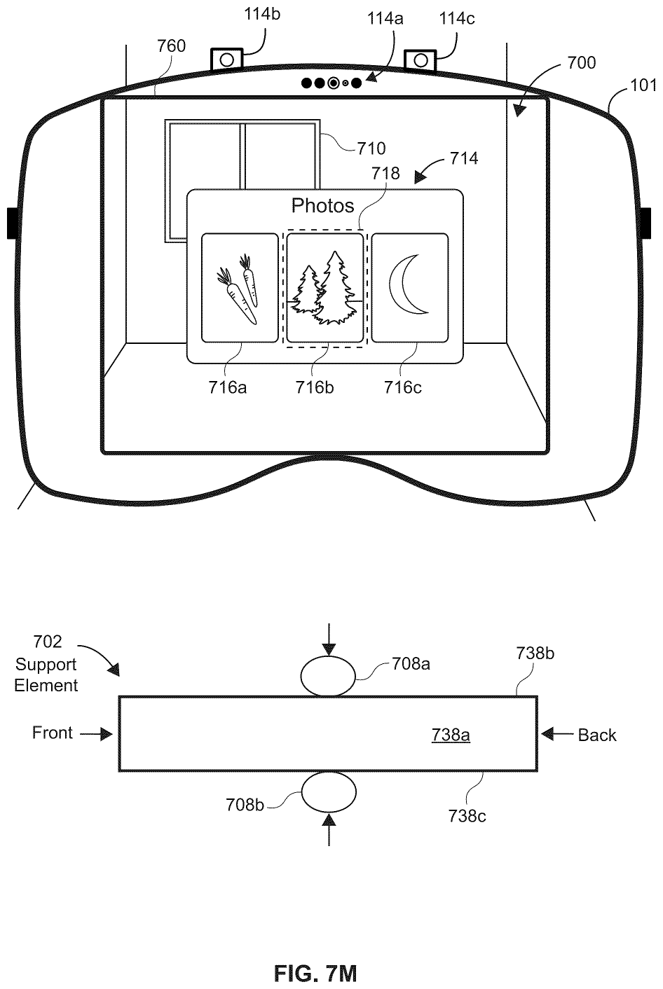

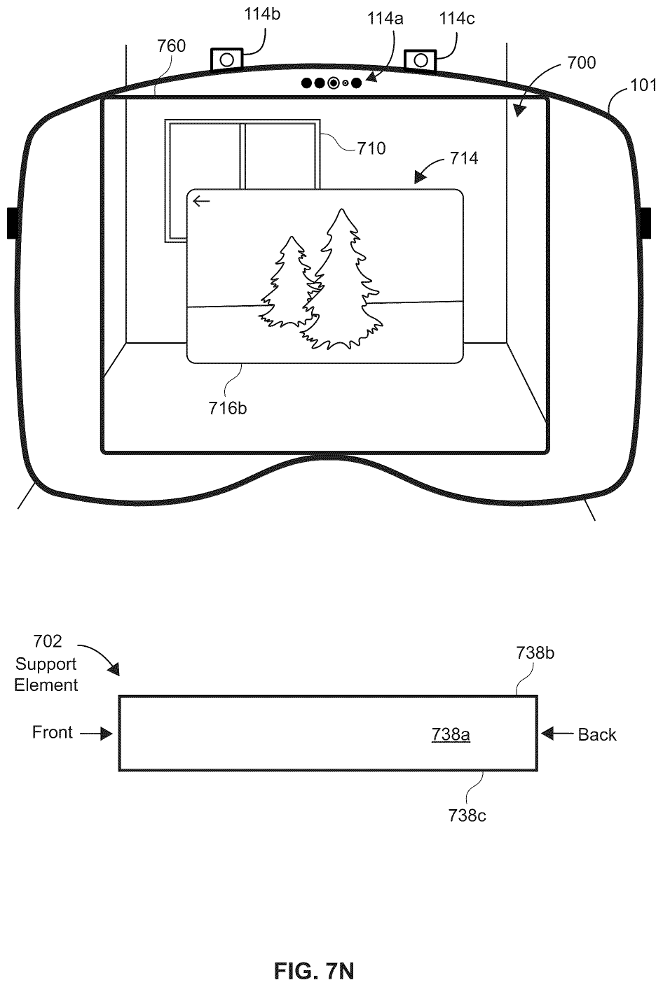

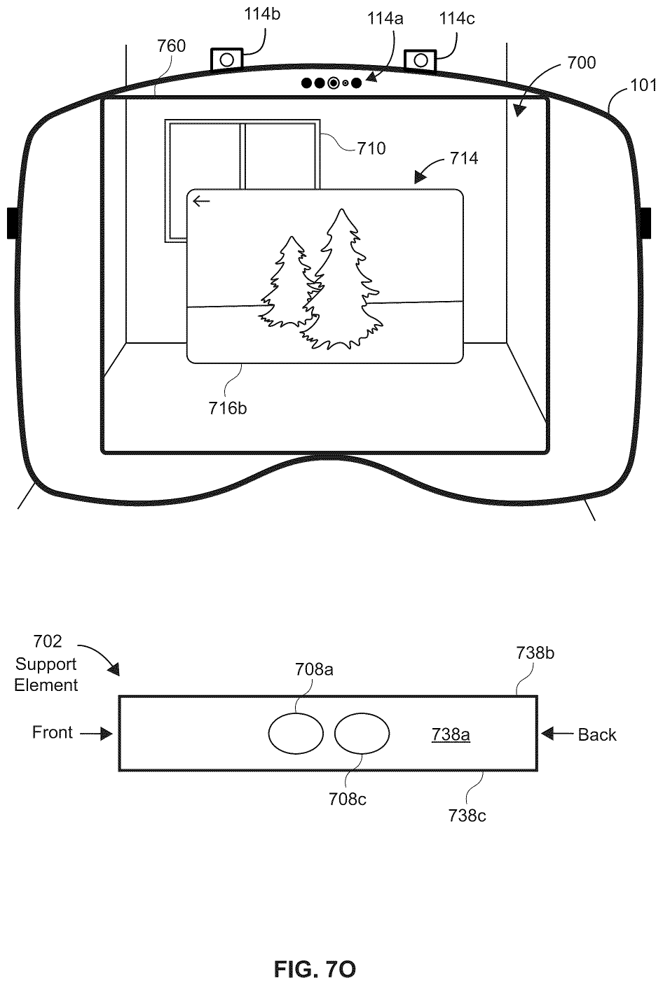

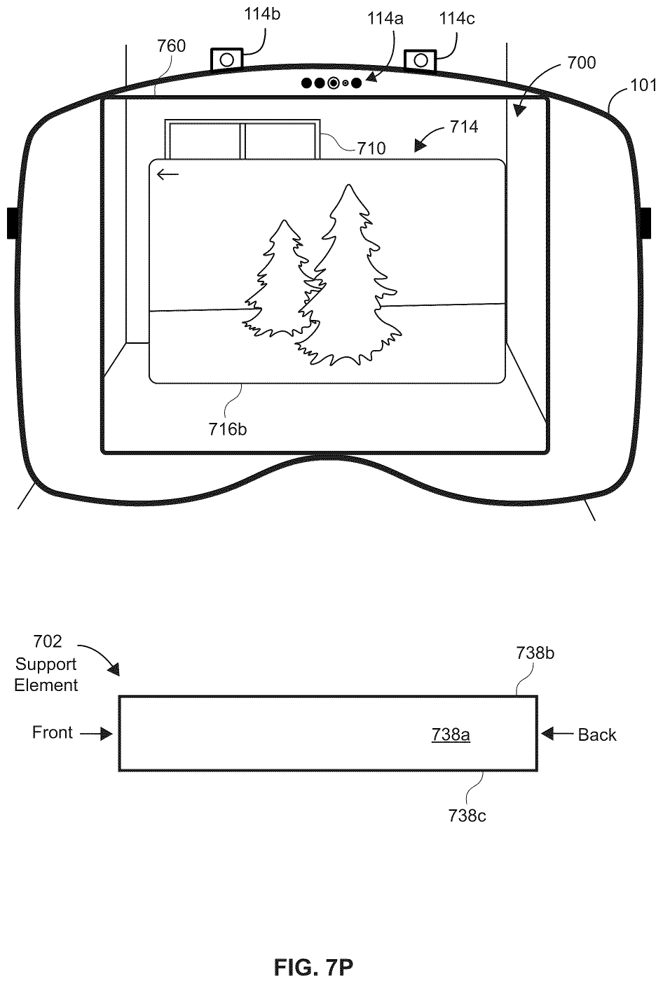

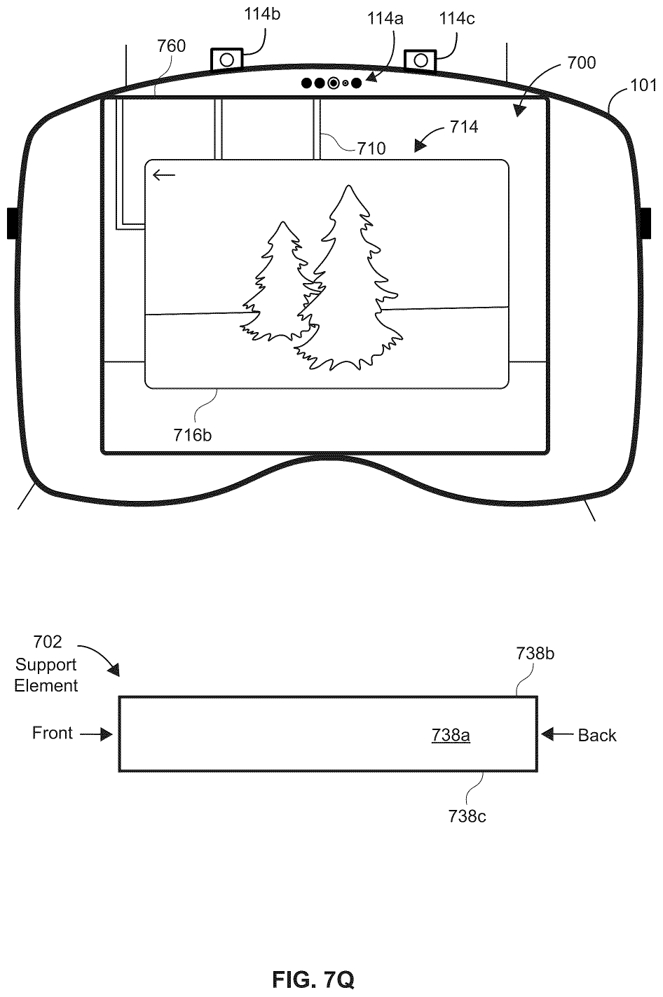

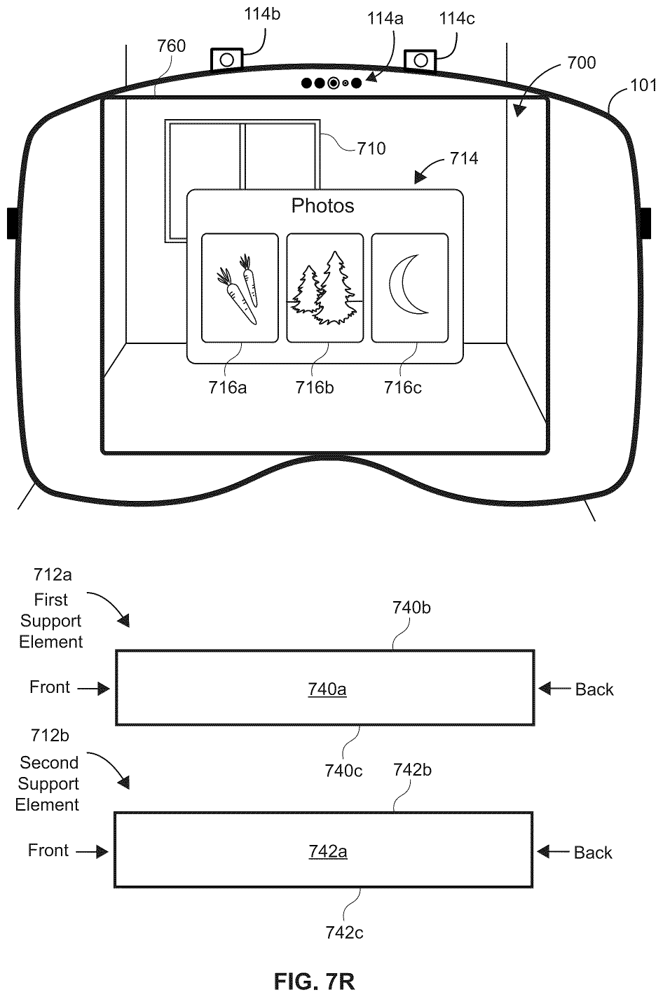

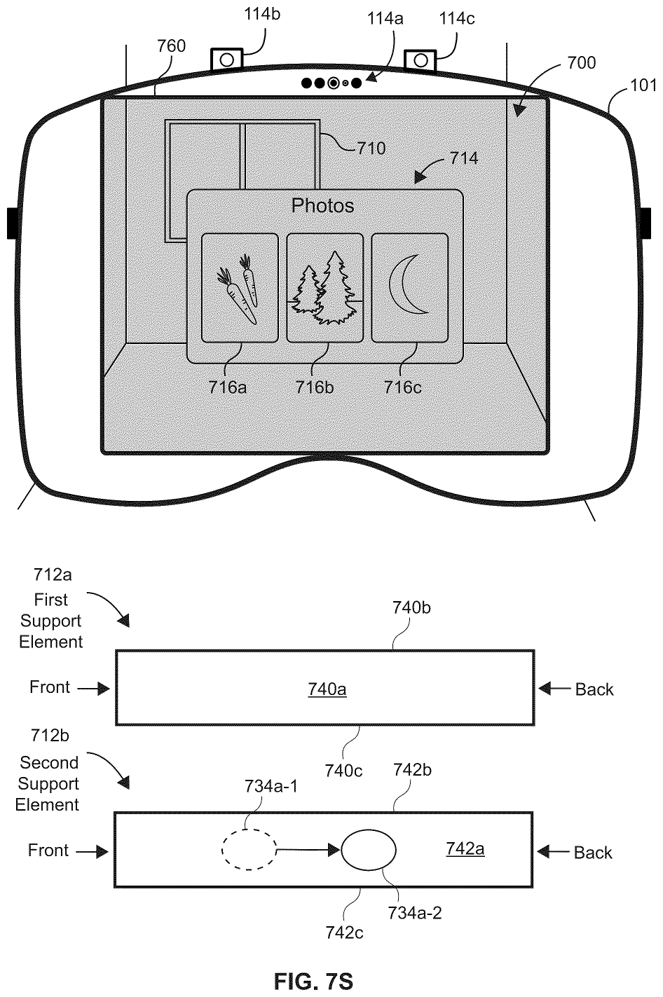

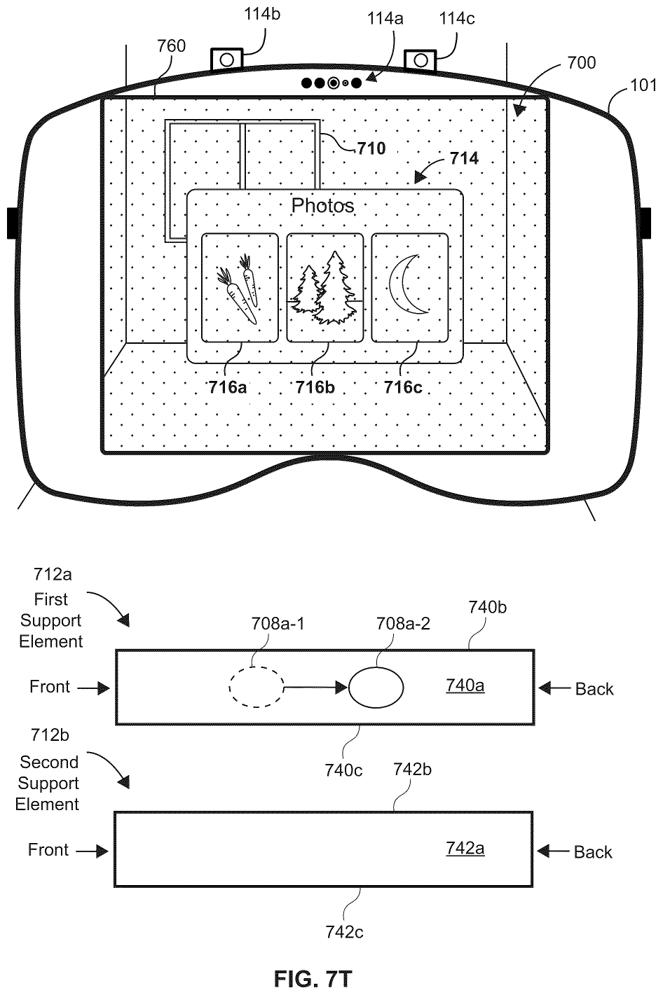

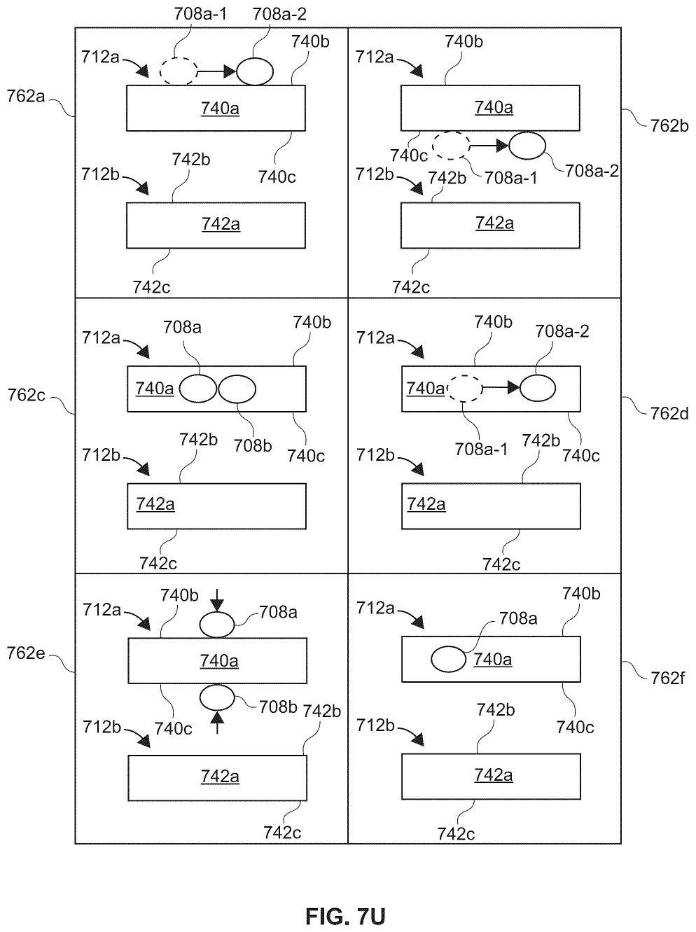

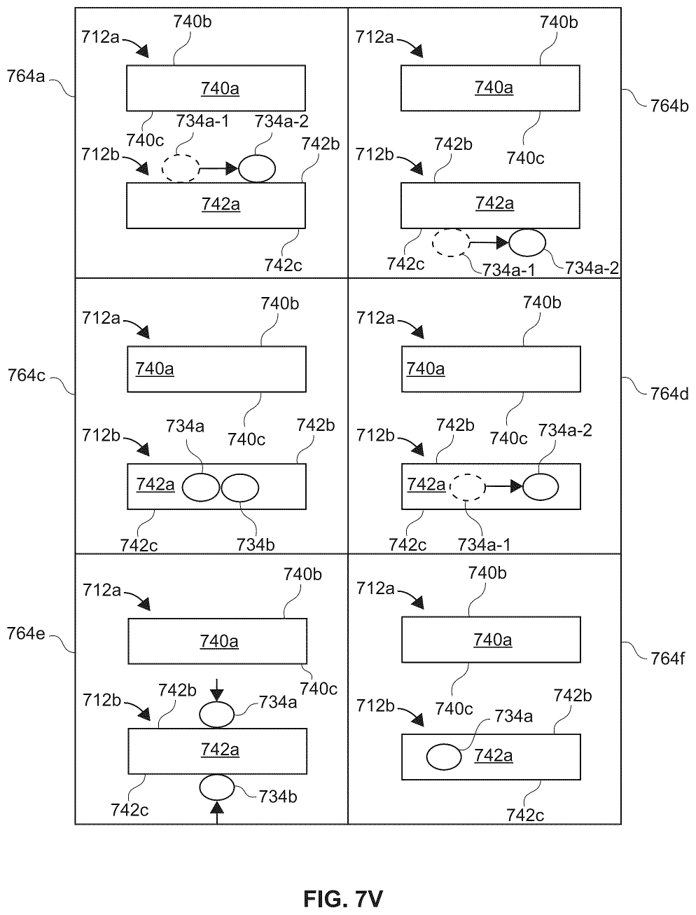

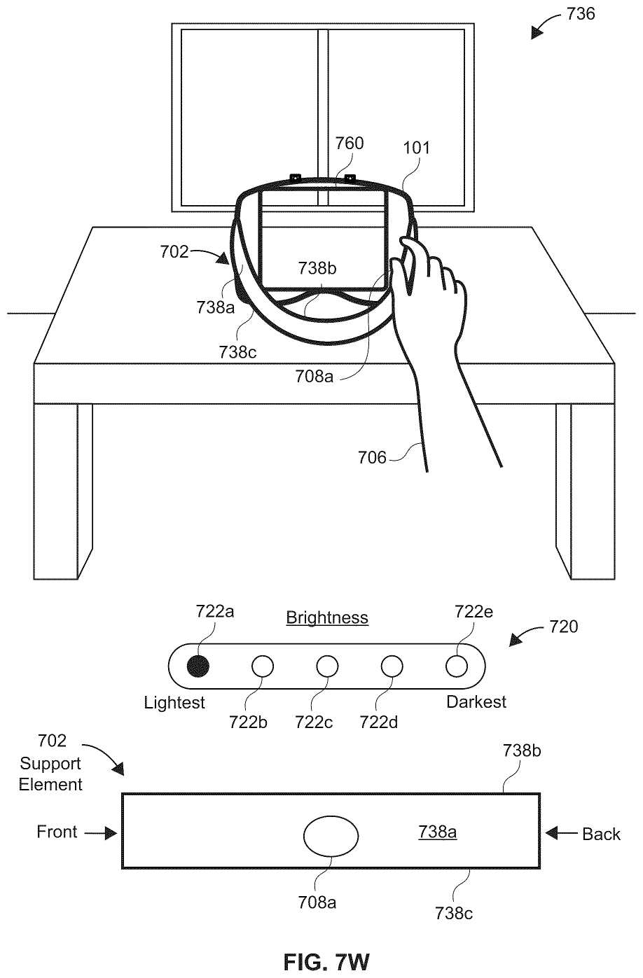

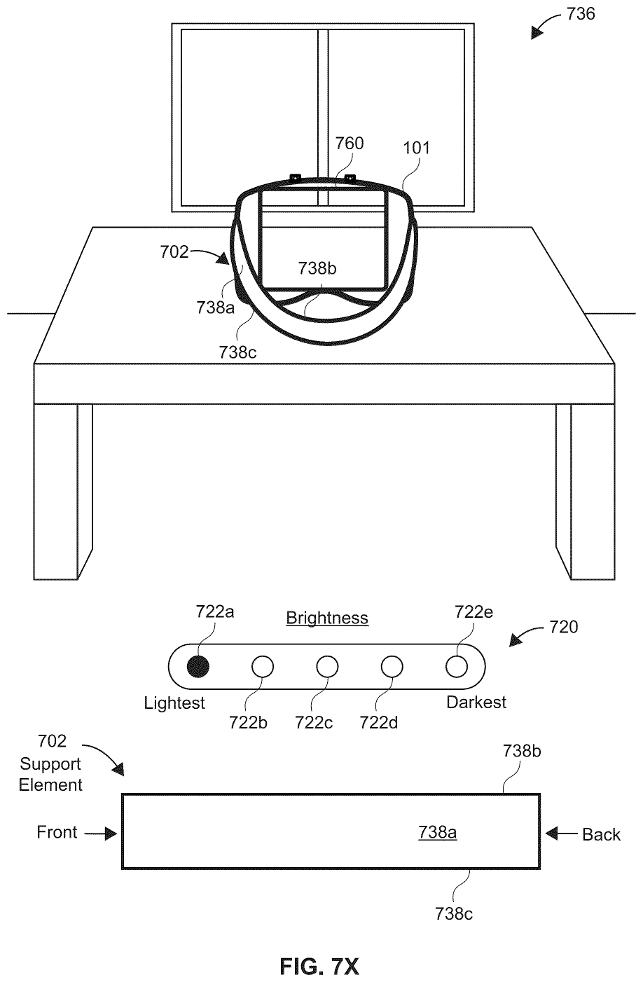

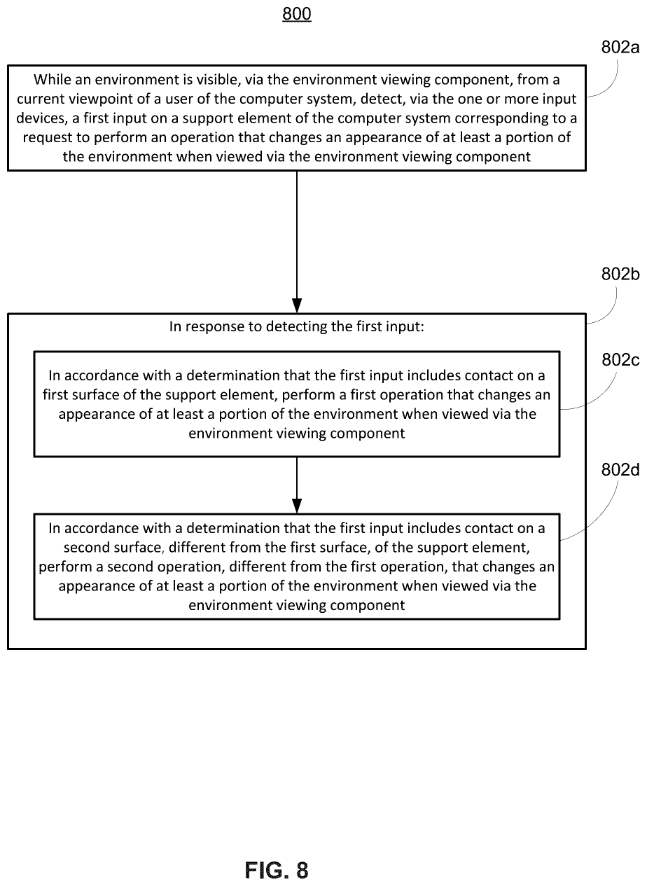

FIGS. 1A-6 provide a description of example computer systems for providing XR experiences to users (such as described below with respect to method 800). FIGS. 7A-7X illustrate example techniques of a computer system performing an operation in an environment in response to detecting an input on a support element of the computer system. FIG. 8 is a flowchart illustrating an exemplary method of performing an operation in an environment in response to detecting an input on a support element of a computer system. The user interfaces in FIGS. 7A-7X are used to illustrate the processes in FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:
Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display.

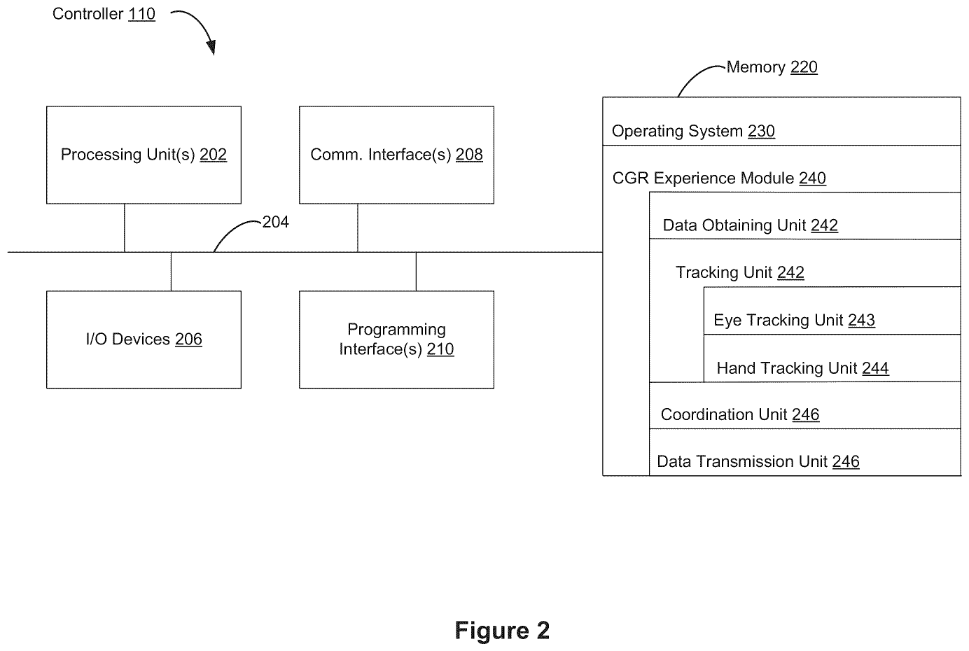

Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, OLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

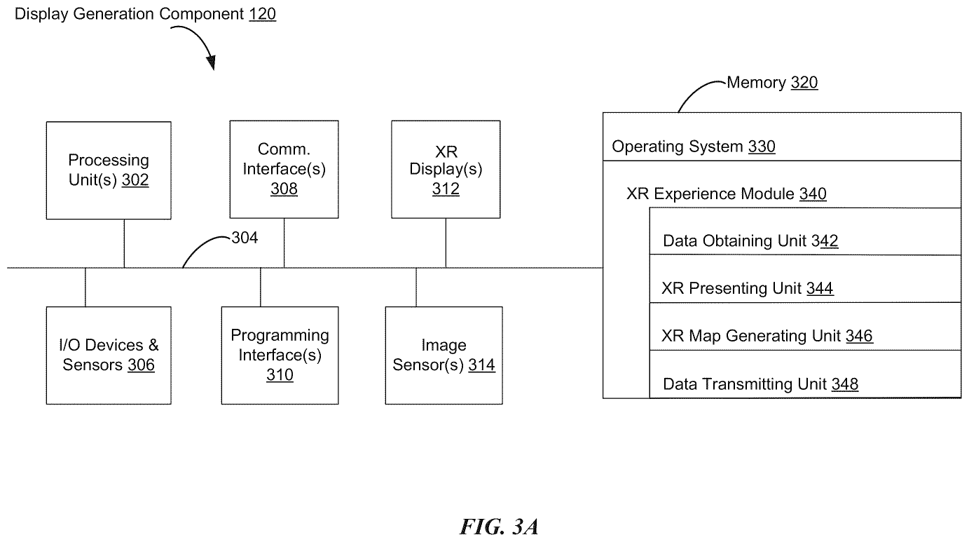

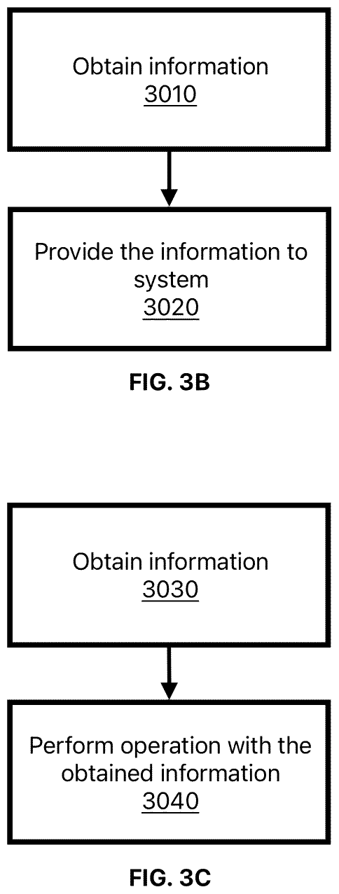

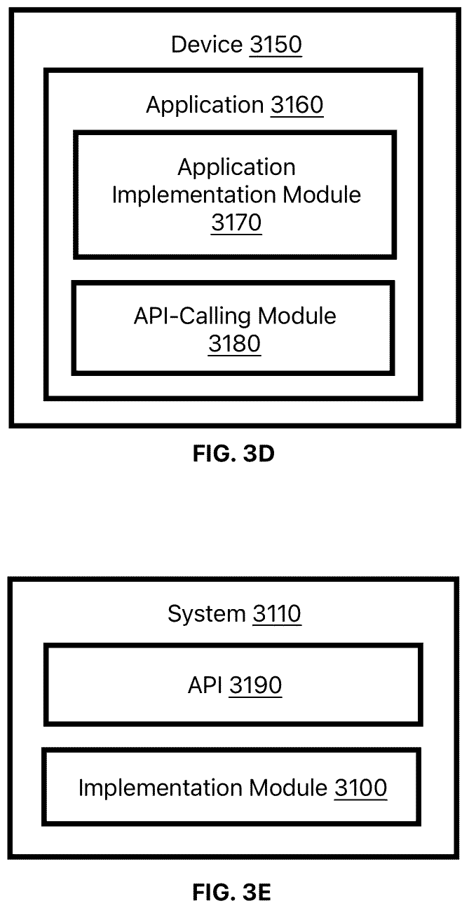

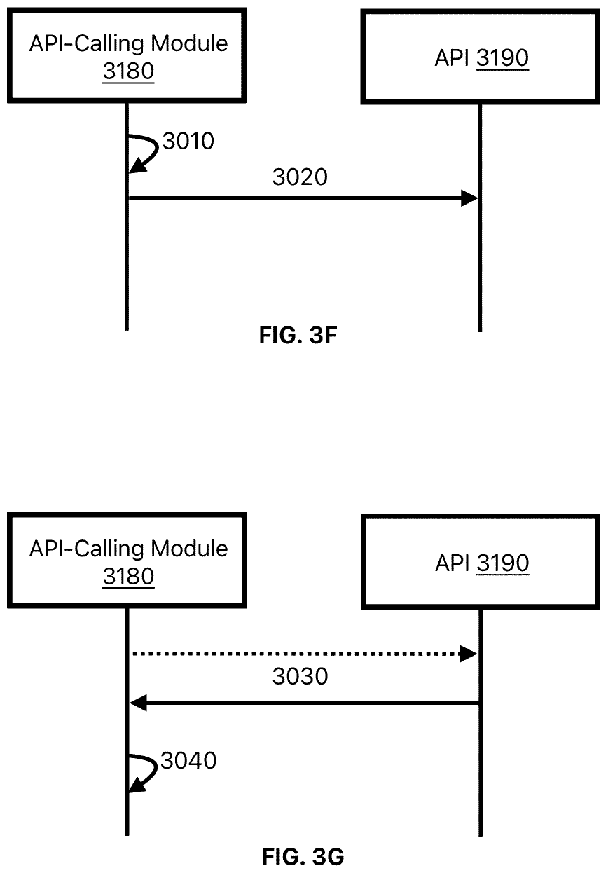

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 11-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 11-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

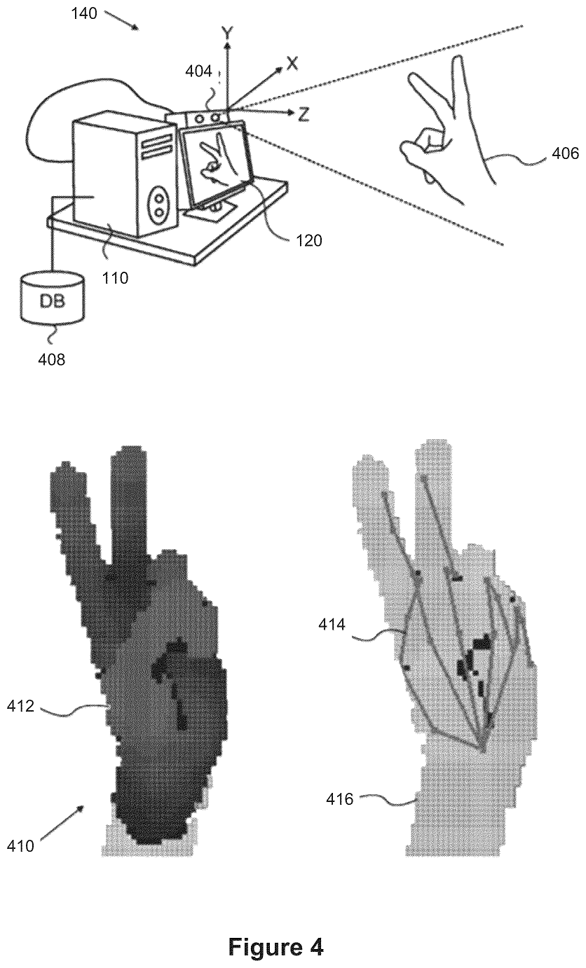

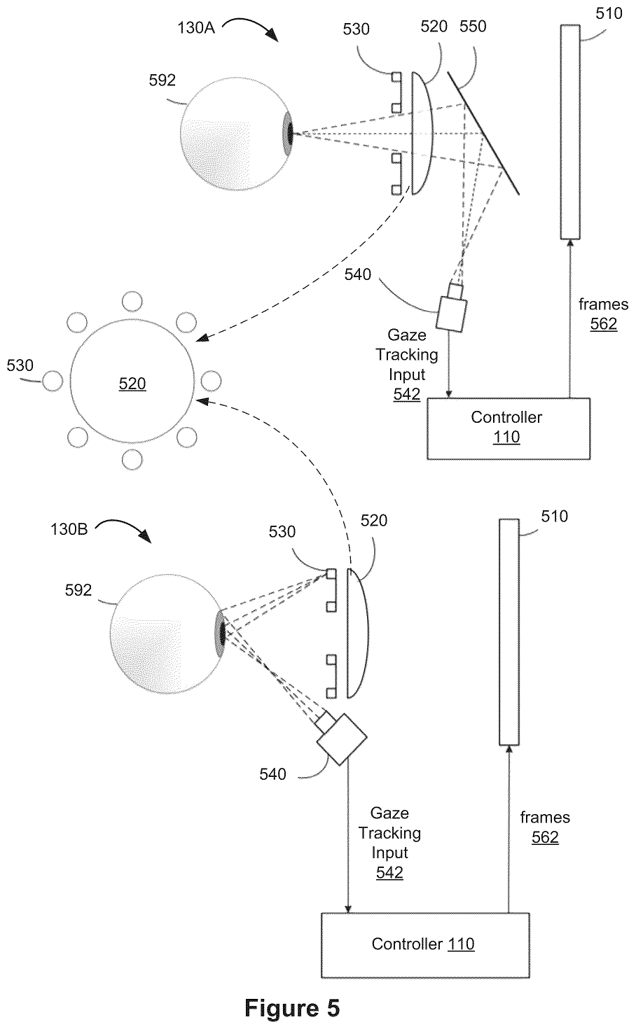

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

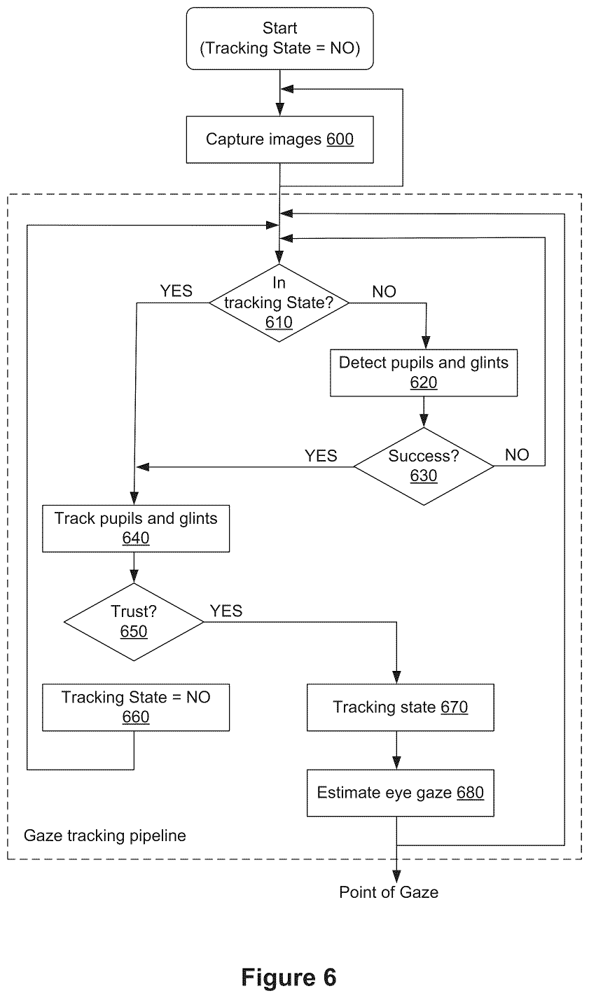

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### USER INTERFACES AND ASSOCIATED PROCESSES

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7X illustrate examples of a computer system performing one or more operations in response to detecting an input on a support element of the computer system.

FIG. 7A illustrates a user 704 wearing a computer system 101 (e.g., an electronic device). As shown in FIG. 7A, computer system 101 is a head-mounted device (e.g., a head-mounted display) worn by user 704. In some embodiments, computer system 101 includes an environment viewing component 760. The environment viewing component 760 optionally includes one or more lenses (e.g., liquid lenses, liquid crystal lenses, and/or Alvarez lenses (e.g., the one or more lenses optionally include one or more brightness modulation devices, such as liquid crystal dimmers and/or electrochromic films)) that user 704 is able to view a physical environment (e.g., one or more objects of the physical surrounding of user 704) through. In some embodiments, environment viewing component 760 includes (e.g., or is) a display generation component (e.g., having one or more characteristics of display generation component 120). For example, the display generation component is configured to display one or more user interfaces (e.g., and/or one or more virtual objects) in an environment (e.g., environment 700 shown and described with reference to FIGS. 7B-7T). For example, one or more user interfaces and/or one or more objects from the physical environment of user 704 are visible to user 704 through environment viewing component 760 while computer system 101 is worn by user 704. In some embodiments, computer system 101 includes a plurality of image sensors (e.g., image sensors 314 of FIG. 3). The image sensors optionally include one or more of a visible light camera, an infrared camera, a depth sensor, or any other sensor computer system 101 would be able to use to capture one or more images of a user or a part of the user (e.g., one or more hands of the user) while the user interacts with computer system 101. In some embodiments, environment viewing component 760 has one or more characteristics of the environment viewing component described with reference to method 800.

In some embodiments, computer system 101 includes a support element 702 (e.g., and optionally includes multiple support elements, such as shown and described with reference to FIGS. 7R-7V that enable computer system 101 to be worn by user 704). For example, support element 702 includes (e.g., or is) an arm (e.g., coupled to environment viewing component 760 and supported by an ear of user 704 (e.g., when computer system 101 is worn by user 704)), a strap (e.g., coupled to environment viewing component 760 and wrapping around a head of user 704) and/or a band (e.g., computer system 101 is a bracelet and/or watch, and the band wraps around a wrist of user 704). In some embodiments, support element 702 includes multiple surfaces. As shown in FIG. 7A, support element 702 includes a first surface 738a (e.g., a side surface), second surface 738b (e.g., a top surface) and third surface 738c (e.g., a bottom surface), opposite the second surface 738b. In some embodiments, first surface 738a, second surface 738b and third surface 738c are touch-sensitive surfaces of support element 702 (e.g., touch-sensitive surfaces integrated with support element 702 (e.g., within a housing of support element 702 and/or computer system 101)). In some embodiments, first surface 738a, second surface 738b, and/or third surface 738c are separate touch-sensitive elements (e.g., different touch-sensitive input elements in communication with computer system 101). In some embodiments, first surface 738a, second surface 738b, and/or third surface 738c are different portions of the same touch-sensitive element (e.g., the same touch-sensitive input element in communication with computer system 101). In some embodiments, support element 702 (e.g., a housing of support element 702) includes curvature (e.g., such that support element 702 does not include geometrically flat (e.g., or symmetrical) surfaces). For example, support element 702 does not include one or more edges that define first surface 738a, second surface 738b, and/or third surface 738c (e.g., first surface 738a curves into second surface 738b and third surface 738c). In some embodiments, support element 702 includes a plurality of touch electrodes disposed beneath first surface 738a, second surface 738b, and third surface 738c (e.g., disposed and/or formed on one or more material layers (e.g., on one or more sides of a substrate) beneath first surface 738a, second surface 738b, and third surface 738c). In some embodiments, computer system 101 is configured to sense the self-capacitance of and/or the mutual capacitance between the plurality of touch electrodes to detect touch and/or proximity activity (e.g., including movement of an object) on a respective surface of support element 702 (e.g., on the first surface 738a, second surface 738b, and/or third surface 738c). In some embodiments, first surface 738a, second surface 738b, and/or third surface 738c are software defined by computer system 101 (e.g., support element 702 includes curvature such that first surface 738a, second surface 738b, and/or third surface 738c are not geometrically distinct). For example, touch and/or proximity activity detected (e.g., by estimating a location of a centroid of a touch input relative to support element 702) within a first portion of support element 702 is defined by computer system 101 as a touch input on first surface 738a. For example, touch and/or proximity activity detected within a second portion, different from the first portion, of support element 702 is defined by computer system 101 as a touch input on second surface 738b. For example, touch and/or proximity activity detected within a third portion, different from the first portion and the second portion, of support element 702 is defined by computer system 101 as a touch input on third surface 738c. In some embodiments, support element 702 has one or more characteristics of the support element described with reference to method 800. In some embodiments, the first surface 738a, second surface 738b, and third surface 738c have one or more characteristics of the first surface, second surface and/or third surface of the support element, respectively, described with reference to method 800.

In some embodiments, computer system 101 is configured to selectively respond to user input provided on one or more of the surfaces of the support element 702. For example, as shown in FIG. 7A, user 704 provides a first touch input on first surface 738a using finger 708a of hand 706. In some embodiments, the first touch input corresponds to a tap input on first surface 738a. In some embodiments, the first touch input includes movement (e.g., the first touch input corresponds to a swipe input on first surface 738a). In some embodiments, the first touch input corresponds to a request to change an appearance of a portion of an environment that is visible to user 704 through environment viewing component 760 (e.g., as shown and described with reference to FIGS. 7B-7V).

FIGS. 7B-7X illustrate computer system 101 performing operations in environment 700 (e.g., that change an appearance of at least a portion of environment 700) in response to inputs detected on one or more respective surfaces of a respective support element (e.g., support element 702) of computer system 101. In some embodiments, a respective operation is assigned to a respective surface of support element 702 (e.g., a first operation (e.g., changing brightness of at least a portion of environment 700) is assigned to first surface 738a, and a second operation (e.g., changing an optical focus appearance of at least a portion of environment 700) is assigned to second surface 738b). In some embodiments, a respective operation is assigned to a respective touch input (e.g., a first operation (e.g., adjusting brightness in a first manner) is assigned to a swipe input, and a second operation (e.g., adjusting brightness in a second manner) is assigned to a tap input). In some embodiments, a respective operation is assigned to a respective surface of a respective support element and to a respective touch input (e.g., a first operation (e.g., changing brightness) is assigned to a swipe input performed on first surface 738a of support element 702 (e.g., and is not assigned to a swipe input performed on second surface 738b)). It should be appreciated that the inputs and operations shown in FIGS. 7B-7X and described below are exemplary, and in some embodiments, an illustrated operation is assigned to a different surface of support element 702 (e.g., changing an optical focus appearance of at least a portion of environment 700 is assigned to first surface 738a, and changing user interface focus (e.g., UI focus) between virtual elements is assigned to second surface 738b) and/or to a different touch input (e.g., selection of a virtual element is executed in response to a tap input, and changing optical focus is executed in response to a pinch input (e.g., concurrent touch inputs on second surface 738b and third surface 738c)).

FIG. 7B illustrates an environment 700 that is visible to user 704 through environment viewing component 760. For example, environment 700 shown in FIG. 7B is visible to user 704 while user 704 is wearing computer system 101 (e.g., as shown in FIG. 7A). In some embodiments, environment 700 has one or more characteristics of the environment described with reference to method 800. In some embodiments, environment 700 includes video and/or optical passthrough of a physical environment of user 704. For example, as shown in FIG. 7B, a real-world window 710 is visible in environment 700 (e.g., from the current viewpoint of user 704). In some embodiments, environment 700 optionally includes one or more virtual objects that are displayed (e.g., and/or otherwise generated) by a display generation component (e.g., that is and/or part of environment viewing component 760). As shown in FIG. 7B, environment 700 includes virtual object 714 (e.g., virtual object 714 is visible to user 704 in addition to the passthrough of the physical environment (e.g., real-world window 710)). In some embodiments, virtual object 714 is associated with a respective application that is accessible to user 704 through computer system 101 (e.g., user 704 accesses the application through computer system 101 or through a device in communication with computer system 101). For example, as shown in FIG. 7B, virtual object 714 is associated with an image storage application. As shown, virtual object 714 includes a plurality of virtual elements 716a-716c (e.g., virtual elements 716a-716c are images stored in memory of computer system 101 and accessible via the image storage application that virtual object 714 is associated with). In some embodiments, computer system 101 navigates (e.g., changes UI focus) or selects a respective virtual element of the plurality of virtual elements 716a-716c in response to one or more user inputs (e.g., as shown and described with reference to FIGS. 7K-7N).

A schematic representation of support element 702 is illustrated in FIG. 7B (e.g., and in the subsequent figures). As shown, the schematic representation of support element 702 includes first surface 738a (e.g., a side surface), second surface 738b (e.g., a top surface), and third surface 738c (e.g., a bottom surface). For reference, a front (e.g., labeled “front”) and a back (e.g., labeled “back”) of support element 702 are identified in FIG. 7B (e.g., and in the subsequent figures). For example, the front of support element 702 corresponds to a portion of support element 702 closer to environment viewing component 760, and the back of support element 702 corresponds to a portion of support element 702 farther from environment viewing component 760 (e.g., as shown in FIG. 7A, support element 702 is coupled to environment viewing component 760). In some embodiments, support element 702 is one of multiple (optionally identical) support elements of computer system 101 (e.g., is one of two arms coupled to environment viewing component 760). For example, in some embodiments, support element 702 is an arm supported by a left ear of user 704 when computer system 101 is worn by user 704. Alternatively, in some embodiments, support element 702 is an arm supported by a right ear of user 704 when computer system 101 is worn by user 704.

In some embodiments, computer system 101 performs one or more operations in environment 700 in response to detecting one or more touch inputs performed on support element 702. For example, computer system 101 changes the appearance of at least a portion of environment 700 in response to detecting one or more inputs performed on support element 702. For example, computer system 101 changes the brightness, optical focus appearance, magnification, tint, color and/or saturation of at least a portion of environment 700 (e.g., from the current viewpoint of user 704). In some embodiments, computer system 101 performs a user interface operation in environment 700 in response to detecting one or more inputs performed on support element 702. For example, computer system 101 navigates through one or more virtual elements (e.g., virtual elements 716a-716c) and/or selects a virtual element. In some embodiments, a respective operation is assigned to a respective surface of support element 702. For example, as described below, computer system 101 changes a brightness of environment 700 in response to detecting a touch input on first surface 738a. In some embodiments, a respective operation is assigned to a respective type of gesture detected by computer system 101. For example, computer system 101 changes the brightness of environment 700 in response to detecting a swipe input. In some embodiments, a respective operation is assigned to a respective surface of support element 702 and a respective type of gesture detected by computer system 101. For example, computer system 101 changes the brightness of environment 700 in response to detecting a swipe input performed on first surface 738a of support element 702.

In some embodiments, computer system 101 is an electronic device that does not include a display generation component (e.g., and optionally does not include one or more camera sensors). For example, environment 700 includes optical passthrough of a physical environment of user 700 and does not include one or more virtual objects displayed and/or generated by computer system 101. In some embodiments, in response to detecting one or more inputs performed on support element 702, an operation is performed using environment viewing component 760 that changes an appearance of environment 700 (e.g. an optical focus appearance) from the current viewpoint of user 704. In some embodiments, the operation is performed using a variable optical component of environment viewing component 760, such as one or more liquid lenses, liquid crystal lenses, and/or Alvarez lenses (e.g., a lens composed of two complementary phase plates defined by a third order polynomial where the phase plates can be shifted relative to each other to change a degree of optical focus of content viewed through the lens). For example, in response to detecting a first input on a respective surface (e.g., second surface 738b) of support element 702, an optical focus setting (e.g., an optical power or phase shift) of environment viewing component 760 is changed using the variable optical component, thereby changing a value of sharpness of a portion of optical passthrough visible to user 704 in environment 700 (e.g., placing a portion of environment 700 into focus from the current viewpoint of user 704). In some embodiments, the operation is performed using a brightness modulation component of environment viewing component 760, such as one or more liquid crystal dimmers and/or electrochromic films. For example, in response to detecting a second input on a respective surface (e.g., first surface 738a) of support element 702, a brightness of optical passthrough visible to user 704 through environment viewing component 760 is changed using the brightness modulation component.

As shown in FIG. 7B, user 704 performs a first touch input (e.g., labeled 708a-1) using finger 708a of FIG. 7A on first surface 738a of support element 702. In some embodiments, user 704 initiates a swipe input (e.g., movement of finger 708a during the swipe input is shown in FIGS. 7C-7D). In some embodiments, the first touch input corresponds to a request to perform an operation that changes an appearance of environment 700 (e.g., having one or more characteristics of the request to perform the operation that changes the appearance of the at least the portion of the environment as described with reference to method 800). For example, the first touch input corresponds to a request to change the brightness of environment 700 (e.g., using a brightness modulation component of environment viewing component 760, as discussed above). FIG. 7B includes a schematic 720 that illustrates brightness values 722a-722e that environment 700 is able to be updated to. In some embodiments, brightness values 722a-722e include one or more characteristics of the plurality of values of the first parameter described with reference to method 800. In some embodiments, brightness values 722a-722e are values that are predefined and/or pre-set by computer system 101 (e.g., defined in one or more system settings of computer system 101). In some embodiments, brightness values 722a-722e are defined by user settings (e.g., user preferences that are stored in a user profile (e.g., brightness values 722a-722e are values of brightness user 704 prefers to set environment 700 to)). In some embodiments, user 704 is able to adjust the brightness of environment 700 to one of brightness values 722a-722e (e.g., by performing a first type of input (e.g., a tap input) on support element 702), or to a value that is different from brightness values 722a-722e (e.g., by performing a second type of input (e.g., a swipe input) on support element 702, different from the first type of input). For example, computer system 101 adjusts the brightness of environment 700 to one of brightness values 722a-722e in response to a swipe input that is greater than a threshold velocity (e.g., having one or more characteristics of threshold velocity 732 described below), and to a value different from brightness values 722a-722e in response to a swipe input that is less than a threshold velocity.

FIG. 7C illustrates user 704 performing a swipe input on first surface 738a. In some embodiments, the swipe input has one or more characteristics of a movement input described with reference to method 800. In some embodiments, the swipe input shown in FIG. 7C is a continuation of the first touch input initiated in FIG. 7B. As shown in FIG. 7C, the swipe input includes movement of finger 708a (e.g., from position 708a-1 to a second position 708a-2) on first surface 738a. In some embodiments, in response to the swipe input, computer system 101 changes the brightness of at least a portion of environment 700 (e.g., a portion of environment 700 visible to user, a portion of environment 700 including optical passthrough of the physical environment visible through environment viewing component 760, and/or a portion of environment including one or more virtual objects that are displayed via a display generation component). For example, as shown in FIG. 7C, the brightness of a portion of environment 700 including passthrough of the physical environment (e.g., including real-world window 710) changes from the current viewpoint of user 704 (e.g., by adjusting a brightness modulation component of environment viewing component 760). For example, as shown in FIG. 7C, computer system 101 updates the value of brightness of the portion of environment 700 including virtual object 714 (e.g., in addition to the portion of environment 700 including passthrough of the physical environment of user 704). For example, the value of brightness of the portion of environment 700 including virtual object 714 is changed using a display generation component of computer system 101. The computer system 101 optionally changes the brightness of the passthrough of the physical environment of user 704 and not the brightness of virtual object 714 in response to the swipe input. The computer system 101 optionally alternatively changes the brightness of virtual object 714 and not the brightness of the passthrough of the physical environment of user 704 in response to the swipe input.

In some embodiments, computer system 101 adjusts the brightness of environment 700 in different manners based on a velocity of movement of finger 708a on support element 702 (e.g., on the first surface 738a of support element 702). For example, in FIG. 7C, a graph 730 of the velocity (e.g., y-axis) of the swipe input over time (e.g., x-axis) is shown. Graph 730 includes a threshold velocity 732. For example, threshold velocity 732 is 0.01, 0.05, 0.1, 0.2, 0.5 or 1 m/s. In some embodiments, in accordance with the swipe input including movement that is less than threshold velocity 732, computer system 101 adjusts the value of brightness of environment 700 in a first manner. For example, the first manner of adjusting the value of brightness of environment 700 includes adjusting the value of brightness of environment 700 based on a magnitude of movement of finger 708a during the swipe input. For example, user 704 can adjust the brightness of environment 700 to a custom value (e.g., optionally different from the brightness values 722a-722e) that is based on the velocity, distance, and/or duration of the swipe input on first surface 738a. As shown in FIG. 7C, in response to the swipe input that is below threshold velocity 732, computer system 101 updates the brightness of environment 700 to a brightness value that is between brightness values 722a and 722b (e.g., as represented by cursor 728 on schematic 720). In some embodiments, adjusting the brightness of environment 700 in the first manner includes continuously adjusting the brightness of environment 700 while the swipe input is detected on first surface 738a (e.g., the brightness of environment 700 changes while the position of finger 708a on first surface 738a changes). In some embodiments, in response to detecting a swipe input that is less than threshold velocity 732, computer system 101 changes the value of brightness of environment 700 to one of the brightness values 722a-722e or to a value of brightness different from the brightness values 722a-722e. For example, while detecting the swipe input, computer system 101 adjusts the brightness of environment 700 to one or more values within a range of values that include both the brightness values 722a-722e and values between the brightness values 722a-722e based on the magnitude of movement of finger 708a on first surface 738a (e.g., the range of values includes predefined and non-predefined values of brightness between a maximum brightness (e.g., brightness value 722a) and a minimum brightness (e.g., brightness value 722e)). Alternatively or additionally, in some embodiments, computer system 101 changes the brightness of environment 700 in the first manner in response to a swipe input that exceeds a threshold amount of time (e.g., a threshold duration). For example, in accordance with the first touch input including movement of finger 708a on first surface 738a for greater than a threshold amount of time (e.g., 0.1, 0.2, 0.5, 1, 2, 5 or 10 seconds), computer system 101 continuously adjusts the value of brightness of environment 700 while detecting the swipe input (e.g., based on a magnitude of the swipe input).

In some embodiments, computer system 101 adjusts the brightness of environment 700 based on a direction of the swipe input. For example, as shown in FIG. 7C, the brightness of environment 700 becomes darker in response to movement of finger 708a in the direction toward the back of support element 702 (e.g., in a direction away from environment viewing component 760, illustrated by the rightward movement of the finger 708a on the first surface 738a). Alternatively, in some embodiments, the brightness of environment 700 becomes lighter in response to movement of finger 708a in the direction toward the front of support element 702 (e.g., in a direction toward environment viewing component 760). In some embodiments, in accordance with the swipe input including multiple directions (e.g., a portion of the swipe input includes movement toward the back of support element 702, and a portion of the swipe input includes movement toward the front of support element 702), computer system 101 increases the value of brightness during a first portion of the swipe input (e.g., that includes movement in a first direction) and decreases the value of brightness during a second portion of the swipe input (e.g., that includes movement in a second direction, opposite from the first direction).

FIG. 7D illustrates user 704 ceasing to perform the first touch input (e.g., the swipe input) initiated in FIG. 7B (e.g., and continued in FIG. 7C). As shown in FIG. 7D, user 704 continues the movement of finger 708a on first surface 738a in the direction toward the back of support element 702 (e.g., position 708a-2 is displaced from position 708a-1 by a greater amount in FIG. 7D than in FIG. 7C). In some embodiments, computer system 101 continues to adjust the brightness of environment 700 (e.g., by continuing to adjust a brightness modulation component of environment viewing component 760) in response to the continued movement of finger 708a. For example, as shown in FIG. 7D, the brightness of environment 700 is changed to a value between brightness value 722c and brightness value 722d (e.g., as represented by cursor 728 in schematic 720). As shown in graph 730, the continued movement of finger 708a included movement below threshold velocity 732. In some embodiments, in response to the continued movement of finger 708a that is below threshold velocity 732, computer system 101 continues to continuously adjust the value of brightness of environment 700 based on the velocity, duration, and/or magnitude of the movement of finger 708a on first surface 738a (e.g., the computer system 101 adjust the value of brightness based on a position of finger 708a relative to first surface 738a during the swipe input). In some embodiments, in response to detecting lift-off of finger 708a from first surface 738a (e.g., after the movement of finger 708a from position 708a-1 to position 708-2 shown in FIG. 7D (e.g., as shown by graph 730 in FIG. 7D, the velocity of movement of finger 708a returns to zero)), computer system 101 maintains the display of environment 700 with the value of brightness between brightness value 722c and brightness value 722d represented by cursor 728 in schematic 720.

FIG. 7E illustrates user 704 performing a second touch input on first surface 738a of support element 702 (e.g., with finger 708a of FIG. 7A). In some embodiments, in response to the second touch input performed by user 704, computer system 101 updates the value of the brightness of environment 700 to brightness value 722c (e.g., using a brightness modulation component of environment viewing component 760, such that the brightness of environment 700 increases from the current viewpoint of user 704). In some embodiments, computer system 101 changes the value of brightness of environment 700 in a second manner (e.g., different from the first manner shown and described with reference to in FIGS. 7C-7D) in response to a swipe input that is greater than threshold velocity 732 (e.g., the second touch input corresponds to a quick swipe or a quick flick of finger 708a on first surface 738a). For example, as shown in graph 730 in FIG. 7E, the movement of finger 708a on first surface 738a (e.g., from position 708a-1 to position 708a-2) includes movement that is greater than threshold velocity 732. In some embodiments, changing the value of brightness of environment 700 in the second manner includes changing the value of brightness to one of the brightness values 722a-722e (e.g., and not to a value of brightness between the brightness values 722a-722e (e.g., as shown in FIGS. 7C-7D)). For example, computer system 101 updates the value of brightness of environment 700 to the next highest or lowest brightness value (e.g., the next highest or lowest pre-set or predefined brightness value) from a current value of brightness. As shown in FIG. 7E, computer system 101 updates the value of brightness to brightness value 722c because it is the next lowest brightness value from the value of brightness represented by cursor 728 in FIG. 7D (e.g., the value of brightness represented by cursor 728 in FIG. 7D is the value of brightness of environment 700 when the second touch input is detected by computer system 101). In some embodiments, computer system 101 updates the value of brightness of environment 700 based on the direction of movement of finger 708a. For example, as shown in FIG. 7E, in accordance with the second touch input including movement of finger 708a toward the front of support element 702 (e.g., in a direction toward environment viewing component 760), computer system 101 increases the value of brightness from the value represented by cursor 728 in FIG. 7D to brightness value 722c. In some embodiments, in response to detecting a touch input that includes movement of finger 708a on first surface 738a (e.g., that exceeds threshold velocity 732) toward the back of support element 702 (e.g., in a direction away from environment viewing component 760), computer system 101 decreases the value of brightness to the next lowest brightness value (e.g., brightness value 722d). Alternatively, in some embodiments, computer system 101 decreases the value of brightness in response to a touch input that includes movement toward the front of support element 702 (e.g., to brightness value 722d) and increases the value of brightness in response to a touch input that includes movement toward the back of support element 702 (e.g., to brightness value 722c).

FIG. 7F illustrates user 704 performing a third touch input on first surface 738a. In some embodiments, the third touch input corresponds to a tap input performed by finger 708a (e.g., at position 708a-1) on first surface 738a of support element 702. In some embodiments, the tap input corresponds to a request to update the value of brightness of environment 700 to a maximum value (e.g., brightness value 722a) or a minimum value (e.g., brightness value 722e).

In response to the third touch input, in FIG. 7G, computer system 101 updates the value of brightness of environment 700 to brightness value 722a (e.g., the maximum brightness value). In some embodiments, computer system 101 updates the brightness to the maximum or minimum value based on a quantity of tap inputs (e.g., in accordance with a determination that the third touch input corresponds to a single tap input, computer system 101 updates the value of brightness to brightness value 722a, and in accordance with a determination that the third touch input corresponds to a double tap input, computer system 101 updates the value of brightness to brightness value 722e). In some embodiments, computer system 101 updates the brightness to the maximum or minimum value based on a respective surface of support element 702 that the third touch input is detected on (e.g., in accordance with a determination that the third touch input is detected on first surface 738a, computer system 101 updates the value of brightness to brightness value 722a, and in accordance with a determination that the third touch input is detected on second surface 738b, computer system 101 updates the value of brightness to brightness value 722e).

In some embodiments, computer system 101 updates the value of brightness of environment 700 to the maximum brightness value (e.g., brightness value 722a) based on a current value of brightness of environment 700 (e.g., the value of brightness of environment 700 while a respective touch input is detected). For example, computer system 101 detects a first input (e.g., a stationary input (e.g., the tap input shown in FIG. 7F) or a movement input that exceeds a threshold velocity (e.g., the movement input shown in FIG. 7E)) on a respective surface (e.g., first surface 738a) of support element 702. In some embodiments, in accordance with the current value of brightness of environment 700 being within a threshold amount of the maximum brightness value of environment 700 when the first input is detected, computer system 101 changes the value of brightness of environment 700 to the maximum brightness value (e.g., brightness value 722a). For example, the current value of brightness of environment 700 is within the threshold amount of the maximum brightness value when the current value of brightness is closer to the maximum brightness value than the minimum brightness value (e.g., the current value of brightness of environment 700 is between brightness value 722c and brightness value 722a). For example, in accordance with a stationary input (e.g., a tap input) being detected on first surface 738a while a current value of brightness of environment 700 is brightness value 722b, computer system 101 updates the value of brightness of environment 700 to brightness value 722a. In some embodiments, in accordance with the current value of brightness of environment 700 being a minimum value of brightness (e.g., brightness value 722e) when the first input is detected, computer system 101 changes the value of brightness of environment 700 to the maximum brightness value (e.g., brightness value 722a). For example, in accordance with a stationary input (e.g., a tap input) being detected on first surface 738a while a current value of brightness of environment 700 is brightness value 722e, computer system 101 updates the value of brightness of environment 700 to brightness value 722a.

In some embodiments, computer system 101 updates the value of brightness of environment 700 to the minimum brightness value (e.g., brightness value 722e) based on a current value of brightness of environment 700 (e.g., the value of brightness of environment 700 while a respective touch input is detected). For example, computer system 101 detects a first input (e.g., a stationary input (e.g., the tap input shown in FIG. 7F) or a movement input that exceeds a threshold velocity (e.g., the movement input shown in FIG. 7E)) on a respective surface (e.g., first surface 738a) of support element 702. In some embodiments, in accordance with the current value of brightness of environment 700 being with a threshold amount of the minimum brightness value of environment 700 when the first input is detected, computer system 101 changes the value of brightness of environment 700 to the minimum brightness value (e.g., brightness value 722e). For example, the current value of brightness of environment 700 is within the threshold amount of the minimum brightness value when the current value of brightness is closer to the minimum brightness value than the maximum brightness value (e.g., the current value of brightness of environment 700 is between brightness value 722c and brightness value 722e). For example, in accordance with a stationary input (e.g., a tap input) being detected on first surface 738a while a current value of brightness of environment 700 is brightness value 722d, computer system 101 updates the value of brightness of environment 700 to brightness value 722e. In some embodiments, in accordance with the current value of brightness of environment 700 being a maximum value of brightness (e.g., brightness value 722a) when the first input is detected, computer system 101 changes the value of brightness of environment 700 to the minimum brightness value (e.g., brightness value 722e). For example, in accordance with a stationary input (e.g., a tap input) being detected on first surface 738a while a current value of brightness of environment 700 is brightness value 722a, computer system 101 updates the value of brightness of environment 700 to brightness value 722e.

In some embodiments, computer system 101 changes different parameters of an appearance of environment 700 in response to inputs performed on different surfaces of support element 702. For example, a first operation (e.g., updating the brightness of a portion of environment 700) is assigned to first surface 738a (e.g., as shown and described with reference to FIGS. 7B-7G), and a second operation (e.g., updating an optical focus appearance of a portion of environment 700) is assigned to second surface 738b. In some embodiments, an operation is assigned to a respective surface of support element 702 based on default and/or pre-set system settings. Alternatively or additionally, in some embodiments, an operation is assigned to a respective surface of support element 702 based on user selection and/or preferences (e.g., settings stored in a user profile).

Examples of operations performed by computer system 101 and described below include updating an optical focus appearance of environment 700 (e.g., as shown and described with reference to FIGS. 7H-71) and updating UI focus (e.g., as shown and described with reference to FIGS. 7K-7L). It should be understood that updating optical focus appearance of environment 700 includes using one or more components of environment viewing component 760 (e.g., including a variable optical component, such as a liquid lens, liquid crystal lens and/or Alvarez lens) to place a portion of environment 700 into or out of focus from the current viewpoint of user 704. In some embodiments, updating optical focus appearance of environment 700 occurs based on a change in the optical power (e.g., focal distance) of environment viewing component 760 (e.g., of one or more lenses of environment viewing component 760). In some embodiments, updating optical focus appearance of environment 700 includes changing the depth of field of a portion of environment 700 (e.g., visible through environment viewing component 760 from the current viewpoint of user 704). In some embodiments, environment viewing component 760 includes one or more variable optical components (e.g., one or more liquid lenses, liquid crystal lenses, and/or Alvarez lenses), and changing optical focus appearance of environment 700 includes changing optical power of environment viewing component 760 using the one or more variable optical components. In some embodiments, computer system 101 updates the optical focus appearance of a portion of environment 700 including passthrough of the physical environment of user 704 (e.g., and optionally does not update the optical focus appearance of a portion of environment 700 including one or more virtual objects, such as virtual object 714). In some embodiments, computer system 101 updates the optical focus appearance of a portion of environment 700 including one or more virtual objects, such as virtual object 714 (e.g., in addition to a portion of environment 700 including passthrough of the physical environment of user 704). It should be understood that updating UI focus includes performing a UI operation corresponding to navigation through one or more virtual objects displayed and/or generated in environment 700 via a display generation component (e.g., having one or more characteristics of display generation component 120 (e.g., environment viewing component 760 is display generation component 120)). For example, updating UI focus includes moving a virtual cursor and/or indication through a user interface (e.g., to highlight and/or emphasize different virtual elements, such as virtual elements 716a-716c). For example, updating UI focus includes identifying a virtual element of a plurality of virtual elements (e.g., included in a list) displayed in a user interface that would be selected in response to user input (e.g., in accordance with a determination that an input is detected corresponding to selection of a respective virtual element while a first virtual element has a current UI focus, computer system 101 selects the first virtual element).

FIG. 7H illustrates a portion of environment 700 that is out of optical focus (e.g., as represented by a dotted fill pattern). In FIG. 7H, a schematic 724 is shown that includes optical focus values 726a-726e. In some embodiments, optical focus values 726a-726e correspond to one or more values of optical focus settings (e.g., based on optical power) of environment viewing component 760. For example, in accordance with computer system 101 changing a current optical focus setting of environment viewing component 760 (e.g., in response to a touch input on a respective surface of support element 702), a portion of environment 700 (e.g., the portion of environment 700 currently visible to user 704) becomes more visible to user 704 (e.g., the portion of environment 700 increases in sharpness from the current viewpoint of user 704 (e.g., because of a change in optical power of environment viewing component 760)). In some embodiments, optical focus values 726a-726e are values of an optical focus setting that are predefined and/or pre-set by computer system 101 (e.g., defined in one or more system settings of computer system 101). In some embodiments, optical focus values 726a-726e are values of an optical focus setting that are defined by user settings (e.g., user preferences that are stored in a user profile). In some embodiments, optical focus values 726a-726e are values of an optical focus setting that are defined by environment viewing component 760 (e.g., optical focus values 726a-726e correspond to a range of values of the optical focus setting that the variable optical component of environment viewing component 760 is capable of being changed to). In FIG. 7H, a current value of an optical focus setting of environment viewing component 760 is optical focus value 726c. In some embodiments, optical focus appearance of environment 700 changes in different manners based on a type of touch input received that changes one or more optical focus settings. For example, as shown and described with reference to changing brightness in FIGS. 7B-7D, optical focus appearance of at least a portion of environment 700 is changed based on the magnitude of a swipe input (e.g., in accordance with the swipe input including movement that is less than a threshold velocity, such as threshold velocity 732) that affects a magnitude of change of a current value of an optical focus setting. For example, as shown and described with reference to changing brightness in FIGS. 7E and 7F-7G, optical focus appearance of at least a portion of environment 700 is changed to an appearance corresponding to a pre-set or predefined value of an optical focus setting (e.g., optical focus values 726a-726e), including a maximum or minimum value of the optical focus setting, in response to a touch input satisfying one or more criteria (e.g., the touch input is a tap input, or the touch input includes movement of an object (e.g., finger 708a) that is less than a threshold velocity (e.g., threshold velocity 732)).

FIG. 7I illustrates user 704 performing an input corresponding to a request to update optical focus appearance of a portion of environment 700 (e.g., by changing an optical focus setting of environment viewing component 760). For example, the portion of environment 700 corresponds to a portion of environment 700 that is visible from the current viewpoint of user 704. In response to the input corresponding to the request to update optical focus appearance of the portion of environment 700, computer system 101 updates a current value of an optical focus setting to optical focus value 726e (e.g., as shown in schematic 724). In some embodiments, in response to updating the current value of the optical focus setting to optical focus value 726e, the portion of environment 700 increases in sharpness from the current viewpoint of user (e.g., represented by the removal of the dotted fill pattern in environment 700).

In some embodiments, computer system 101 updates optical focus appearance of environment 700 in response to an input detected on second surface 738b (e.g., and not in response to an input detected on first surface 738a). As shown in FIG. 7I, a touch input is performed on second surface 738b that includes movement of finger 708a (e.g., from first position 708-1 to second position 708-2). For example, the touch input shown in FIG. 7I corresponds to a swipe input performed on second surface 738b. The touch input optionally includes movement that is less than threshold velocity 732 (e.g., the optical focus appearance of environment 700 is updated in the first manner, such as shown and described with reference to brightness in FIGS. 7B-7D). For example, the optical focus appearance of environment 700 is updated continuously while computer system 101 detects the movement of finger 708a on second surface 738b (e.g., a current value of an optical focus setting of environment viewing component 760 is updated based on a position of finger 708a relative to second surface 738b during the touch input). The touch input optionally includes movement that is greater than threshold velocity 732 (e.g., the optical focus appearance of environment 700 is updated in the second manner, such as shown and described with reference to brightness in FIGS. 7E-7G). For example, the optical focus appearance of environment 700 is updated (e.g., not continuously) to an appearance corresponding to optical focus value 726e (e.g., the maximum value of an optical focus setting of environment viewing component 760) in response to detecting the touch input shown in FIG. 7I. In some embodiments, the optical focus appearance of environment 700 is updated based on the direction of movement of finger 708a on second surface 738b (e.g., a value of an optical focus setting of environment viewing component 760 is changed based on the direction of movement of finger 708a on second surface 738b). For example, as shown in FIG. 7I, optical focus appearance of environment 700 is changed from an appearance corresponding to optical focus value 726c (e.g., as shown in FIG. 7H) to an appearance corresponding to optical focus value 726e (or optionally optical focus value 726d) in response to movement of finger 708a toward the back of support element 702 (e.g., in a direction away from environment viewing component 760). In some embodiments, optical focus appearance of environment 700 is changed from an appearance corresponding to optical focus value 726c to an appearance corresponding to optical focus value 726a (e.g., or optionally optical focus value 726b) in response to movement of finger 708a toward the front of support element 702 (e.g., in a direction toward environment viewing component 760). It should be appreciated that alternatively, in some embodiments, computer system 101 increases a value of an optical focus setting (e.g., optical power) of environment viewing component 760 in response to movement of finger 708a performed on second surface 738b toward the front of support element 702 and decreases a value of an optical focus setting of environment viewing component 760 in response to movement of finger 708a performed on second surface 738b toward the back of support element 702.

FIG. 7J illustrates user 704 performing a touch input on third surface 738c of support element 702. In response to detecting the touch input performed on third surface 738c, computer system 101 forgoes performing an operation (e.g., changing an appearance of a portion of environment 700 from the current viewpoint of user 704). As shown in FIG. 7J, the touch input includes a contact on third surface 738c and not on first surface 738a or second surface 738b. In response to the contact on the third surface 738c, computer system 101 maintains the optical focus appearance of the portion of environment 700 to an appearance corresponding to optical focus value 726e (e.g., and optionally does not update different parameters of environment 700 (e.g., brightness), or perform a user interface operation (e.g., changing UI focus)). In some embodiments, computer system 101 does not change the appearance of environment 700 (e.g., including performing a UI operation) in response to touch inputs detected on only third surface 738c. As shown in FIG. 7J, the touch input includes movement of finger 708a on third surface 738c (e.g., from position 708a-1 to position 708a-2). In some embodiments, computer system 101 forgoes performing an operation (e.g., changing an appearance of a portion of environment 700) in response to different types of inputs detected on third surface 738c and not first surface 738a and/or second surface 738b (e.g., tap inputs (e.g., including single tap inputs or multi-tap inputs (e.g., double or triple tap inputs)), multi-finger inputs, swipe inputs that are less than a threshold velocity and/or duration, or swipe inputs that are greater than a threshold velocity and/or duration).

FIG. 7K illustrates an indication 718 being displayed (e.g., via a display generation component) in environment 700 surrounding virtual element 716a. In some embodiments, indication 718 represents a current UI focus (e.g., having one or more characteristics of UI focus described above). For example, virtual element 716a has the current UI focus within virtual object 714 (e.g., virtual object 714 is a user interface of a respective application (e.g., an image storage application as previously discussed)). In some embodiments, indication 718 is displayed in environment 700 in response to user input (e.g., a touch input detected on a respective surface of support element 702). It should be appreciated that indication 718 is an exemplary representation of UI focus, and in some embodiments, UI focus is displayed by computer system 101 in a different manner (e.g., by changing one or more visual characteristics of virtual element 716a (e.g., enlarging, changing a brightness and/or color, and/or displaying one or more indications within or on virtual element 716a)).

In some embodiments, computer system 101 assigns (e.g., through (e.g., pre-set) system settings and/or user settings (e.g., based on preferences of a user stored in a user profile)) different operations to different surfaces of support element 702. For example, one or more UI operations (e.g., changing UI focus) are assigned to first surface 738a (e.g., as shown and described below with reference to FIG. 7L), and one or more operations for changing a parameter of a portion of environment 700 (e.g., changing optical focus appearance) are assigned to second surface 738b (e.g., as shown and described above with reference to FIG. 7I). For example, in accordance with a first type of input (e.g., a swipe input) being detected on first surface 738a (e.g., and not second surface 738b), computer system 101 performs a UI operation (e.g., changing UI focus, or selecting a virtual element) in environment 700, and in accordance with the first type of input (e.g., the same swipe input) being detected on second surface 738b (e.g., and not first surface 738a), computer system 101 performs an operation changing a parameter of a portion of environment 700 (e.g., updating brightness or optical focus appearance).

FIG. 7L illustrates user 704 performing a touch input on first surface 738a corresponding to a request to change the UI focus from virtual element 716a to virtual element 716b in the virtual object 714. In response to detecting the touch input on first surface 738a, computer system 101 updates the UI focus within virtual object 714 to virtual element 716b. As shown in FIG. 7L, computer system 101 displays indication 718 surrounding virtual element 716b (e.g., as opposed to virtual element 716a as shown in FIG. 7K). The touch input includes movement of finger 708a on first surface 738a (e.g., from first position 708a-1 to second position 708a-2). In some embodiments, the change in UI focus is updated to virtual element 716b based on a direction of movement of finger 708a on first surface 738a. For example, as shown in FIG. 7L, the UI focus is updated to virtual element 716b in response to movement of finger 708a on first surface 738a toward the back of support element 702 (e.g., in a direction away from environment viewing component 760). Alternatively, in some embodiments, the UI focus is updated (e.g., from FIG. 7K) to virtual element 716c (e.g., or is maintained at virtual element 716a) in response to the movement of finger 708a toward the back of support element 702. In some embodiments, in response to detecting a second touch input (e.g., after updating the UI focus to virtual element 716b, as shown in FIG. 7L) that includes movement of finger 708a on first surface 738a toward the front of support element 702 (e.g., in a direction toward environment viewing component 760), computer system 101 updates the UI focus to virtual element 716a. In some embodiments, in response to detecting a second touch input (e.g., after updating the UI focus to virtual element 716b, as shown in FIG. 7L) that includes movement of finger 708a on first surface 738a toward the back of support element 702 (e.g., in a direction away from environment viewing component 760), computer system 101 updates the UI focus to virtual element 716c.

FIG. 7M illustrates user 704 performing a touch input on second surface 738b and third surface 738c of support element 702 corresponding to a request to select virtual element 716b. As shown in FIG. 7M, the touch input includes contact with finger 708a on second surface 738b and a second finger 708b on third surface 738c. In some embodiments, the touch input includes concurrent contact on second surface 738b and third surface 738c. For example, the touch input shown in FIG. 7M corresponds to a pinch input (e.g., pinching support element 702 between finger 708a and finger 708b). For example, finger 708a corresponds to a first finger (e.g., that is not a thumb) of hand 706 (e.g., shown in FIG. 7A) and finger 708b corresponds to a thumb of hand 706. In some embodiments, the touch input includes concurrent tap-and-release contacts on second surface 738b and third surface 738c (e.g., fingers 708a and 708b perform lift-off prior to 0.1, 0.2, 0.5, 1, 2, 5, or 10 seconds). In some embodiments, the touch input includes concurrent tap-and-hold contacts on second surface 738b and third surface 738c (e.g., fingers 708a and 708b maintain contact for at least 0.1, 0.2, 0.5, 1, 2, 5, or 10 seconds). In some embodiments, the touch input does not include movement of finger 708a and/or finger 708b along the length of support element 702 (e.g., the touch input does not include one or more swipe inputs on second surface 738b or third surface 738c). In some embodiments, computer system 101 performs a different operation (e.g., from selecting virtual element 716b) in response to a concurrent swipe input performed on second surface 738b and third surface 738c (e.g., finger 708a swipes on second surface 738b while finger 708b swipes (e.g., concurrently) on third surface 738c). For example, in response to a concurrent swipe input, computer system 101 performs a UI operation (e.g., changes the UI focus) or changes a parameter of a portion of environment 700 (e.g., changes a magnification of a portion of environment 700, such as shown and described with reference to FIGS. 7O-7Q).

In some embodiments, in response to the touch input performed by user 704 in FIG. 7M, computer system 101 selects virtual element 716b. For example, as shown in FIG. 7N, computer system 101 updates the display of virtual object 714 to enlarge virtual element 716b within virtual object 714 (e.g., such that virtual element 716b occupies a greater area of virtual object 714).

In some embodiments, computer system 101 assigns (e.g., through (e.g., pre-set) system settings and/or user settings (e.g., based on preferences of a user stored in a user profile)) different operations to different touch inputs performed on a respective surface of support element 702. For example, a first operation for changing a first parameter (e.g., brightness) of a portion of environment 700 is assigned to a first touch input (e.g., a swipe input) performed on first surface 738a, and a second operation for changing a second parameter (e.g., magnification), different from the first parameter, of a portion of environment 700 is assigned to a second touch input (e.g., a multi-finger input) performed on first surface 738a (e.g., the swipe input shown and described above with reference to FIGS. 7B-7D compared to the multi-finger tap input shown and described below with reference to FIGS. 7O-7P). For example, a UI operation (e.g., selecting a virtual element) is assigned to a first touch input (e.g., a single finger input) performed on first surface 738a, and an operation for changing a parameter (e.g., magnification) of a portion of environment 700 is assigned to a second touch input (e.g., a multi-finger input) performed on first surface 738a (e.g., the swipe input shown and described above with reference to FIG. 7L compared to the multi-finger tap input shown and described below with reference to FIGS. 7O-7P).

FIG. 7O illustrates user 704 performing a touch input on first surface 738a corresponding to a request to change a magnification of a portion of environment 700. In some embodiments, a magnification of a portion of environment 700 (e.g., a portion of environment 700 visible to user 704 through environment viewing component 760) is changed using a variable optical component of environment viewing component 760 (e.g., one or more liquid crystal lenses). For example, by adjusting the variable optical component, the magnifying power of environment viewing component 760 is changed (e.g., thereby changing an appearance of a portion of environment 700 that is viewed by user 704 through environment viewing component 760). In some embodiments, a magnification of a portion of environment 700 is changed using a display generation component of computer system 101. For example, computer system 101 changes a display size of a virtual object (e.g., virtual object 714) displayed in environment 700 using the display generation component. For example, computer system 101 zooms into or out of a user interface included within a virtual object displayed in environment 700.

As shown in FIG. 7O, the touch input includes a multi-finger input. For example, the touch input includes a concurrent tap on first surface 738a with finger 708a and a second finger 708c (e.g., optionally different from finger 708b (e.g., a thumb of hand 706)). In some embodiments, the touch input includes one or more taps (e.g., is a single tap input, or alternatively a double or triple tap input). In some embodiments, the touch input corresponds to a tap-and-release input (e.g., finger 708a and finger 708c perform lift-off from first surface 738a within 0.1, 0.2, 0.5, 1, 2, 5, or 10 seconds from initiating the touch input). In some embodiments, the touch input corresponds to a tap-and-hold input (e.g., finger 708a and finger 708c maintain contact on first surface 738a for more than 0.1, 0.2, 0.5, 1, 2, 5, or 10 seconds).

In some embodiments, as shown in FIG. 7P, computer system 101 changes the magnification of a first portion of environment 700 in response to detecting the input performed by user 704 in FIG. 7O. As shown in FIG. 7P, the magnification of virtual object 714 is increased (e.g., virtual object 714 is enlarged compared to as shown in FIG. 7O). In some embodiments, increasing the magnification of virtual object 714 includes increasing the display size of virtual object 714 (e.g., and optionally not changing a location of virtual object 714 relative to user 704 in environment 700). Alternatively, in some embodiments, increasing the magnification of virtual object 714 includes changing a location of virtual object 714 relative to user 704 in environment 700 (e.g., to be closer to user 704, such that the display size increases from the viewpoint of user 704). In some embodiments, in FIG. 7P, computer system 101 changes the magnification of virtual object 714 using a display generation component (e.g., having one or more characteristics of display generation component 120).

In some embodiments, as shown in FIG. 7Q, computer system 101 changes the magnification of a second portion of environment 700 (e.g., optionally different from the first portion of environment 700 described with reference to FIG. 7P) in response to detecting the input performed by user 704 in FIG. 7O. For example, the second portion of environment 700 includes the portion of environment 700 visible to user 704 through environment viewing component 760 from their current viewpoint. As shown in FIG. 7Q, the second portion of environment 700 includes optical passthrough of the physical environment of user 704 (e.g., including real-world window 710). In some embodiments, the magnification of the optical passthrough of the physical environment of user 704 is changed using a variable optical component (e.g., one or more liquid lenses) of environment viewing component 760. For example, by adjusting the variable optical component, the magnification power of environment viewing component 760 changes (e.g., thereby changing the level of magnification of the optical passthrough visible in environment 700 from the current viewpoint of user 704).

As shown in FIG. 7Q, computer system 101 increases the magnification of virtual object 714 (e.g., in addition to increasing the magnification of the passthrough of the physical environment of user 704). Alternatively, in some embodiments, computer system 101 increases the magnification of the passthrough of the physical environment of user 704 without increasing the magnification of virtual object 714 (e.g., virtual object 714 maintains display at the same location in environment 700, and/or maintains the same display size relative to the viewpoint of user 704).

In some embodiments, in response to a second touch input, computer system 101 decreases the magnification of a portion of environment 700 (e.g., using the variable optical component of environment viewing component 760). For example, the second touch input is performed on second surface 738b (e.g., as opposed to first surface 738a). For example, the second touch input is a different type of touch input (e.g., compared to as shown in FIG. 7O (e.g., a single finger input, a tap input including a different quantity of taps, or a touch input including movement (e.g., movement of at least one finger on at least one surface of support element 702)).

In some embodiments, computer system 101 includes multiple support elements. For example, as shown in FIG. 7R, computer system 101 includes a first support element 712a and a second support element 712b. In some embodiments, first support element 712a is a first support arm coupled to environment viewing component 760 (e.g., and supported by a first ear (e.g., a left ear) of user 704 when computer system 101 is worn), and second support element 712b is a second support arm coupled to environment viewing component 760 (e.g., and supported by a second ear (e.g., a right ear) of user 704 when computer system 101 is worn). In some embodiments, first support element 712a and second support element 712b have one or more characteristics of support element 712 shown and described with reference to FIGS. 7A-7Q. As shown in FIG. 7R, first support element 712a includes a first surface 740a (e.g., a side surface (e.g., a left side from a perspective of user 704)), a second surface 740b (e.g., a top surface), and a third surface 740c (e.g., a bottom surface). Further, as shown in FIG. 7R, second support element 712b includes a first surface 742a (e.g., a side surface (e.g., a right side from a perspective of user 704)), a second surface 742b (e.g., a top surface), and a third surface 740c (e.g., a bottom surface). In some embodiments, first surface 740a and first surface 742a have one or more characteristics of first surface 738a shown and described with reference to FIGS. 7B-7Q. In some embodiments, second surface 740b and second surface 742b have one or more characteristics of second surface 738b shown and described with reference to FIGS. 7B-7Q. In some embodiments, third surface 740c and third surface 742c have one or more characteristics of third surface 738c shown and described with reference to FIGS. 7B-7Q.

In some embodiments, computer system 101 assigns (e.g., through (e.g., pre-set) system settings and/or user settings (e.g., based on preferences of a user stored in a user profile)) different operations to different support elements. For example, a first operation for changing a first parameter (e.g., brightness) of a portion of environment 700 is assigned to first support element 712a, and a second operation for changing a second parameter (e.g., optical focus appearance) of a portion of environment 700 is assigned to second support element 712b. For example, one or more UI operations are assigned to first support element 712a, and one or more operations for changing one or more parameters (e.g., changing brightness and/or optical focus appearance) of a portion of environment 700 are assigned to second support element 712b. In some embodiments, a respective operation is assigned to a respective surface of a respective support element (e.g., and optionally to a respective touch gesture performed on the assigned surface). For example, changing optical focus appearance is assigned to first surface 740a of first support element 712a (e.g., and not to first surface 742a of second support element 712b), and changing UI focus is assigned to second surface 742b of second support element 712b (e.g., and not to second surface 740b of first support element 712a). For example, changing a parameter (e.g., brightness) in a first manner is assigned to second surface 740b of first support element 712a (e.g., and not to second surface 742b of second support element 712b), and changing the parameter in a second manner, different from the first manner, is assigned to second surface 742b of second support element 712b (e.g., and not to second surface 740b of first support element 712a).

FIG. 7S illustrates user 704 performing a touch input on first surface 742a of second support element 712b. In some embodiments, the touch input corresponds to a request to change a value of brightness for a portion of environment 700 (e.g., the portion of environment 700 visible to user 704 through environment viewing component 760). As shown in FIG. 7S, in response to detecting the touch input on first surface 742a of second support element 712b, computer system 101 changes the brightness of a portion of environment 700 (e.g., environment 700 is darker compared to as shown in FIG. 7R). The touch input includes movement of a finger 734a on first surface 742a (e.g., from a first position 734a-1 to a second position 734a-2). In some embodiments, finger 734a is a finger (e.g., different from finger 708a) of a second hand (e.g., a right hand) of user 704 (e.g., different from hand 706). For example, finger 734a is from a hand of user 704 on the same side as second support element 712b (e.g., on a right side of user 704). In some embodiments, in response to detecting a touch input on first surface 742a different from the touch input shown in FIG. 7S (e.g., a tap input), computer system 101 changes the brightness of the portion of environment 700 in a different manner (e.g., such as the first manner or the second manner described with reference to FIGS. 7C-7G). In some embodiments, in response to detecting a touch input on first surface 742a different from the touch input shown in FIG. 7S (e.g., a tap input), computer system 101 performs a different operation in environment 700 (e.g., performs a UI operation (e.g., changing UI focus), or changes a different parameter (e.g., magnification) of the appearance of a portion of environment 700). In some embodiments, in response to an input detected on a different surface of second support element 712b (e.g., second surface 742b and/or third surface 742c), computer system 101 performs a different operation in environment 700 (e.g., different from changing a value of brightness).

FIG. 7T illustrates user 704 performing a touch input on first surface 740a of first support element 712a. In some embodiments, the touch input on first surface 740a corresponds to a request to change optical focus appearance of a portion of environment 700. The touch input optionally includes movement of finger 708a on first surface 740a (e.g., from a first position 708a-1 to a second position 708a-2). In some embodiments, finger 708a is a finger from an opposite hand from finger 734a (e.g., shown in FIG. 7S). For example, finger 708a is from a hand (e.g., hand 706 shown in FIG. 7A) on the same side of user 704 as first support element 712a (e.g., on a left side of user 704). As shown in FIG. 7T, in response to detecting the touch input on first surface 740a of first support element 712a, computer system 101 changes an optical focus appearance of a portion of 700 (e.g., as represented by the dotted fill pattern shown in FIG. 7T). In some embodiments, in response to detecting a touch input on first surface 740a different from the touch input shown in FIG. 7T (e.g., a tap input), computer system 101 changes the optical focus appearance of the portion of environment 700 in a different manner (e.g., such as the first manner or the second manner described with reference to changing brightness in FIGS. 7C-7G). In some embodiments, in response to detecting a touch input on first surface 740a different from the touch input shown in FIG. 7S (e.g., a tap input), computer system 101 performs a different operation in environment 700 (e.g., performs a UI operation (e.g., selecting a virtual element), or changes a different parameter (e.g., magnification) of the appearance of a portion of environment 700. In some embodiments, in response to detecting an input detected on a different surface of first support element 712a (e.g., second surface 740b and/or third surface 740c), computer system 101 performs a different operation in environment 700 (e.g., different from changing optical focus appearance).

FIG. 7U illustrates a plurality of touch inputs that are assigned to different surfaces of first support element 712a. In some embodiments, as shown in box 762a, a movement input (e.g., swipe input) is performed on second surface 740b (e.g., having one or more characteristics of the touch input shown and described with reference to FIG. 7I). In some embodiments, in response to the movement input detected on second surface 740b, computer system 101 performs the operation shown and described with reference to FIG. 7I. Alternatively, in some embodiments, in response to the movement input detected on second surface 740b, computer system 101 performs a different operation from the operation shown and described with reference to FIG. 7I (e.g., computer system 101 performs a UI operation, or changes a different parameter of a portion of environment 700). In some embodiments, as shown in box 762b, a movement input (e.g., swipe input) is performed on third surface 740c (e.g., having one or more characteristics of the touch input shown and described with reference to FIG. 7J). In some embodiments, in response to the movement input detected on third surface 740c, computer system 101 forgoes performing an operation in environment 700 (e.g., as shown and described with reference to FIG. 7J). Alternatively, in some embodiments, in response to the movement input detected on third surface 740c, computer system 101 performs an operation in environment 700 (e.g., computer system 101 changes an appearance (e.g., a parameter, such as brightness) of a portion of environment 700 or performs a UI operation). In some embodiments, as shown in box 762c, a multi-finger is performed on first surface 740a (e.g., having one or more characteristics of the touch input shown and described with reference to FIG. 7O). In some embodiments, in response to the multi-finger input detected on first surface 740a, computer system 101 performs the operation shown and described with reference to FIG. 7P. Alternatively, in some embodiments, in response to the multi-finger input detected on first surface 740a, computer system 101 performs a different operation from the operation shown and described with reference to FIG. 7P (e.g., computer system 101 performs a UI operation, or changes a different parameter of a portion of environment 700). In some embodiments, as shown in box 762d, a movement input is performed on first surface 740a (e.g., having one or more characteristics of the touch input shown and described with reference to FIG. 7L). In some embodiments, in response to the movement input detected on first surface 740a, computer system 101 performs an operation shown and described with reference to FIGS. 7B-7D, FIG. 7E, or FIG. 7L. Alternatively, in some embodiments, in response to the movement input detected on first surface 740a, computer system 101 performs a different operation from the operations shown and described in FIGS. 7B-7D, FIG. 7E, or FIG. 7L (e.g., computer system 101 changes a magnification of a portion of environment 700). In some embodiments, as shown in box 762e, a pinch input is performed on second surface 740b and third surface 740c (e.g., having one or more characteristics of the touch input shown and described with reference to FIG. 7M). In some embodiments, in response to the pinch input detected on second surface 740b and third surface 740c, computer system 101 performs the operation shown and described with reference to FIG. 7N. Alternatively, in some embodiments, in response to the pinch input detected on second surface 740b and third surface 740c, computer system 101 performs a different operation from the operation shown and described with reference to FIG. 7N (e.g., computer system 101 changes a brightness or optical focus appearance). In some embodiments, as shown in box 762f, a stationary input (e.g., tap input) is performed on first surface 740a (e.g., having one or more characteristics of the touch input shown and described with reference to FIG. 7F). In some embodiments, in response to the stationary input detected on first surface 740a, computer system 101 performs the operation shown and described with reference to FIG. 7G. Alternatively, in some embodiments, in response to the stationary input detected on first surface 740a, computer system 101 performs a different operation from the operation shown and described with reference to FIG. 7G (e.g., computer system 101 selects a virtual element).

It should be appreciated that the touch inputs shown and described with reference to FIG. 7U are exemplary, and computer system 101 may assign operations to alternative touch inputs performed on one or more respective surfaces of first support element 712a. For example, computer system 101 assigns an operation to a tap input performed on second surface 740b, a multi-finger input on second surface 740b, a multi-tap input (e.g., double or triple tap) on first surface 740a, a multi-tap input on second surface 740b, a tap-and-hold input (e.g., a tap input maintained for more than 0.1, 0.2, 0.5, 1, 2, 5, or 10 seconds) on first surface 740a, a tap-and-hold input on second surface 740b, or a swipe pinch input (e.g., concurrent swipe inputs performed (e.g., with different fingers)) on second surface 740b and third surface 740c.

FIG. 7V illustrates a plurality of touch inputs that are assigned to different surfaces of second support element 712b. In some embodiments, as shown in box 764a, a movement input (e.g., swipe input) is performed on second surface 742b (e.g., having one or more characteristics of the touch input shown and described with reference to FIG. 7I). In some embodiments, in response to the swipe input detected on second surface 742b, computer system 101 performs an operation different from the operation performed in response to the swipe input detected on second surface 740b (e.g., as shown described with reference to FIG. 7U). In some embodiments, as shown in box 764b, a movement input is performed on third surface 742c (e.g., having one or more characteristics of the touch input shown and described with reference to FIG. 7J). In some embodiments, in response to the swipe input detected on third surface 742c, computer system 101 forgoes performing an operation in environment 700 (e.g., as shown and described with reference to FIG. 7J). Alternatively, in some embodiments, in response to the swipe input detected on third surface 742c, computer system 101 performs an operation in environment 700 (e.g., different from an operation performed in response to the swipe input detected on third surface 740c (e.g., as shown and described with reference to FIG. 7U)). In some embodiments, as shown in box 764c, a multi-finger is performed on first surface 742a (e.g., having one or more characteristics of the touch input shown and described with reference to FIG. 7O). In some embodiments, in response to the multi-finger input detected on first surface 742a, computer system 101 performs an operation different from the operation performed in response to the multi-finger input on first surface 740a (e.g., as shown and described with reference to FIG. 7U). In some embodiments, as shown in box 764d, a movement input (e.g., swipe input) is performed on first surface 742a (e.g., having one or more characteristics of the touch input shown and described with reference to FIG. 7L). In some embodiments, in response to the movement input detected on first surface 742a, computer system 101 performs an operation different from the operation performed in response to the movement input detected on first surface 740a (e.g., as shown and described with reference to FIG. 7U). In some embodiments, as shown in box 764e, a pinch input is performed on second surface 742b and third surface 742c (e.g., having one or more characteristics of the touch input shown and described with reference to FIG. 7M). In some embodiments, in response to the pinch input detected on second surface 742b and third surface 742c, computer system 101 performs an operation different from the operation performed in response to the pinch input detected on second surface 740b and third surface 740c (e.g., as shown and described with reference to FIG. 7U). In some embodiments, as shown in box 764f, a tap input is performed on first surface 742a (e.g., having one or more characteristics of the touch input shown and described with reference to FIG. 7F). In some embodiments, in response to the tap input detected on first surface 742a, computer system 101 performs a different operation from the operation performed in response to the tap input detected on first surface 740a (e.g., as shown and described with reference to FIG. 7U).

It should be appreciated that the touch inputs shown and described with reference to FIG. 7V are exemplary, and computer system 101 may assign operations to alternative touch inputs performed on one or more respective surfaces of second support element 712b. For example, computer system 101 assigns an operation to a tap input performed on second surface 742b, a multi-finger input on second surface 742b, a multi-tap input (e.g., double or triple tap) on first surface 742a, a multi-tap input on second surface 742b, a tap-and-hold input (e.g., a tap input maintained for more than 0.1, 0.2, 0.5, 1, 2, 5, or 10 seconds) on first surface 742a, a tap-and-hold input on second surface 742b, or a swipe pinch input (e.g., concurrent swipe inputs performed (e.g., with different fingers)) on second surface 742b and third surface 742c.

In some embodiments, user operation of computer system 101 requires user 704 to handle (e.g., grab) computer system 101 using one or more support elements (e.g., support element 702) of computer system 101 (e.g., when user 704 is not wearing computer system (e.g., when user 704 is putting on or taking off computer system 101)). In some embodiments, in response to user operation of computer system 101 that requires user 704 to handle computer system 101 using the one or more support elements, computer system 101 does not perform one or more operations (e.g., in environment 700), as discussed below.

FIG. 7W illustrates computer system 101 in a physical environment 736 of user 704 when user 704 is not currently wearing computer system 101. As shown in FIG. 7W, user 704 is grabbing support element 702 of computer system 101 with hand 706. For example, in FIG. 7W, user 704 has taken off computer system 101 (e.g., and is placing computer system 101 on a real-world surface (e.g., a table) in physical environment 736). Alternatively, in FIG. 7W, user 704 is putting on computer system 101 (e.g., by grabbing and lifting computer system 101 from a real-world surface (e.g., a table) in physical environment 736). Alternatively or additionally, in FIG. 7W, user 704 is lifting computer system 101 to move computer system 101 to a new location in physical environment 736. As a result of user 704 grabbing support element 702, a contact (e.g., from finger 708a) is detected on first surface 738a. Optionally, computer system 101 does not detect the contact on first surface 738a (e.g., because computer system 101 is powered off, or in an idled (e.g., sleep) state).

In FIG. 7X, in response to detecting the contact on first surface 738a, computer system 101 forgoes performing an operation (e.g., in environment 700 viewed through environment viewing component 760). As shown in schematic 720 in FIG. 7X (e.g., compared to FIG. 7W), the brightness of environment 700 remains at brightness value 722a in response to the contact of finger 708a (e.g., optionally detected) on first surface 738a. For example, computer system 101 forgoes changing the brightness (e.g., and/or other parameters) of environment 700 because computer system 101 is not currently worn by user 704 (e.g., computer system 101 changes the brightness of environment 700 in response to contact detected on first surface 738a while computer system 101 is worn by user 704 (e.g., as shown and described with reference to FIGS. 7F-7G)). In some embodiments, computer system 101 forgoes changing other parameters of environment 700 in response to the contact of finger 708a (e.g., that is optionally detected) on first surface 738a in FIG. 7W (e.g., optical focus appearance, magnification, color, and/or saturation). In some embodiments, computer system 101 forgoes performing one or more UI operations in response to the contact of finger 708a (e.g., that is optionally detected) on first surface 738a in FIG. 7W (e.g., changing UI focus, selecting a virtual element, scrolling, displaying a virtual object and/or ceasing to display a virtual object).

FIG. 8 is a flowchart illustrating an exemplary method 800 of performing an operation in an environment in response to detecting an input on a support element of a computer system. The user interfaces in FIGS. 7A-7X are used to illustrate the processes described with reference to FIG. 8. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system (e.g., computer system 101) in communication with an environment viewing component (e.g., environment viewing component 760) and one or more input devices (e.g., image sensors 114a-114c). In some embodiments, the computer system is or includes an electronic device, such as a mobile device (e.g., a tablet, a smartphone, a media player, or a wearable device), or a computer. In some embodiments, the environment viewing component is a translucent display. In some embodiments, the environment viewing component includes one or more lenses (e.g., one or more optical liquid lenses) that a user of the computer system is able to view a physical environment through. In some embodiments, the computer system includes a display generation component (e.g., optionally integrated with the environment viewing component). In some embodiments, the display generation component is a display integrated with the computer system (optionally a touch screen display), external display such as a monitor, projector, television, or a hardware component (optionally integrated or external) for projecting a user interface or causing a user interface to be visible to one or more users. In some embodiments, the environment viewing component is a display generation component. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller. In some embodiments, at least a portion of the one or more input devices is partially or entirely integrated into a housing of the computer system. For example, the one or more input devices include one or more touch-sensitive surfaces (e.g., touch screen displays and/or touch pads (e.g., trackpads)) that are integrated into a housing of the computer system). In some embodiments, at least a portion of the one or more input devices is partially or entirely external to the computer system and in communication (e.g., wirelessly and/or via a wired connection) with the computer system.

In some embodiments, while an environment is visible, via the environment viewing component, from a current viewpoint of a user of the computer system, the computer system detects (802a), via the one or more input devices, a first input on a support element of the computer system corresponding to a request to perform an operation that changes an appearance of at least a portion of the environment when viewed via the environment viewing component, such as the touch input detected on first surface 738a of support element 702 shown in FIGS. 7B-7D, or the touch input detected on second surface 738b of support element 702 shown in FIG. 7I. In some embodiments, the environment is a three-dimensional environment that is generated, displayed, or otherwise caused to be viewable by the computer system. For example, the environment is an extended reality (XR) environment, such as a virtual reality (VR) environment, a mixed reality (MR) environment, or an augmented reality (AR) environment. In some embodiments, the environment includes one or more virtual objects and/or representations of objects in a physical environment of a user of the computer system. In some embodiments, the environment includes video passthrough and/or optical passthrough of the user's physical environment. In some embodiments, the environment is the user's physical environment (e.g., and does not include an XR environment generated by the computer system). In some embodiments, the computer system is a wearable device, and the support element enables the computer system to be worn by a user of the computer system (e.g., the support element is a support arm (e.g., a glasses arm), strap, or band (e.g., a bracelet or watch band)). In some embodiments, the support element includes one or more surfaces (e.g., the one or more surfaces include one or more touch-sensitive surfaces and optionally one or more non-touch-sensitive surfaces). For example, the input is detected at a touch-sensitive surface associated with (e.g., attached to and/or integrated with) a surface of the one or more surfaces of the support element. The support element is optionally incorporated with (e.g., coupled to and/or a part of) the housing of the computer system. In some embodiments, the first input includes a gesture performed relative to the one or more surfaces of the support element. For example, the one or more surfaces include a top surface, a bottom surface, and/or a side surface. In some embodiments, the first input includes movement of one or more portions of the user (e.g., one or more fingers of a hand of the user) relative to the one or more surfaces of the support element (e.g., while in contact with the one or more surfaces). In some embodiments, performing the operation that changes an appearance of at least a portion of the environment includes changing one or more visual features of the environment from the current viewpoint of the user. For example, the first input corresponds to a request to change the brightness (e.g., dimming), focus (e.g., changing focal power of the environment viewing component), magnification, tint, color and/or saturation of the environment and/or one or more objects (e.g., virtual objects and/or windows) visible (e.g., displayed) in the environment from the current viewpoint of the user. In some embodiments, performing the operation in the environment includes interacting with one or more virtual objects displayed in the environment. For example, the first input corresponds to a request to select a selectable option (e.g., a user interface element displayed with a virtual window), to display a virtual object (e.g., via selection of an icon), to move a virtual object, and/or to scroll a scrollable window (e.g., associated with a webpage or a social media application) in the environment.

In some embodiments, in response to detecting the first input (802b), in accordance with a determination that the first input includes contact on a first surface of the support element (e.g., without including contact on a second surface of the support element), the computer system performs (802c) a first operation that changes an appearance of at least a portion of the environment when viewed via the environment viewing component, such as the change in brightness of environment 700 shown in FIGS. 7B-7D in response to the touch input detected on first surface 738a. In some embodiments, the first surface is one of a plurality of surfaces of the support element (e.g., the plurality of surfaces includes a second surface, different from the first surface (as described below)). In some embodiments, the first surface is a touch-sensitive surface partially or entirely integrated with the support element. In some embodiments, the computer system performs the first operation in accordance with the determination that the first input includes a first touch gesture (e.g., a first type of touch gesture, such as a tap, tap-and-hold (e.g., a contact maintained on the surface for at least a threshold amount of time (e.g., 0.1, 0.2, 0.5, 1, 2, 5, or 10 seconds)), and/or a swipe) that is performed on the first surface of the support element. In some embodiments, the first operation is specifically associated with the first touch gesture (e.g., the first operation is performed in accordance with a determination that the first input corresponds to the first touch gesture, rather than a second touch gesture, as discussed below). In some embodiments, the first operation is associated with the first surface (e.g., the first operation is performed in accordance with a determination that the first input is performed on the first surface and not on a surface of the support element different from the first surface (e.g., the second surface, as described below)). In some embodiments, the first operation is associated with the first touch gesture and the first surface (e.g., the first operation is performed in accordance with a determination that the first input corresponds to the first touch gesture and that the first input is performed on the first surface). In some embodiments, the first operation includes changing one or more visual features of the environment and/or one or more objects visible (e.g., displayed) in the environment from the current viewpoint of the user (e.g., changing the brightness (e.g., dimming), focus, magnification, tint, color and/or saturation of the environment and/or one or more objects visible in the environment). For example, the first operation includes decreasing an apparent brightness level of the physical environment, such that one or more objects from/in the physical environment that are visible through video passthrough or optical passthrough in the environment appear to be dimmed from the current viewpoint of the user. In some embodiments, the first operation includes selecting, moving, and/or changing the size of one or more virtual objects (e.g., virtual windows and/or containers) displayed in the environment from the current viewpoint of the user. For example, the first operation includes moving a virtual window from a first location to a second location in the environment from the current viewpoint of the user. In some embodiments, the first operation includes scrolling, selecting, and/or controlling the playback of content (e.g., application content, webpage content, video content, images and/or documents) displayed in the environment from the current viewpoint of the user. For example, the first operation includes scrolling through social media content associated with an application that is accessible to the user through the computer system.

In some embodiments, in response to detecting the first input (802b), in accordance with a determination that the first input includes contact on a second surface, different from the first surface, of the support element (e.g., without including contact on the first surface of the support element), the computer system performs (802d) a second operation, different from the first operation, that changes an appearance of at least a portion of the environment when viewed via the environment viewing component, such as the change in optical focus appearance shown in FIG. 7I in response to the touch input detected on second surface 738b. In some embodiments, the second surface is a touch-sensitive surface partially or entirely integrated with the support element. In some embodiments, the first surface is arranged perpendicular to (e.g., or within 0.1, 0.2, 0.3, 0.5, 1, 2, 3, 4, 5, 10, 15, 20, 25, 30, 35, 40 or 45 degrees of perpendicular to) the second surface. For example, the first surface is a side surface of the support element, and the second surface is a top or bottom surface of the support element. In some embodiments, the first surface is arranged on an opposite side of the second surface (e.g., the first surface is arranged parallel to (e.g., or within 0.1, 0.2, 0.3, 0.5, 1, 2, 3, 4, 5, 10, 15, 20, 25, 30, 35, 40 or 45 parallel to) the second surface). For example, the first surface is a top surface of the support element, and the second surface is a bottom surface of the support element (e.g., or the first surface is a bottom surface of the support element and the second surface is a top surface of the support element). As another example, the first surface is a first side surface (e.g., left or right side surface) of the support element, and the second surface is a second side surface, opposite to the first side surface, of the support element. In some embodiments, the first surface and the second surface are touch-sensitive surfaces partially or entirely integrated into the housing of the computer system (e.g., the first surface and the second surface are not surfaces of the support element). For example, the first surface is a side surface of the housing (e.g., optionally not including the support element) and the second surface is a top or bottom surface of the housing. As another example, the first surface is a top or bottom surface of the housing of the computer system and the second surface is a side surface of the housing. In some embodiments, the housing includes a frame surrounding the environment viewing component, and the first surface and the second surface are different surfaces of the frame. In some embodiments, the first surface corresponds to a first region of a touch-sensitive surface (e.g., a touch screen display and/or touch pad), and the second surface corresponds to a second region, different from the first region, of the touch-sensitive surface. In some embodiments, the computer system performs the second operation in accordance with the determination that the first input includes a second touch gesture that is performed on the second surface of the support element. In some embodiments, the second touch gesture is different from the first touch gesture (e.g., the first touch gesture is a first type of touch gesture (e.g., a tap, tap-and-hold, and/or a swipe in a first direction) and the second touch gesture is a second type of touch gesture different from the first type of touch gesture (e.g., a tap and hold, a double-tap, and/or a swipe in a second direction, opposite the first direction). In some embodiments, the second touch gesture is the same as the first touch gesture (e.g., the second touch gesture is the same type of touch gesture as the first touch gesture but performed on a different surface of the support element from the first touch gesture). In some embodiments, the second operation is specifically associated with the second touch gesture (e.g., the second operation is performed in accordance with a determination that the first input corresponds to the second touch gesture). In some embodiments, the second operation is associated with the second surface (e.g., the second operation is performed in accordance with a determination that the first input is performed on the second surface and not on a surface of the support element different from the second surface (e.g., the first surface)). In some embodiments, the second operation is associated with the second touch gesture and the second surface (e.g., the second operation is performed in accordance with a determination that the first input corresponds to the second touch gesture and that the first input is performed on the second surface). In some embodiments, the second operation includes changing one or more different visual features of the environment (e.g., and/or one or more objects visible in the environment) that are different from the one or more visual features changed by the first operation (e.g., the first operation includes changing a first visual feature in the environment (e.g., brightness, focus, magnification, tint, color and/or saturation) and the second operation includes changing a second visual feature in the environment different from the first visual feature). For example, the second operation includes changing the focus of the environment from the current viewpoint of the user (e.g., while the first operation includes dimming the environment from the current viewpoint of the user). In some embodiments, the second operation includes different types of user interaction with one or more virtual objects in the environment compared to the first operation. For example, the second operation includes changing the size of a virtual object in the environment from the current viewpoint of the user (e.g., while the first operation includes moving the virtual object in the environment from the current viewpoint of the user). In some embodiments, the second operation includes different types of user interaction with content displayed in the environment compared to the first operation. For example, the second operation includes controlling the playback volume of video content displayed within an application window (e.g., while the first operation includes scrolling through the content in the application window). In some embodiments, the first operation includes changing one or more visual features of the environment (e.g., and/or one or more objects visible in the environment) and the second operation includes interacting with one or more virtual objects and/or content displayed in the environment. In some embodiments, the first operation includes interacting with one or more virtual objects and/or content displayed in the environment and the second operation includes changing one or more visual features of the environment (e.g., and/or one or more visual features of one or more objects visible (e.g., displayed) in the environment). Performing a first operation based on an input that includes contact on a first surface of a support element and performing a second operation (e.g., different from the first operation) based on an input that includes contact on a second surface of the support element reduces the likelihood that an operation is performed using the support element that a user does not intend to be performed (e.g., by assigning the first operation and the second operation to different surfaces of the support element), thereby reducing errors in user-device interaction, and helping reduce the need for input to correct such unintended operations.

In some embodiments, the first input includes a tap on the support element of the computer system, such as the tap input detected on first surface 738 in FIG. 7F. In some embodiments, the tap is detected on a respective surface of the support element (e.g., the first surface or the second surface). In some embodiments, the tap is performed by an object (e.g., a portion of a user of the computer system). For example, the portion is or includes one or more fingers of a hand of the user. In some embodiments, the first input includes one or more taps on the support element (e.g., a double or triple tap). In some embodiments, the first input corresponds to a tap and release input on the support element (e.g., the release of the tap occurs within a threshold period of time from initiation of the tap (e.g., 0.01, 0.05, 0.1, 0.2, 0.5, 1, 2, 5, or 10 seconds)). For example, lift-off (e.g., of an object) is detected 0.01, 0.05, 0.1, 0.2, 0.5, 1, 2, 5 or 10 seconds after contact is detected on (e.g., on the first surface and/or the second surface of) the support element. In some embodiments, the first input corresponds to a tap and hold input on the support element (e.g., the release of the tap occurs after a threshold period of time from initiation of the tap (e.g., 0.01, 0.05, 0.1, 0.2, 0.5, 1, 2, 5, or 10 seconds)). In some embodiments, the computer system performs different operation based on the first input corresponding to a tap and release input or a tap and hold input (e.g., the computer system changes different parameters of the at least the portion of the environment, changes a parameter of the at least the portion of the environment in a different manner, or performs different user interface operations). The first input optionally does not include movement on the support element (e.g., the first input does not include a swipe input). In some embodiments, the first input includes one or more taps on the support element (e.g., the user taps a surface of the support element concurrently with two fingers). In some embodiments, the appearance of the at least the portion of the environment is changed in a manner that is based on the quantity of taps on the support element (e.g., the brightness of a portion of the environment is changed to a value that is based on the quantity of taps on the support element). Performing a first operation based on a tap input on a first surface of a support element, and performing a second operation (e.g., different from the first operation) based on a tap input on a second surface of the support element, reduces the different types of inputs required to perform different operations in an environment (e.g., by assigning both the first operation and the second operation to tap inputs), thereby improving user-device interaction.

In some embodiments, the first input includes detected movement (e.g., of a finger or other input element) on the support element of the computer system, such as the touch input detected on first surface 738a shown in FIGS. 7B-7D. In some embodiments, the movement on the support element corresponds to a swipe input on a surface (e.g., the first surface and/or the second surface) of the support element. In some embodiments, the swipe input includes movement in a first direction on the surface of the support element. In some embodiments, the swipe input includes movement in a second direction, opposite the first direction, on the surface of the support element. In some embodiments, the computer system performs different operations based on the first input including movement in the first direction or movement in the second direction (e.g., in accordance with the movement of the first input including movement in the first direction, the computer system increases a parameter of the at least the portion of the environment, and in accordance with the movement of the first input including movement in the second direction, the computer system decreases the parameter of the at least the portion of the environment). In some embodiments, the first input includes movement traversing the length of the surface of the support element (e.g., a swipe input with horizontal movement (e.g., relative to the user's viewpoint)). In some embodiments, the swipe input corresponds to movement traversing the width and/or height of the surface of the support element (e.g., a swipe input with vertical movement (e.g., relative to the user's viewpoint)). In some embodiments, the movement detected on the support element is multi-directional (e.g., movement in the first and/or second direction, or movement in a horizontal direction and/or vertical direction, successively). In some embodiments, the movement detected on the support element is less than a threshold velocity (e.g., the threshold velocity is 0.01, 0.05, 0.1, 0.2, 0.5 or 1 m/s) and/or duration (e.g., the threshold duration is 0.1, 0.2, 0.5, 1, 2, 5, or 10 seconds). In some embodiments, the movement detected on the support element is greater than the threshold velocity and/or duration. In some embodiments, the at least the portion of the environment is changed in a different manner when the movement detected on the support element is greater than the threshold velocity and/or duration compared to when the movement detected on the support element is less than the threshold velocity and/or duration (e.g., as described with reference to changing the first parameter of the at least portion of the environment below). Performing a first operation based on movement detected on a first surface of a support element, and performing a second operation (e.g., different from the first operation) based on movement detected on a second surface of the support element, reduces the different types of inputs required to perform different operations in an environment (e.g., by assigning both the first operation and the second operation to inputs that include movement of an object (e.g., swipe inputs)), thereby improving user-device interaction.

In some embodiments, performing the first operation includes, in accordance with a determination that the first input corresponds to a first gesture performed by a first portion of a user of the computer system, performing a third operation corresponding to the first gesture, such as changing UI focus in response to the movement input detected on first surface 738a shown in FIG. 7L. In some embodiments, performing the first operation includes, in accordance with a determination that the first input corresponds to a second gesture, different from the first gesture, performed by the first portion of the user, performing a fourth operation corresponding to the second gesture, wherein the fourth operation is different from the third operation, such as changing the brightness of environment 700 in response to the stationary input detected on first surface 738a shown in FIG. 7F. In some embodiments, the first portion of the user has one or more characteristics of the portion of the user described above. For example, the first portion of the user includes a finger of a hand of the user. In some embodiments, the first gesture and the second gesture are different types of touch gestures. For example, the first gesture includes a tap input on the support element and the second gesture includes movement on the support element (or vice versa). For example, the first gesture includes an input performed with a first quantity of objects (e.g., with one finger) and the second gesture includes an input performed with a second quantity of objects (e.g., with more than one finger). In some embodiments, in accordance with the determination that the first input corresponds to the first gesture, the computer system does not perform the fourth operation corresponding to the second gesture. In some embodiments, in accordance with the determination that the first input corresponds to the second gesture, the computer system does not perform the third operation corresponding to the first gesture. In some embodiments, in accordance with a determination that the first input corresponds to a third gesture, different from the first gesture and the second gesture, the computer system performs an operation corresponding to the third gesture (e.g., and does not perform the third operation and/or the fourth operation). In some embodiments, performing the second operation includes, in accordance with a determination that the first input corresponds to a third gesture performed by the first portion of the user, performing a fifth operation corresponding to the third gesture (e.g., different from the third operation and/or the fourth operation). In some embodiments, performing the second operation further includes, in accordance with a determination that the first input corresponds to a fourth gesture, different from the third gesture, performed by the first portion of the user, performing a sixth operation corresponding to the fourth gesture (e.g., different from the third operation, the fourth operation, and/or the fifth operation). In some embodiments, the third gesture and the fourth gesture have one or more characteristics of the first gesture and/or the second gesture described above. In some embodiments, the fifth operation and the sixth operation have one or more characteristics of the third operation and/or fourth operation described above. In some embodiments, the third operation includes updating the display of one or more virtual objects displayed in the environment (e.g., as described below). For example, the third operation includes scrolling a user interface, moving the location of a virtual window, and/or selecting a selectable option. In some embodiments, the fourth operation includes updating a visual feature (e.g., a first parameter as described below) of the at least the portion of the environment. For example, the fourth operation includes updating the brightness, focus, color, saturation and/or magnification of the at least the portion of the environment (e.g., the fourth operation includes updating the visual feature for both one or more virtual objects and passthrough of the physical environment visible in the at least the portion of the environment from the current viewpoint of the user). In some embodiments, the third operation includes updating a visual feature of the at least the portion of the environment and the fourth operation includes updating the display of one or more virtual objects displayed in the environment. In some embodiments, the third operation includes updating display of one or more first virtual objects, and the fourth operation includes updating display of one or more second virtual objects (e.g., different from the one or more first virtual objects). In some embodiments, the third operation includes updating the display of one or more virtual objects in a first manner, and the fourth operation includes updating the display of the one or more virtual objects in a second manner, different from the first manner. For example, the third operation includes navigating through a user interface (e.g., changing focus from a first virtual element to a second virtual element), and the fourth operation includes selection of a virtual element within the user interface. Performing different operations in an environment when an input is detected on a first surface of a support element or a second surface of the support element, and based on a type of gesture that is performed on the respective surface, enables a user to perform a plurality of different operations in an environment through the support element and/or helps reduce user errors (e.g., by assigning different operations to different surfaces of the support element and/or to different gestures), thereby improving user-device interaction.

In some embodiments, performing the third operation corresponds to changing a first parameter of the at least the portion of the environment in a first manner, such as changing the brightness of environment 700 in the first manner shown in FIGS. 7B-7D. In some embodiments, performing the fourth operation corresponds to changing the first parameter of the at least the portion of the environment in a second manner, different from the first manner, such as changing the brightness of the environment 700 in the second manner shown in FIGS. 7F-7G. In some embodiments, the first parameter is a visual feature of the environment. For example, the first parameter is the brightness, focus, color, saturation and/or magnification of the at least the portion of the environment. In some embodiments, changing the first parameter includes changing a value of the first parameter (e.g., changing the brightness, focal power, color, saturation and/or magnification of at the at least the portion of the environment from the current viewpoint of the user). In some embodiments, changing the first parameter of the at least the portion of the environment includes changing the first parameter of one or more objects of the physical environment visible via the environment viewing component (e.g., changing the first parameter includes dimming at least a portion of the physical environment viewed via the environment viewing component from the current viewpoint of the user). In some embodiments, changing the first parameter of the at least the portion of the environment includes changing the first parameter of one or more virtual objects displayed (e.g., via a display generation component) in the at least the portion of the environment (e.g., changing the first parameter includes changing the color and/or saturation of one or more virtual objects in the environment). In some embodiments, changing the first parameter of the at least the portion of the environment includes changing the first parameter for both one or more objects of the user's physical environment (e.g., visible as passthrough of the physical environment) and one or more virtual objects (e.g., displayed by a display generation component) viewed by the user via the environment viewing component. In some embodiments, changing the first parameter in the second manner includes updating the first parameter to a value that is not a fixed value of the plurality of fixed values of the first parameter. For example, updating the first parameter in the second manner includes updating the first parameter to a value that is based on a velocity, duration and/or amount of movement of the first movement (e.g., as described below). In some embodiments, performing the second operation includes changing a second parameter of the at least the portion of the environment. In some embodiments, the computer system changes the second parameter of the at least the portion of the environment in a third manner when a third gesture is detected on the support element (e.g., on the second surface of the support element). In some embodiments, the computer system changes the second parameter of the at least the portion of the environment in a fourth manner, different from the third manner, when a fourth gesture, different from the third gesture, is detected on the support element. In some embodiments, the third manner and the fourth manner have one or more characteristics of the first manner and/or the second manner described above. The second parameter is optionally a different parameter from the first parameter (e.g., the first parameter is brightness, and the second parameter is focal power). In some embodiments, in accordance with a determination that the first input includes contact on the first surface of the support element, the computer system changes the first parameter of the at least the portion of the environment, and in accordance with a determination that the second input includes contact on the second surface of the support element, the computer system changes the second parameter of the at least the portion of the environment. Changing a parameter of a portion of an environment in a first manner in response to a first gesture performed on a support element and in a second manner, different from the first manner, in response to a second gesture performed on the support element provides a user discretion in adjusting the parameter using a desired method and/or by a desired amount (e.g., by enabling the user to change the value of the parameter to a fixed value, or to change the value of the parameter to a custom value (e.g., a more specific value and/or not a fixed value)), thereby improving user-device interaction and reducing errors in interaction.

In some embodiments, wherein the first gesture includes one or more stationary inputs (e.g., one or more tap inputs, press inputs, and/or long press inputs), such as the stationary input shown in FIG. 7F, and the second gesture includes a movement input (e.g., a swipe input and/or a drag input), such as the movement input shown in FIGS. 7B-7D. In some embodiments, the computer system performs the third operation in accordance with a determination that the first input includes one or more tap inputs. In some embodiments, performing the third operation includes, in accordance with a determination that the first gesture includes a first quantity of stationary inputs, changing the first parameter by a first amount corresponding to the first quantity of stationary inputs. In some embodiments, the first gesture corresponds to a single stationary input (e.g., a single tap (e.g., contact) and release within a threshold period of time (e.g., 0.1, 0.2, 0.5, 1, 2, 5 or 10 seconds)). In some embodiments, the first quantity is less than a threshold amount (e.g., two or three tap inputs within a threshold period of time (e.g., 0.1, 0.2, 0.5, 1, 2, 5 or 10 seconds). In some embodiments, the first quantity is greater than a threshold amount (e.g., the first input includes at least two taps (e.g., a double tap) on a surface of the support element within a threshold period of time (e.g., 0.1, 0.2, 0.5, 1, 2, 5 or 10 seconds)). In some embodiments, performing the third operation includes, in accordance with a determination that the first gesture includes a second quantity, different from the first quantity, of stationary inputs, changing the first parameter by a second amount, different from the first amount, corresponding to the second quantity of stationary inputs. In some embodiments, the computer system performs the fourth operation in accordance with a determination that the first input includes a swipe input. In some embodiments, performing the fourth operation includes, in accordance with a determination that the second gesture includes a movement input in a first direction, changing the first parameter by a third amount corresponding to the first direction of the movement input. In some embodiments, the first direction corresponds to a direction traversing at a least a portion of the length of the support element (e.g., at least a portion of the length of a respective surface of the support element). For example, the first direction is a horizontal direction. In some embodiments, the first direction corresponds to a direction traversing the height of the support element (e.g., the height of the first surface of the support element). For example, the first direction is a vertical direction. In some embodiments, in accordance with a determination that the second gesture includes a movement input in the first direction, changing the first parameter includes increasing a value of the first parameter. In some embodiments, the third amount corresponds to a velocity, duration, and/or a distance of the movement input in the first direction (e.g., a swipe input with greater velocity, duration and/or distance increases the first parameter by a greater amount than a swipe input with less velocity, duration and/or distance). In some embodiments, performing the fourth operation includes, in accordance with a determination that the second gesture includes a movement input in a second direction, different from the first direction, changing the first parameter by a fourth amount, different from the third amount, corresponding to the second direction of the movement input. In some embodiments, the second direction is opposite from the first direction. In some embodiments, the first direction is a direction that traverses the length of the support element toward the environment viewing component, and the second direction is a direction that traverses the length of the support element away from the environment viewing component. In some embodiments, the first direction is a direction that traverses the length of the support element away from the environment viewing component, and the second direction is a direction that traverses the length of the support element toward the environment viewing component. In some embodiments, in accordance with a determination that the second gesture includes a movement input in the second direction, changing the first parameter includes decreasing a value of the first parameter. In some embodiments, the fourth amount corresponds to a velocity, duration and/or a distance of the movement input in the second direction. Changing a parameter in a first manner (e.g., and/or by a first amount) in response to one or more stationary inputs performed on a support element or in a second manner (e.g., and/or by a second amount) in response to a movement input performed on the support element provides a user discretion in adjusting the parameter using a desired method and/or by a desired amount (e.g., by enabling the user to change the value of the parameter to a fixed value, or to a custom value (e.g., a more specific value and/or not a fixed value), thereby improving user-device interaction and reducing errors in interaction.

In some embodiments, changing the first parameter of the at least the portion of the environment in the first manner includes updating a value of the first parameter to be a first value of a plurality of values (e.g., a plurality of preset or predefined values) of the first parameter corresponding to the one or more stationary inputs, such as changing the brightness to brightness value 722a in FIG. 7G corresponding to the stationary input detected by computer system 101 in FIG. 7F. In some embodiments, the plurality of values is preset or predefined by system settings of the computer system (e.g., the plurality of values is default values of the first parameter defined by system settings). In some embodiments, the plurality of values is based on user defined (e.g., preferred) settings (e.g., stored in a user profile). In some embodiments, the plurality of values of the first parameter correspond to a plurality of steps (e.g., levels) of the first parameter. For example, the plurality of values corresponds to a percentage of the maximum value of the first parameter (e.g., corresponding to 1, 2, 5, 10, 15, 20, 25, 30, 35, 40, 45, or 50 percent of the maximum value of the first parameter). In some embodiments, in accordance with the first input includes a first quantity of tap inputs (e.g., a single tap input), the computer system increases the first parameter to the next value of the plurality of values of the first parameter. For example, if the difference between each value of the plurality of values is 10 percent of the maximum value of the first parameter, and the current value of the first parameter is 15 percent of the maximum value of the first parameter, updating the value of the first parameter includes updating the value of the first parameter to 20 percent of the maximum value of the first parameter. In some embodiments, the computer system changes the first parameter to a value that is based on the quantity of the tap inputs included in the first input (e.g., in accordance with a determination that the first input includes a single tap input, the computer system changes (e.g., increases or decreases) the first parameter by one step (e.g., to a next preset or predefined value), and in accordance with a determination that the first input includes two tap inputs, the computer system changes (e.g., increases or decreases) the first parameter by two steps (e.g., by two preset or predefined values)). In some embodiments, in accordance with a determination that the first input includes a first quantity of tap inputs, the computer system increases the value of the first parameter (e.g., the first value is the next highest preset or predefined value from the current value of the first parameter). In some embodiments, in accordance with a determination that the first input includes a second quantity, different from the first quantity, of tap inputs, the computer system decreases the value of the first parameter (e.g., the first value is the next lowest preset or predefined value from the current value of the first parameter).

In some embodiments, changing the first parameter of the at least the portion of the environment in the second manner includes updating the value of the first parameter to a second value of the first parameter (e.g., that is not a value of the plurality of values (e.g., preset or predefined) values of the first parameter) corresponding to the movement input (e.g., different values depending on the magnitude and/or direction of the movement), such as the value of brightness (e.g., between brightness value 722c and brightness value 722d) of environment 700 shown in FIG. 7D. In some embodiments, the second value corresponds to a value of the first parameter between two values (e.g., two preset or predefined values) of the plurality of values of the first parameter (e.g., each value of the plurality of values of the first parameter corresponds to 10 percent of the maximum value of the first parameter, and the second value is 17 percent of the maximum value of the first parameter). In some embodiments, a user of the computer system is permitted to update the first parameter to an exact value through a movement input (e.g., swipe input) on the support element (e.g., the user controls the adjustment of the first parameter through the velocity, duration, and/or distance of the movement on the support element). In some embodiments, the second value of the first parameter is greater than a current value of the first parameter (e.g., a value of the first parameter prior to detecting the first input). In some embodiments, the second value of the first parameter is less than a current value of the first parameter (e.g., a value of the first parameter prior to detecting the first input). In some embodiments, the user of the computer system is permitted to update the first parameter to a value that is not one of the plurality of values (e.g., preset or predefined values) of the first parameter or to a value that is one of the plurality of values (e.g., preset or predefined values) of the first parameter through a movement input (e.g., swipe input) on the support element (e.g., the user adjusts the first parameter to a value of the plurality of values of the first parameter or to a different value (e.g., not a preset or predefined value) based on the velocity, duration and/or distance of the movement on the support element). In some embodiments, the computer system updates the first parameter from the first value to the second value in accordance with a determination that the movement input is in a first direction. In some embodiments, in accordance with a determination that the movement input is in a second direction (e.g., different from the first direction), the computer system updates the value of the first parameter to a third value, different from the second value, of the first parameter. In some embodiments, updating the value of the first parameter to the second value of the first parameter corresponds to increasing the value of the first parameter, and updating the value of the first parameter to the third value of the first parameter corresponds to decreasing the value of the first parameter. Changing a parameter of an environment to a value of a plurality of values of the parameter in response to one or more stationary inputs on a support element or to a value (e.g., that is not of the plurality of values of the parameter) in response to a movement input provides a user discretion in adjusting the parameter in a preferred manner and/or by a preferred amount (e.g., by enabling the user to change the value of the parameter to a preset or predefined value or to a custom value), thereby improving user-device interaction and reducing errors in interaction.

In some embodiments, updating the value of the first parameter to the second value of the first parameter includes continuously changing the value of the first parameter while detecting the movement input (e.g., over a duration of the movement input), such as the continuous change in brightness of environment 700 shown in FIGS. 7B-7D while the touch input is performed on first surface 738a of support element 702. In some embodiments, the computer system consistently updates the value of the first parameter while the user performs the movement input on the support element. In some embodiments, the value of the first parameter is updated based on the position of the first portion (e.g., finger) of the user on the support element. In some embodiments, a first end of a portion of a respective surface of the support element (e.g., the first surface and/or the second surface) corresponds to a maximum value of the first parameter, and a second end, opposite the first end, of the portion of the respective surface of the support element corresponds to a minimum value of the first parameter (e.g., the portion of the respective surface represents a scale of values of the first parameter). For example, movement of the first portion of the user between the first end and the second end of the portion of the respective surface of the support element corresponds to adjustment of the value of the first parameter between the maximum value of the first parameter and the minimum value of the first parameter. In some embodiments, the rate of the adjustment of the value of the first parameter corresponds to the velocity of movement of the first portion of the user on the support element. In some embodiments, in accordance with a determination that the swipe input is in the first direction, updating the value of the first parameter includes continuously increasing the value of the first parameter, and in accordance with a determination that the movement input is in the second direction, updating the value of the first parameter includes continuously decreasing the value of the first parameter. In some embodiments, in accordance with a determination that the movement input is in the first direction, updating the value of the first parameter includes continuously decreasing the value of the first parameter, and in accordance with a determination that the movement input is in the second direction, updating the value of the first parameter includes continuously increasing the value of the first parameter. Continuously changing a value of a parameter of an environment while detecting a movement input provides visual feedback to a user performing the swipe input of the resulting visual effect of the movement input on the environment (e.g., if the user terminates the movement input), and provides the user an opportunity to continue to change the value of the parameter (e.g., by continuing the movement input) if the user is not satisfied with the resulting visual effect, thereby reducing errors in interaction.

In some embodiments, in accordance with a determination that the movement input satisfies first criteria, updating the value of the first parameter to the second value of the first parameter includes changing the first parameter to a respective value (e.g., a preset or predefined value) of the plurality of values of the first parameter, such as changing the value of brightness of environment 700 to brightness value 722c in FIG. 7E (e.g., because the movement input shown in FIG. 7E exceeds threshold velocity 732). In some embodiments, the first criteria include a criterion that is satisfied when the velocity of the movement of the first portion of the user on the support element (e.g., during the movement input) is greater than a threshold amount (e.g., greater than 0.01, 0.05, 0.1, 0.2, 0.5, 1 or 2 m/s). In some embodiments, the first criteria include a criterion that is satisfied when the movement input includes less than a threshold distance (e.g., less than 0.5, 1, 2, 5, 10, or 20 cm) of movement of the first portion of the user on the support element. In some embodiments, the first criteria include a criterion that is satisfied when the duration of the movement input is less than a threshold amount (e.g., less than 0.1, 0.2, 0.5, 1, 2, 5 or 10 seconds). In some embodiments, changing the first parameter to the respective value of the plurality of values of the first parameter includes one or more characteristics of updating the value of the first parameter to the first value of the first parameter as described above. In some embodiments, in accordance with a determination that the movement input does not satisfy the first criteria, the computer system forgoes changing the first parameter to the respective value of the plurality of values of the first parameter. For example, in accordance with the determination that the movement input does not satisfy the first criteria, the computer system continuously changes the value of the first parameter while detecting the movement input in the first direction (e.g., as described above). In some embodiments, in accordance with a determination that the movement input is in a first direction, changing the first parameter to the respective value includes increasing the value of the first parameter. In some embodiments, in accordance with a determination that the movement input is in a second direction, different from the first direction, changing the first parameter to the respective value includes decreasing the value of the first parameter. In some embodiments, the respective value corresponds to the next predefined or preset value from a current value of the first parameter (e.g., the respective value is the next highest or next lowest value of the plurality of values of the first parameter). In some embodiments, in accordance with a determination that the movement input is greater than a threshold velocity (e.g., 0.01, 0.05, 0.1, 0.2, 0.5, 1 or 2 m/s), the respective value is independent of a magnitude and/or distance of the swipe input.

In some embodiments, in accordance with a determination that the movement input satisfies second criteria (e.g., different from the first criteria), updating the value of the first parameter to the second value of the first parameter includes changing the first parameter to a value of the first parameter different from the respective value of the plurality of values of the first parameter, such as changing the value of brightness of environment 700 to the value shown in FIG. 7D (e.g., because the movement input shown in FIGS. 7B-7D does not exceed threshold velocity 732). In some embodiments, satisfying the second criteria corresponds to not satisfying the first criteria. In some embodiments, the second criteria include a criterion that is satisfied when the velocity of the movement of the first portion of the user on the support element (e.g., during the movement input) is less than a threshold amount (e.g., less than 0.01, 0.05, 0.1, 0.2, 0.5, 1 or 2 m/s). In some embodiments, the second criteria include a criterion that is satisfied when the movement input includes greater than a threshold distance (e.g., less than 0.5, 1, 2, 5, 10, or 20 cm) of movement of the first portion of the user on the support element. In some embodiments, the second criteria include a criterion that is satisfied when the duration of the movement input is greater than a threshold amount (e.g., greater than 0.1, 0.2, 0.5, 1, 2, 5 or 10 seconds). In some embodiments, in accordance with a determination that the movement input does not satisfy the second criteria, the computer system changes the value of the first parameter to a respective value of the plurality of fixed values of the first parameter. In some embodiments, in accordance with a determination that the movement input does not satisfy the second criteria, the computer system changes the value of the first parameter to a second value of the first parameter (e.g., different from the value of the first parameter that is different from the respective value of the plurality of values of the first parameter). In some embodiments, in accordance with a determination that the movement input is in a first direction, changing the first parameter to the value of the first parameter different from the respective value of the plurality of values of the first parameter includes increasing the value of the first parameter. In some embodiments, in accordance with a determination that the movement input is in a second direction, different from the first direction, changing the first parameter to the value different from the respective value of the plurality of values of the first parameter includes decreasing the value of the first parameter. In some embodiments, in accordance with a determination that the movement input is less than a threshold velocity (e.g., 0.01, 0.05, 0.1, 0.2, 0.5, 1 or 2 m/s), the value of the first parameter different from the respective value of the plurality of values of the first parameter is based on a magnitude and/or distance of the swipe input. Updating a value of a parameter of an environment to a value of the parameter in response to a movement input that satisfies first criteria provides a user a method to efficiently change the parameter to a predictable value, thereby reducing errors in interaction and improving user-device interaction.

In some embodiments, the first gesture includes movement of the first portion of the user on the support element of the computer system with less than a threshold velocity, such as the movement input shown in FIGS. 7B-7D, and the second gesture includes movement of the first portion of the user on the support element with greater than the threshold velocity, such as the movement input shown in FIG. 7E. In some embodiments, the threshold velocity is 0.01, 0.05, 0.1, 0.2, 0.5, 1 or 2 m/s. In some embodiments, in accordance with a determination that the first input includes movement of the first portion of the user on the support element that is greater than the threshold velocity, the computer system updates the value of the first parameter to a value of the plurality of values of the first parameter (e.g., as described above). For example, in accordance with the determination that the first input includes movement of the first portion of the user on the support element that is greater than the threshold velocity, the computer system updates the value of the first parameter to the value of the plurality of values of the first parameter independent (e.g., irrespective) of a distance of movement of the first portion of the user on the support element. In some embodiments, in accordance with a determination that the first input includes movement of the first portion of the user on the support element that is less than the threshold velocity, the computer system continuously changes the value of the first parameter while detecting the first input (e.g., as described above). For example, in accordance with the determination that the first input includes movement of the first portion of the user on the support element that is less than the threshold velocity, the computer system updates the value of the first parameter to a value (e.g., optionally different from a value of the plurality of values of the first parameter) that is based on a distance (e.g., or magnitude) of movement of the first portion of the user on the support element. In some embodiments, the first gesture includes movement of the first portion of the user on the support element of the computer system with less than a threshold distance of movement, and the second gesture includes movement of the first portion of the user on the support element with greater than the threshold velocity of movement. For example, the threshold distance of movement is 0.1, 0.2, 0.5, 1, 2, 5, 10 or 20 cm. In some embodiments, in accordance with a determination that the first input includes movement of the first portion of the user on the support element that is more than the threshold distance of movement, the computer system updates the value of the first parameter to a value of the plurality of values of the first parameter. In some embodiments, in accordance with a determination that the first input includes movement of the first portion of the user on the support element that is less than the threshold distance of movement, the computer system continuously changes the value of the first parameter while detecting the first input. In some embodiments, the first gesture includes movement of the first portion of the user on the support element for less than a threshold amount of time, and the second gesture includes movement of the first portion of the user on the support element for greater than the threshold amount of time. For example, the threshold amount of time is 0.1, 0.2, 0.5, 1, 2, 5 or 10 seconds. In some embodiments, in accordance with a determination that the first input includes movement of the first portion of the user on the support element for less than the threshold amount of time, the computer system updates the value of the first parameter to a value of the plurality of values of the first parameter. In some embodiments, in accordance with a determination that the first input includes movement of the first portion of the user on the support element for greater than the threshold amount of time, the computer system continuously changes the value of the first parameter while detecting the first input. Changing a parameter of a portion of an environment in a first manner in response to a swipe input on a support element with less than a threshold velocity and in a second manner, different from the first manner, in response to a movement input on the support element with greater than the threshold velocity, provides a user discretion in adjusting the parameter using a preferred method and/or by a preferred amount (e.g., by enabling the user to change the parameter in different manners based on the velocity of a movement input on the support element), thereby improving user-device interaction and reducing errors in interaction.

In some embodiments, performing the third operation corresponding to changing the first parameter of the at least the portion of the environment in the first manner includes changing a value of the first parameter from a first value to a second value, different from the first value, wherein a difference between the first value and the second value is based on a distance (e.g., a first distance) of movement of the first portion of the user, such as the difference in value of the brightness of environment 700 in FIG. 7B (e.g., at brightness value 722a) and the brightness of environment 700 in FIG. 7D based on the distance of movement of finger 708a on first surface 738a in FIGS. 7B-7D. The second value is optionally not a value of the plurality of values of the first parameter (e.g., as described above). For example, the second value corresponds to a value between two pre-set or predefined values of the first parameter. In some embodiments, the second value includes one or more characteristics of the second value of the first parameter described above. In some embodiments, the first distance corresponds to a portion of the length of a respective surface (e.g., the first surface) of the support element. In some embodiments, in accordance with a determination that the distance of movement of the first portion of the user corresponds to a first portion of the length of the respective surface of the support element, the difference between the first value and the second value is a first amount, and in accordance with a determination that the distance of movement of the first portion of the user corresponds to a second portion, greater than the first portion, of the length of the respective surface of the support element, the difference between the first value and the second value is a second amount, larger than the first amount. In some embodiments, in accordance with a determination that the distance of movement of the first portion of the user corresponds to a third portion, less than the first portion, of the length of the respective surface of the support element, the difference between the first value and the second value is a third amount, less than the first amount. In some embodiments, in response to detecting movement of the first portion of the user on the support element that is less than the threshold velocity, the computer system changes the value of the first parameter to a value of the first parameter that is based on a distance (e.g., or magnitude) of the movement of the first portion of the user on the support element (e.g., a user of the computer system can set the first parameter to a specific (e.g., custom and/or not a pre-set or predefined) value of the first parameter with a swipe input on the support element with a lower velocity).

In some embodiments, performing the fourth operation corresponding to changing the first parameter of the at least the portion of the environment in the second manner includes changing the value of the first parameter from the first value to a respective value of a plurality of values of the first parameter (e.g., pre-set or predefined values of the first parameter), wherein a difference between the first value and the respective value is independent of (e.g., not based on) a distance (e.g., a second distance optionally different from the first distance) of movement of the first portion of the user, such as the difference in the value of brightness of environment 700 in FIG. 7D (e.g., represented by cursor 728) and in FIG. 7E (e.g., brightness value 722c) that is independent of the distance of movement of finger 708a on first surface 738a in FIG. 7E. In some embodiments, the respective value of the plurality of values of the first parameter includes one or more characteristics of a value (e.g., the respective value) of the plurality of values of the first parameter described above. In some embodiments, the plurality of values of the first parameter are default (e.g., pre-set or predefined) values of the first parameter (e.g., set by the computer system (e.g., stored in system settings)). For example, the values of the plurality of values of the first parameter are separated by intervals of 1, 2, 5, 10, 15, 20, 25 or 50 percent of the maximum value of the first parameter. In some embodiments, the plurality of values of the first parameter are custom values (e.g., set by the user of the computer system (e.g., and optionally stored in a user profile)). For example, the plurality of values of the first parameter correspond to values of the first parameter preferred by the user of the computer system (e.g., values of the first parameter that the user of the computer system frequently sets the first parameter to). The distance of movement of the first portion of the user is optionally the same during the second gesture as the first gesture (e.g., the first gesture and the second gesture are movement inputs that include the same distance and/or magnitude of movement of the first portion of the user on the support element). The distance of movement of the first portion of the user included in the first gesture is optionally different from the distance of movement of the first portion of the user included in the second gesture (e.g., the first gesture and the second gesture are movement inputs that include a different distance and/or magnitude of movement of the first portion of the user on the support element). In some embodiments, the difference between the first value and the respective value of the plurality of values of the first parameter when the distance of movement of the first portion of the user corresponds to a first portion of the length of the respective surface of the support element is the same as the difference between the first value and the respective value of the plurality of values of the first parameter when the distance of movement of the first portion of the user corresponds to a second portion, different from the first portion, of the length of the respective surface of the support element. In some embodiments, in response to detecting movement of the first portion of the user on the support element that is greater than the threshold velocity, the computer system changes the value of the first parameter to a respective value of the plurality of values of the first parameter independent (e.g., irrespective) of a distance (e.g., or magnitude) of the movement of the first portion of the user on the support element. In some embodiments, a user of the computer system customizes a value of the first parameter through a movement input (e.g., swipe input) on a respective surface (e.g., the first surface or the second surface) of the support element that includes a lower velocity (e.g., based on the distance and/or magnitude of the movement input), or sets the value of the first parameter to a pre-set or predefined value through a movement input on a respective surface of the support element that includes a higher velocity (e.g., irrespective of the distance and/or magnitude of the movement input). Changing a parameter of a portion of an environment to a value that is based on a distance of movement on a support element when the movement exceeds a threshold velocity, and changing the parameter to a respective value (e.g., different from the value) when the movement does not exceed the threshold velocity provides a user discretion in adjusting the parameter using a preferred method and/or by a preferred amount (e.g., by enabling the user to change the parameter in different manners based on the velocity of a movement input on the support element), thereby improving user-device interaction and reducing errors in interaction.

In some embodiments, the plurality of values of the first parameter includes a maximum value of the first parameter, such as brightness value 722a represented in schematic 720 in FIGS. 7B-7G, and a minimum value of the first parameter, such as brightness value 722e represented in schematic 720 in FIGS. 7B-7G. In some embodiments, in accordance with a determination that the first input includes a swipe input in the first direction (e.g., on the support element toward the environment viewing component) that includes more than the threshold velocity of movement (e.g., and/or less than a threshold duration of movement and/or threshold distance of movement), the computer system updates the value of the first parameter to the maximum value of the first parameter (e.g., without updating the value of the first parameter to an intermediate value (e.g., as described below)). In some embodiments, in accordance with a determination that the first input includes a swipe input in the second direction (e.g., on the support element away from the environment viewing component) that includes more than the threshold velocity of movement (e.g., and/or less than a threshold duration of movement and/or threshold distance of movement), the computer system updates the value of the first parameter to the minimum value of the first parameter (e.g., without updating the value of the first parameter to an intermediate value (e.g., as described below)). In some embodiments, in accordance with a determination that the first input includes a movement input (e.g., swipe input) in the first direction (e.g., on the support element toward the environment viewing component) that includes more than the threshold velocity of movement (e.g., and/or less than a threshold duration of movement and/or threshold distance of movement), the computer system updates the value of the first parameter to the minimum value of the first parameter (e.g., without updating the value of the first parameter to an intermediate value (e.g., as described below)). In some embodiments, in accordance with a determination that the first input includes a movement input in the second direction (e.g., on the support element away from the environment viewing component) that includes more than the threshold velocity of movement (e.g., and/or less than a threshold duration of movement and/or threshold distance of movement), the computer system updates the value of the first parameter to the maximum value of the first parameter (e.g., without updating the value of the first parameter to an intermediate value (e.g., as described below)). Updating a value of a parameter of a portion of an environment to a minimum or maximum value in response to movement on a support element that is greater than a threshold velocity provides a user a method to quickly add or remove a visual effect from the environment and provides a user a method to efficiently change the parameter to a predictable value, thereby improving user-device interaction and reducing errors in interaction.

In some embodiments, the plurality of values of the first parameter includes one or more intermediate values between a maximum value of the first parameter and a minimum value of the first parameter, such as brightness values 722b-722d represented in schematic 720 in FIGS. 7B-7G. In some embodiments, the one or more intermediate values correspond to steps (e.g., pre-set or predefined values (e.g., stored in system settings)) between the maximum value of the first parameter and the minimum value of the first parameter (e.g., having one or more characteristics of the steps of the first parameter as described above). In some embodiments, the one or more intermediate values have one or more characteristics of a value (e.g., respective value) of the plurality of values of the first parameter described above. In some embodiments, in accordance with a determination that the first input satisfies first criteria, the computer system updates the value of the first parameter of the at least the portion of the environment to an intermediate value of the plurality of values. For example, the first criteria include a criterion that is satisfied when a current value of the first parameter (e.g., the value of the first parameter when the first input is detected) is less than an intermediate value of the plurality of values of the first parameter (e.g., the current value of the first parameter is 40 percent of the maximum value of the first parameter and the next highest intermediate value is 50 percent of the maximum value of the first parameter). For example, the first criteria include a criterion that is satisfied when a current value of the first parameter is greater than an intermediate value of the plurality of values of the first parameter (e.g., the current value of the first parameter is 40 percent of the maximum value of the first parameter, and the next lowest intermediate value is 25 percent of the maximum value of the first parameter). For example, the first criteria include a criterion that is satisfied when the first input corresponds to a movement input (e.g., swipe input) in the first direction (e.g., with more than the threshold velocity). For example, the first criteria include a criterion that is satisfied when the first input corresponds to a movement input in the second direction (e.g., with more than the threshold velocity). In some embodiments, in accordance with a determination that the first input satisfies second criteria (e.g., different from the first criteria), the computer system updates the value of the first parameter of the at least the portion of the environment to the maximum value of the first parameter. For example, the second criteria include a criterion that is satisfied when the maximum value of the first parameter is the next highest value of the first parameter from the current value of the first parameter (e.g., the plurality of values of the first parameter are separated by 10 percent of the maximum value of the first parameter, and the current value of the first parameter is 95 percent of the maximum value of the first parameter). For example, the second criteria include a criterion that is satisfied when the first input corresponds to a movement input in the first direction. For example, the second criteria include a criterion that is satisfied when the first input corresponds to a movement input in the second direction. For example, the second criteria include a criterion that is satisfied when the first input includes a stationary input (e.g., a single tap, double tap, or triple tap input). In some embodiments, in accordance with a determination that the first input satisfies third criteria (e.g., different from the first criteria and/or second criteria), the computer system updates the value of the first parameter of the at least the portion of the environment to the minimum value of the first parameter. For example, the third criteria include a criterion that is satisfied when the first input corresponds to a movement input in the first direction. For example, the third criteria include a criterion that is satisfied when the first input corresponds to a movement input in the second direction. For example, the third criteria include a criterion that is satisfied when the first input includes a stationary input. Updating a value of a parameter of a portion of an environment to an intermediate value (e.g., between a maximum and a minimum value of the parameter) in response to movement of an object on a support element that is greater than a threshold velocity provides a user a method to efficiently change the parameter to one or more predictable values, and provides user discretion in changing the parameter to a preferred value (e.g., by providing more values between the maximum value and the minimum value), thereby reducing errors in interaction and improving user-device interaction.

In some embodiments, the environment viewing component includes (e.g., or is) a display generation component (e.g., including one or more characteristics of the display generation component described with reference to step(s) 802), such as display generation component 120. In some embodiments, the environment includes one or more virtual objects displayed via the display generation component (e.g., the one or more virtual objects include one or more characteristics of the one or more virtual objects described above (e.g., with reference to step(s) 802), such as virtual object 714 displayed in environment 700 in FIGS. 7B-7T. In some embodiments, the first operation is performed on at least a portion of the one or more virtual objects in the environment, such as changing the UI focus from virtual element 716a to virtual element 716b in response to the touch input on first surface 738a in FIG. 7L. In some embodiments, the first operation includes selecting, moving and/or changing the size of one or more virtual objects from the current viewpoint of the user (e.g., as described with reference to step(s) 802). In some embodiments, the first operation includes changing one or more visual features of one or more virtual objects (e.g., changing the brightness, focus, magnification, tint, color, clarity, transparency and/or saturation of the at least the portion of the one or more virtual objects from the current viewpoint of the user). In some embodiments, performing the second operation includes updating, via the display generation component, display of the at least the portion of the one or more virtual objects in the environment (e.g., as described with reference to the first operation). In some embodiments, performing the first operation (e.g., in response to detecting the first input on the first surface of the support element) includes updating the display of the at least the portion of the one or more virtual objects in the environment in a first manner. In some embodiments, performing the second operation (e.g., in response to detecting the first input on the second surface of the support element) includes updating the display of the at least the portion of the one or more virtual objects in a second manner, different from the first manner. For example, updating the at least the portion of the one or more virtual objects in the first manner includes performing a first user interface operation (e.g., moving a virtual object), and updating the at least the one or more virtual objects in the second manner includes performing a second user interface operation (e.g., changing the size of a virtual object), different from the first user interface operation. For example, updating the at least the portion of the one or more virtual objects in the first manner includes adjusting a first parameter (e.g., the brightness) of the at least the portion of the one or more virtual objects, and updating the at least the portion of the one or more virtual objects in the second manner includes adjusting a second parameter (e.g., the color), different from the first parameter, of the at least the portion of the one or more virtual objects. Performing an operation on one or more virtual objects in an environment in response to an input that includes contact on a first surface of a support element, and performing a different operation (e.g., that optionally does not include performing an operation on the one or more virtual objects) based on an input that includes contact on a second surface of the support element reduces the likelihood of user interaction with the one or more virtual objects when the user does not intend to interact with the one or more virtual objects (e.g., by assigning the operation to a respective surface of the support element), thereby reducing errors in user-device interaction, and helping reduce the need for input to correct such unintended operations.

In some embodiments, the one or more virtual objects include one or more virtual elements (e.g., virtual elements 716a-716c shown in FIG. 7L), and updating display of the at least the portion of the one or more virtual objects includes navigating through the one or more virtual elements, such as changing UI focus from virtual element 716a to virtual element 716b in FIG. 7L. In some embodiments, the one or more virtual elements are included within a virtual window and/or container in the environment (e.g., in the at least the portion of the environment). In some embodiments, the one or more virtual elements are displayed as a (e.g., scrollable) list (e.g., a vertical list or a horizontal list of virtual elements from the current viewpoint of the user). In some embodiments, the one or more virtual elements are displayed in a grid or pattern (e.g., in one or more clusters) in a user interface (e.g., in a home user interface or a system user interface). In some embodiments, the one or more virtual elements are or include photographs, icons (e.g., representing applications in a user interface (e.g., a home user interface), settings controls (e.g., in a system user interface) and/or files (e.g., documents, audio files, and/or data files (e.g., associated with a respective application, such as a music application, web browsing application, and/or a social media application)). In some embodiments, the one or more virtual elements are scrollable. For example, in response to the first input, the computer system updates the display (e.g., position) of one or more virtual elements in a list of virtual elements (e.g., the virtual elements correspond to one or more selectable options, as described below). In some embodiments, in response to the first input, the computer system scrolls a user interface included in a virtual window and/or container. For example, the user interface is a web browsing and/or social media application user interface (e.g., scrolling the user interface includes scrolling a web site and/or through images/posts displayed in a social media application). In some embodiments, navigating through the one or more virtual elements includes updating a current focus from one or more first virtual elements to one or more second virtual elements. For example, a current focus is represented by a boundary displayed around one or more virtual elements, and/or by changing a visual feature of one or more virtual elements (e.g., changing the color, brightness, and/or size of a virtual element that has the current focus). In some embodiments, the navigation through the one or more virtual elements corresponds to a direction and/or magnitude of movement of an object (e.g., having one or more characteristics of the object described above) on a respective surface (e.g., the first surface and/or second surface) of the support element. For example, in accordance with a determination that the first input includes movement of the object in a first direction on the respective surface of the support element, the computer system moves the current focus in a second direction in the environment corresponding to the first direction from the current viewpoint of the user. For example, in accordance with a determination that the first input includes movement of the object in a third direction, different from the first direction, on the respective surface of the support element, the computer system moves the current focus in a fourth direction, different from the second direction, in the environment corresponding to the second direction from the current viewpoint of the user. For example, in accordance with a determination that the first input includes movement of the object with a first magnitude (e.g., of distance) on the support element, the computer system scrolls through the one or more virtual elements by a first amount. For example, in accordance with a determination that the first input includes movement of the object with a second magnitude, different from the first magnitude, on the support element, the computer system scrolls through the one or more virtual elements by a second amount, different from the first amount. Navigating through one or more virtual elements in an environment in response to an input that includes contact on a first surface of a support element, and performing a different operation (e.g., that does not include navigating through the one or more virtual elements) based on an input that includes contact on a second surface of the support element, reduces the likelihood that the navigation occurs when the user does not intend to navigate through the one or more virtual elements (e.g., by assigning the operation of navigating through the one or more virtual elements to a respective surface of the support element), thereby reducing errors in user-device interaction, and helping reduce the need for input to correct such unintended operations.

In some embodiments, the one or more virtual objects include one or more selectable options, and updating display of the at least the portion of the one or more virtual objects includes selecting a selectable option of the one or more selectable options, such as the selection of virtual element 716b shown in FIGS. 7M-7N. In some embodiments, the one or more selectable options are included in a list (e.g., having one or more characteristics of the list of virtual elements described above). In some embodiments, the one or more selectable options are included in a home user interface or a system user interface of the computer system. For example, the one or more selectable options correspond to application icons in a home user interface, or settings in a menu of a system user interface. In some embodiments, the one or more selectable options are included in a virtual window and/or container in the environment (e.g., in the at least the portion of the environment). For example, the one or more selectable options are included in a web browsing user interface (e.g., affordances included in a web page), or a respective application (e.g., affordances included in a social media user interface). In some embodiments, in accordance with a determination that the first input includes one or more tap inputs (e.g., a single tap input, a double tap input, and/or a tap input performed with multiple objects (e.g., multiple fingers of a hand of the user)), the computer system selects a selectable option of the one or more selectable options. In some embodiments, the selectable option of the one or more selectable options corresponds to a selectable option with the current focus (e.g., the selectable option with the current focus has one or more characteristics of a virtual element with a current focus as described above). In some embodiments, in response to selection of the selectable option, one or more virtual objects displayed in the at least the portion of the environment changes (e.g., a new virtual object is displayed (e.g., the selectable option corresponds to an application icon in a home user interface, and selection of the selectable option causes an application to be launched in the environment), a new web page is displayed within a web browser user interface, content (e.g., video and/or audio content) is launched within a content streaming service application, or content (e.g., image content) is enlarged or minimized within an application). Selecting a selectable option in an environment in response to an input that includes contact on a first surface of a support element, and performing a different operation (e.g., that does not include selecting a selectable option) based on an input that includes contact on a second surface of the support element reduces the likelihood that the selectable option is selected when the user does not intend to select the selectable option (e.g., by assigning the operation of selecting a selectable option to a respective surface of the support element), thereby reducing errors in user-device interaction, and helping reduce the need for input to correct such unintended operations.

In some embodiments, performing the second operation includes changing a first parameter of the at least the portion of the environment corresponding to a visual emphasis of the at least the portion of the environment, such as changing optical focus appearance of a portion environment 700 in response to the touch input detected on second surface 738b in FIG. 7I. In some embodiments, the first parameter of the at least the portion of the environment has one or more characteristics of the first parameter described above. In some embodiments, changing the first parameter of the at least the portion of the environment includes one or more characteristics of changing the first parameter of the at least the portion of the environment as described above. Changing a first parameter (e.g., visual feature) of a portion of an environment in response to an input that includes contact on a second surface of a support element, and performing a different operation (e.g., that does not include changing the first parameter) based on an input that includes contact on a first surface of the support element reduces the likelihood that the first parameter is changed when the user does not intend to change the first parameter (e.g., by assigning the operation of changing the first parameter of the portion of the environment to a respective surface of the support element), thereby reducing errors in user-device interaction, and helping reduce the need for input to correct such unintended operations.

In some embodiments, the first parameter is an optical focus based on which the at least the portion of the environment is visible from the current viewpoint of the user (e.g., the first parameter is an optical focus appearance of at least a portion of the environment that is visible from the current viewpoint of the user), such as the change in optical focus appearance of environment 700 shown in FIGS. 7H-7I. In some embodiments, the computer system changes the optical focus appearance of the environment from the current viewpoint of the user by changing the focal power of the environment viewing component. In some embodiments, the computer system changes the optical focus appearance of the environment from the current viewpoint of the user by changing the focal length of the environment viewing component. In some embodiments, changing the optical focus appearance of the environment includes changing the depth of field (e.g., the area of the environment that is in focus from the current viewpoint of the user is changed) from the current viewpoint of the user. In some embodiments, changing the optical focus appearance of a portion of the environment includes putting an object in focus (e.g., a physical object previously not in focus) from the current viewpoint of the user (e.g., and optionally putting one or more objects out of focus from the current viewpoint of the user). For example, the object is included in the physical environment of the user and is visible in the at least the portion of the environment via the environment viewing component (e.g., as optical passthrough of the user's physical environment). For example, changing the optical focus appearance of a portion of the environment includes changing a sharpness of at least a portion of the environment from the current viewpoint of the user. Changing an optical focus appearance of a portion of an environment in response to an input that includes contact on a second surface of a support element, and performing a different operation (e.g., that does not include changing optical focus appearance) based on an input that includes contact on a first surface of the support element, reduces the likelihood that the optical focus appearance of the environment is changed when the user does not intend to change the optical focus appearance of the environment (e.g., by assigning the operation of changing the optical focus appearance of the environment to a respective surface of the support element), thereby reducing errors in user-device interaction, and helping reduce the need for input to correct such unintended operations.

In some embodiments, the environment viewing component includes a variable optical component, and the optical focus (e.g., the optical focus appearance of the at least the portion of the environment) is changed using the variable optical component, such as changing the optical focus appearance of the portion of environment 700 in FIG. 7I by changing the value of an optical focus setting of the variable optical component of environment viewing component 760. In some embodiments, the variable optical component includes one or more liquid lenses, liquid crystal lenses, and/or Alvarez lenses. In some embodiments, the variable optical component is configured to change the focal length (e.g., optical power) of the environment viewing component. In some embodiments, the variable optical component is configured to change the manner in which light passes through the environment viewing component (e.g., through one or more lenses of the environment viewing component (e.g., using one or more liquid and/or liquid crystal lenses)). In some embodiments, the variable optical component is also used to change a parameter different from the optical focus appearance of the environment (e.g., the brightness and/or magnification of at least a portion of the environment from the current viewpoint of the user). Including a variable optical component in the environment viewing component increases the range of focal power of the environment viewing component, and increases the speed, responsiveness, and accuracy of optical focus operations, thereby improving user-device interaction.

In some embodiments, the first parameter is a brightness of the at least the portion of the environment, such as changing the brightness of environment 700 in FIG. 7E. In some embodiments, the brightness of the at least the portion of the environment is changed from the current viewpoint of the user using a variable optical component of the environment viewing component. For example, the variable optical component includes one or more liquid crystal dimmers and/or electrochromic films. For example, by adjusting the variable optical component (e.g., in response to the first input), the computer system changes an appearance of at least a portion of the environment visible from the current viewpoint of the user (e.g., a portion of the environment appears more dim in response to the first input (e.g., including one or more objects of the physical environment visible as optical passthrough through the environment viewing component)). In some embodiments, changing the brightness of the environment includes changing a display brightness of one or more virtual objects using a display generation component. In some embodiments, the at least the portion of the environment corresponds to a portion of the environment visible from the current viewpoint of the user (e.g., changing the first parameter of the at least the portion of the environment includes changing the brightness of the portion of the environment that is visible to the user from their current viewpoint). In some embodiments, after the computer system changes the first parameter of the at least the portion of the environment, the user changes their current viewpoint (e.g., the computer system detects a change in the pose of the computer system relative to the environment). In some embodiments, a second portion of the environment (e.g., different from the at least the portion of the environment), is displayed with the same appearance (e.g., with the same value of the first parameter (e.g., brightness) as the at least the portion of the environment). For example, the second portion of the environment corresponds to a portion of the environment that is visible to the user after the user changes their viewpoint. Changing a brightness of a portion of an environment in response to an input that includes a contact on a second surface of a support element, and performing a different operation (e.g., that does not include changing brightness) based on an input that includes contact on a first surface of the support element, reduces the likelihood that the brightness of the portion of the environment is changed when the user does not intend to change the brightness of the portion of the environment (e.g., by assigning the operation of changing brightness of the portion of the environment to a respective surface of the support element), thereby reducing errors in user-device interaction, and helping reduce the need for input to correct such unintended operations.

In some embodiments, changing the first parameter of the at least the portion of the environment includes continuously changing the first parameter of the at least the portion of the environment (e.g., in accordance with the first input) while detecting the first input (e.g., having one or more characteristics of continuously changing the first parameter of the at least the portion of the environment as described above with reference to the first operation), such as the continuous change in brightness of environment 700 shown in FIGS. 7B-7D while computer system 101 detects the touch input on support element 702. For example, continuously changing the first parameter of the at least the portion of the environment while detecting the first input includes continuously adjusting a variable optical component (e.g., having one or more characteristics of a variable optical component described above) of the environment viewing component while detecting the first input (e.g., based on the movement included in the first input). For example, the optical power and/or magnification power of the environment viewing component continuously changes while the first input is performed on a respective surface (e.g., the first surface or second surface) of support element. In some embodiments, the first input includes movement of an object on the support element (e.g., as described above), and the appearance of at least a portion of the environment changes (e.g., by adjustment of the variable optical component) based on the movement of the object (e.g., based on the velocity, direction, duration, distance and/or magnitude of the movement of the object on the support element). Continuously changing a value of a parameter of a portion of an environment while detecting an input provides visual feedback to a user performing the input of the resulting visual effect of the input on the environment (e.g., if the user terminates the input), and provides the user an opportunity to continue to change the parameter (e.g., by continuing the swipe input) if the user is not satisfied with the resulting visual effect, thereby reducing errors in interaction.

In some embodiments, changing the first parameter of the at least the portion of the environment includes changing a value of the first parameter from a first value (e.g., a current value of the first parameter) to a respective value of a plurality of values (e.g., pre-set or predefined values) of the first parameter (e.g., as described above with reference to the first operation), such as changing the value of brightness of environment 700 from the value shown in FIG. 7D to brightness value 722c in FIG. 7E. The first value is optionally a value of the plurality of values of the first parameter. The first value is optionally not a value of the plurality of values of the first parameter. In some embodiments, the plurality of values of the first parameter has one or more characteristics of the plurality of values of the first parameter as described above (e.g., the plurality of values of the first parameter includes a maximum value, a minimum value and/or one or more intermediate values (e.g., between the maximum value and the minimum value)). Changing a value of a parameter of a portion of an environment to a value of a plurality of values of the parameter (e.g., pre-set or predefined values of the parameter) provides a user a method to efficiently change the parameter to a predictable value, thereby reducing errors in interaction and improving user-device interaction.

In some embodiments, the first input is an input of a first type (e.g., the stationary input on first surface 738a shown in FIG. 7F). In some embodiments, after detecting the first input, the computer system detects, via the one or more input devices, a second input on the support element of the computer system corresponding to an input of a second type (e.g., different from the first type), such as the multi-finger input detected by computer system 101 on first surface 738a in FIG. 7O. In some embodiments, in response to detecting the second input, performing a third operation, different from the first operation and the second operation, that changes an appearance of at least a portion of the environment when viewed via the environment viewing component, such as changing the magnification of a portion of environment 700 shown in FIG. 7P and FIG. 7Q. In some embodiments, the input of the first type includes a first quantity of tap inputs (e.g., a single tap input) and the input of the second type includes a second quantity, different from the first quantity, of tap inputs (e.g., a double tap or triple tap input). In some embodiments, the input of the first type includes an input with one object (e.g., a portion of the user, such as a finger of a hand), and the input of the second type includes an input with multiple objects (e.g., multiple fingers of a hand of the user). In some embodiments, the input of the first type includes a tap and release input (e.g., lift-off of an object from the support element occurs in less than a threshold amount of time (e.g., 0.1, 0.2, 0.5, 1, 2, 5 or 10 seconds from initiating the input), and the input of the second type includes a tap and hold input (e.g., lift-off of an object from the support element occurs in greater than a threshold amount of time (e.g., 0.1, 0.2, 0.5, 1, 2, 5 or 10 seconds from initiating the input). In some embodiments, the input of the first type includes movement of an object on the support element, and the input of the second type does not include movement of the object on the support element (e.g., the input of the first type includes a swipe input, and the input of the second type includes one or more tap inputs). In some embodiments, the third operation has one or more characteristics of the first operation and/or the second operation described above. In some embodiments, the first operation and/or the second operation include updating a display of one or more virtual objects included in at least a portion of the environment (e.g., as described above), and the third operation includes changing one or more parameters (e.g., visual features) of at least a portion of the environment (e.g., the one or more parameters have one or more characteristics of the first parameter as described above). In some embodiments, the first operation and/or the second operation include changing one or more parameters of at least a portion of the environment, and the third operation includes updating a display of one or more virtual objects included in at least a portion of the environment. In some embodiments, the first operation and/or second operation include changing a first parameter of at least a portion of the environment in a first manner (e.g., including one or more characteristics of changing the first parameter of at least a portion of the environment in the first manner as described above), and the third operation includes changing the first parameter of at least a portion of the environment in a second manner different from the first manner (e.g., including one or more characteristics of changing the first parameter of the at least the portion of the environment in the second manner as described above). In some embodiments, the first operation and/or second operation include changing a first parameter of at least a portion of the environment, and the third operation includes changing a second parameter, different from the first parameter, of at least a portion of the environment (e.g., the first parameter corresponds to the brightness of the at least the portion of the environment, and the second parameter corresponds to optical focus appearance of the environment). In some embodiments, the first operation and/or second operation include one or more first operations performed on one or more virtual objects, and the third operation includes performing one or more second operations, different from the one or more first operations, on the one or more virtual objects (e.g., the first operation includes scrolling one or more virtual elements, the second operation includes selecting one or more virtual elements, and the third operation includes moving and/or changing the size of one or more virtual elements). Performing a respective operation in an environment based on a type of contact on a respective surface of a support element reduces the likelihood that an operation is performed using the respective surface of the support element that the user does not intend to be performed (e.g., by assigning different operations to different types of contact on the respective surface of the support element), thereby reducing errors in user-device interaction, and helping reduce the need for input to correct such unintended operations.

In some embodiments, in response to detecting the first input, in accordance with a determination that the first input includes contact on multiple respective surfaces of the support element concurrently, the computer system performs a third operation, different from the first operation and the second operation, that changes an appearance of the at least the portion of the environment when viewed via the environment viewing component, such as the selection of virtual element 716b shown in FIGS. 7M-7N in response to the touch input on second surface 738b and third surface 738c detected by computer system 101 in FIG. 7M. In some embodiments, the third operation has one or more characteristics of the third operation described above. In some embodiments, the third operation includes changing a different parameter of at least a portion of the environment from those of the first operation and/or second operation (e.g., the first operation and/or second operation include changing the brightness, and the third operation includes changing the optical focus appearance and/or magnification of at least a portion of the environment). In some embodiments, the first input that includes contact on the first surface of the support element described with relation to step(s) 802 is not a contact performed on multiple respective surfaces of the support element (e.g., the contact is performed on only the first surface of the support element). In some embodiments, the first input that includes contact on the second surface of the support element described with relation to step(s) 802 is not a contact performed on multiple respective surfaces of the support element (e.g., the contact is performed on only the second surface of the support element). In some embodiments, the multiple respective surfaces of the support element include the first surface and the second surface. In some embodiments, the multiple respective surfaces include the first surface and/or second surface and a third surface of the support element. For example, the multiple respective surfaces include the first surface and the third surface of the support element. In some embodiments, the first input corresponds to concurrent tap inputs on the respective surfaces of the support element (e.g., the respective surfaces of the support element are tapped concurrently with separate objects (e.g., two different fingers of a hand of the user of the computer system)). Performing an operation in an environment in response to an input that includes concurrent contact on multiple respective surfaces of a support element reduces the likelihood that the operation is performed when the user does not intend it to be performed in the environment (e.g., by assigning the operation to an input that includes concurrent contact on different surfaces of the support element), thereby reducing errors in user-device interaction, and helping reduce the need for input to correct such unintended operations.

In some embodiments, the multiple respective surfaces of the support element are the second surface of the support element and a third surface, different from the first surface and the second surface, of the support element, such as second surface 738b and third surface 738c of support element 702 shown in FIG. 7M. In some embodiments, the multiple respective surfaces of the support element correspond to a top surface of the support element and a bottom surface of the support element. For example, the second surface corresponds to the top surface of the support element and the third surface corresponds to the bottom surface of the support element. In some embodiments, the first input corresponds to a pinch input (e.g., a first finger of the user taps the top surface of the support element while a second finger of the user concurrently taps the bottom surface of the support element (e.g., such that the support element is pinched between the first finger and the second finger of the user)). In some embodiments, the multiple respective surfaces do not include the first surface of the support element (e.g., a side surface of the support element). Performing an operation in an environment in response to concurrent contact on a second surface (e.g., top surface) and third surface (e.g., bottom surface) of a support element, and not a first surface (e.g., side surface) of the support element reduces the likelihood that the operation is performed when the user does not intend it to be performed in the environment (e.g., by assigning the operation to an input that includes concurrent contact on the second surface and the third surface of the support element), thereby reducing errors in user-device interaction, and helping reduce the need for input to correct such unintended operations.

In some embodiments, in response to detecting the first input, in accordance with a determination that the first input includes contact on the third surface of the support element without including contact on the first surface of the support element or the second surface of the support element, the computer system forgoes performing an operation that changes the appearance of the at least the portion of the environment when viewed via the environment viewing component, such as computer system 101 forgoing performing an operation in environment 700 in response to the touch input detected on third surface 738c of support element 702 in FIG. 7J. In some embodiments, in accordance with a determination that the first input corresponds to contact on a bottom surface of the support element without contact (e.g., concurrent contact) on the top surface of the support element, the computer system forgoes performing any operation in the environment (e.g., that changes the appearance of at least a portion of the environment when viewed via the environment viewing component). For example, one or more parameters of at least a portion of the environment are not changed. For example, the display of one or more virtual objects in at least a portion of the environment is not changed/updated. Performing an operation in an environment in response to contact on multiple surfaces, including a respective surface, of a support element, and not performing the operation in response to contact on only the respective surface reduces the likelihood that the operation is performed when the user does not intend it to be performed (e.g., by requiring an input that includes contact on the respective surface and an additional surface of the support element), thereby reducing errors in user-device interaction, and helping reduce the need for input to correct such unintended operations.

In some embodiments, after detecting the first input, the computer system detects, via the one or more input devices, a second input corresponding to a request to perform an operation that changes an appearance of at least a portion of the environment when viewed via the environment viewing component, such as a touch input shown in FIGS. 7U-7V. In some embodiments, the second input has one or more characteristics of the first input described above (e.g., with reference to step(s) 802). In some embodiments, the at least the portion of the environment has one or more characteristics of the at least the portion of the environment described above (e.g., with reference to step(s) 802).

In some embodiments, in response to detecting the second input, in accordance with a determination that the second input includes a first gesture performed by a portion of a user of the computer system on a surface of the support element, the computer system performs a third operation that changes an appearance of at least a portion of the environment when viewed via the environment viewing component, such as changing optical focus appearance of environment 700 in response to the movement input detected on first surface 740a of first support element 712a in FIG. 7T. In some embodiments, the portion of the user of the computer system has one or more characteristics of the first portion of the user of the computer system described above. In some embodiments, the third operation has one or more characteristics of the first operation described above (e.g., with reference to step(s) 802). In some embodiments, the first gesture has one or more characteristics of the first gesture and/or the second gesture described above.

In some embodiments, in accordance with a determination that the second input includes the first gesture on a surface of a second support element, different from the support element, of the computer system, the computer system performs a fourth operation, different from the third operation, that changes an appearance of at least a portion of the environment when viewed via the environment viewing component, such as changing the brightness of environment 700 in response to the movement input detected on first surface 742a of second support element 712b in FIG. 7S. In some embodiments, the first gesture performed by the portion of the user on the surface of the support element does not include contact performed on the second support element (e.g., the first gesture performed on the support element only includes contact on a surface of the support element). In some embodiments, the first gesture performed by the portion of the user on the surface of the second support element does not include contact performed on the support element (e.g., the first gesture performed on the second support element only includes contact on a surface of the second support element). In some embodiments, the second support element has one or more characteristics of the support element described with reference to step(s) 802. For example, the computer system is a wearable device, and the support element and the second support element enable the computer system to be worn by the user of the computer system (e.g., the support element is a first support arm (e.g., a first glasses arm) and the second support element is a second support arm (e.g., a second glasses arm)). In some embodiments, the support element is a strap or band (e.g., a bracelet or watch band) worn on a first portion of the user (e.g., on a first wrist of the user) and the second support element is a strap or band (e.g., a bracelet or watch band) worn on a second portion of the user (e.g., on a second wrist of the user). In some embodiments, the second support element includes one or more touch-sensitive surfaces (e.g., having one or more characteristics of the first surface and/or the second surface described with reference to step(s) 802). In some embodiments, the third operation changes the appearance of the at least the portion of the environment differently than the fourth operation. In some embodiments, the third operation and the fourth operation change different parameters of at least a portion of the environment (e.g., the third operation changes the brightness of the environment, and the fourth operation changes a magnification of the environment). In some embodiments, the third operation and the fourth operation change the display of one or more virtual objects in different manners (e.g., the third operation navigates one or more virtual objects, and the fourth operation moves one or more virtual objects in the environment). In some embodiments, the third operation changes a parameter of at least a portion of the environment, and the fourth operation changes the display of one or more virtual objects in at least a portion of the environment. In some embodiments, the third operation changes the display of one or more virtual objects in at least a portion of the environment, and the fourth operation changes a parameter of at least a portion of the environment. In some embodiments, the support element is associated with a first set of operations that change an appearance of at least a portion of the environment, and the second support element is associated with a second set of operations, different from the set of first operations, that change an appearance of at least a portion of the environment. In some embodiments, different operations of the first set of operations are associated with different surfaces of the support element (e.g., a first surface of the support element is associated with brightness, and a second surface is associated with optical focus appearance of at least a portion of the environment). In some embodiments, different operations of the second set of operations are associated with different surfaces of the second support element (e.g., a first surface of the second support element is associated with navigation of one or more virtual objects, and a second surface of the second support element is associated with movement of one or more virtual objects in the environment). In some embodiments, in accordance with a determination that the second input includes a second gesture, different from the first gesture, performed by the portion of the user of the computer system on a surface of the support element, the computer system performs a fifth operation, different from the third operation, that changes the appearance of at least a portion of the environment when viewed via the environment viewing component. In some embodiments, in accordance with a determination that the second input includes a third gesture (e.g., the same as the second gesture), different from the first gesture, performed by the portion of the user of the computer system on a surface of the second support element, the computer system performs a sixth operation, different from the fourth operation (e.g., and the fifth operation), that changes an appearance of at least a portion of the environment when viewed via the environment viewing component. Performing a first operation based on an input that includes contact on a first support element of a computer system and a second operation (e.g., different from the first operation) based on an input that includes contact on a second support element of the computer system reduces the likelihood that an operation is performed using the support elements of the computer system that a user does not intend to be performed (e.g., by assigning the first operation and the second operation to different support elements of the computer system), thereby reducing errors in user-device interaction, and helping reduce the need for input to correct such unintended operations.

In some embodiments, the first input on the support element is detected while the computer system has a first spatial relationship with a first portion of the user of the computer system, such as while user 704 is wearing computer system 101 in FIG. 7A. In some embodiments, the computer system is a wearable device, and the first input is detected while the user of the computer system is wearing the computer system. In some embodiments, the first portion of the user is the head, forehead, nose and/or ears of the user. In some embodiments, the first portion of the user is a hand, arm, and/or wrist of the user.

In some embodiments, after detecting the first input, the computer system detects, via the one or more input devices, a second input on the support element while the computer system has a second spatial relationship, different from the first spatial relationship, with the first portion of the user of the computer system, such as the touch input detected on first surface 738a while computer system 101 is not being worn by user 704 in FIG. 7W. In some embodiments, the second input has one or more characteristics of the first input described above (e.g., with reference to step(s) 802). For example, the second input is a same type of input (e.g., a tap or swipe gesture) as the first input. In some embodiments, the computer system is a wearable device, and the second input on the support element is detected when a user is not wearing the computer system. For example, the second input is detected while a user is handling the computer system, while taking off the computer system, or putting on the computer system (e.g., the user grabs the support element of the computer system while placing the computer system on the first portion of the user (e.g., on the head of the user)). For example, the second input is detected while the computer system is off a head, forehead, nose, ears, hand, wrist, and/or arm of the user of the computer system. In some embodiments, the second input is detected on a same surface (e.g., the first surface, second surface and/or third surface) of the support element as the first input. At least a portion of the one or more input devices (e.g., including one or more touch sensors) are optionally not operational while the second input is received (e.g., the one or more input devices do not detect the second input (e.g., because the one or more input devices are not active and/or powered on) though the computer system is still being worn by the user, for example). In some embodiments, the second input is performed after an event corresponding to terminating use of the computer system. In some embodiments, the event includes the user of the computer system taking off the computer system (e.g., the computer system is a wearable device, and the user of the computer system removes the computer system from a portion (e.g., head, forehead, nose, ears, hand, wrist, and/or arm) of the user). In some embodiments, the event corresponds to an input detected by the computer system corresponding to a request to cease operation of the computer system (e.g., a request to cease viewing the environment via the environment viewing component). For example, the input is detected at a hardware input device (e.g., a hardware button and/or dial). For example, the input is detected through interaction with one or more virtual elements displayed in the environment (e.g., selection of an affordance displayed in the environment for terminating use of the computer system). For example, the input is a verbal input (e.g., a verbal command), received at an input device (e.g., audio sensor and/or microphone) of the one or more input devices. In some embodiments, the event corresponds to inaction (e.g., no user inputs are detected by the computer system) by a user of the computer system for more than a threshold amount of time (e.g., 1, 2, 5, 10, 15, 30, 60, or 120 minutes). In some embodiments, the first input corresponds to a request to sign-off and/or log-off of a user account and/or profile associated with the environment and/or the computer system (e.g., the input is provided by the user of the computer system through a user interface displayed in the environment).

In some embodiments, in response to detecting the second input, the computer system forgoes performing one or more operations that change an appearance of at least a portion of the environment when viewed via the environment viewing component in accordance with the second input, such as forgoing changing the brightness of environment 700 in FIG. 7X in response to the touch input detected by computer system 101 in FIG. 7W. In some embodiments, in response to detecting the second input, the computer system does not change an appearance of at least a portion of the environment (e.g., does not update a parameter of the environment). In some embodiments, in response to detecting the second input, the computer system does not update the display of one or more virtual objects in the environment. In some embodiments, in accordance with a determination that the second input is detected by the computer system prior to the event corresponding to terminating use of the computer system, the computer system performs one or more operations that change an appearance of at least a portion of the environment when viewed via the environment viewing component. In some embodiments, in accordance with at least a portion of the one or more input devices (e.g., including one or more touch sensors) not being operational while the second input is performed, the computer system does not change an appearance of at least a portion of the environment (e.g., because the second input is not detected by the computer system). In some embodiments, after detecting the first input, the computer system detects, via the one or more input devices, an input on the support element of the computer system. In some embodiments, in accordance with a determination that the computer system has the first spatial relationship with the first portion of the user of the computer system (e.g., the computer system is worn by the user of the computer system), the computer system performs an operation that changes an appearance of at least a portion of the environment when viewed via the environment viewing component (e.g., the operation having one or more characteristics of the first operation or the second operation described above). In some embodiments, in accordance with a determination that the computer system has the second spatial relationship, different from the first spatial relationship, with the first portion of the user of the computer system (e.g., the computer system is not being worn by the user of the computer system), the computer system forgoes performing an operation that changes an appearance of at least a portion of the environment when viewed via the environment viewing component in accordance with the input. Forgoing performing one or more operations in an environment in response to contact on a support element of a computer system while the computer system has a changed spatial relationship with a portion of a user of the computer system (e.g., while the user is taking off the computer system) conserves computing resources and battery life and allows the computer system to be physically moved (e.g., using the support element) without causing unintended user inputs, thereby reducing errors in interaction. One of ordinary skill in the art would recognize various ways to reorder the operations described herein. In some embodiments, aspects/operations of method 800 may be reordered.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising: at a computer system in communication with an environment viewing component and one or more input devices:
while an environment is visible, via the environment viewing component, from a current viewpoint of a user of the computer system, detecting, via the one or more input devices, a first input on a support element of the computer system corresponding to a request to perform an operation that changes an appearance of at least a portion of the environment when viewed via the environment viewing component; and
in response to detecting the first input:
in accordance with a determination that the first input includes contact on a first surface of the support element, performing a first operation that changes an appearance of at least a portion of the environment when viewed via the environment viewing component; and
in accordance with a determination that the first input includes contact on a second surface, different from the first surface, of the support element, performing a second operation, different from the first operation, that changes an appearance of at least a portion of the environment when viewed via the environment viewing component.

2. The method of claim 1, wherein the first input includes a tap on the support element of the computer system.

3. The method of claim 1, wherein the first input includes detected movement on the support element of the computer system.

4. The method of claim 1, wherein performing the first operation includes:
in accordance with a determination that the first input corresponds to a first gesture performed by a first portion of a user of the computer system, performing a third operation corresponding to the first gesture, and
in accordance with a determination that the first input corresponds to a second gesture, different from the first gesture, performed by the first portion of the user, performing a fourth operation corresponding to the second gesture, wherein the fourth operation is different from the third operation.

5. The method of claim 4, wherein:
performing the third operation corresponds to changing a first parameter of the at least the portion of the environment in a first manner, and
performing the fourth operation corresponds to changing the first parameter of the at least the portion of the environment in a second manner, different from the first manner.

6. The method of claim 5, wherein the first gesture includes one or more stationary inputs and the second gesture includes a movement input.

7. The method of claim 6, wherein:
changing the first parameter of the at least the portion of the environment in the first manner includes updating a value of the first parameter to be a first value of a plurality of values of the first parameter corresponding to the one or more stationary inputs, and
changing the first parameter of the at least the portion of the environment in the second manner includes updating the value of the first parameter to a second value of the first parameter corresponding to the movement input.

8. The method of claim 7, wherein updating the value of the first parameter to the second value of the first parameter includes continuously changing the value of the first parameter while detecting the movement input.

9. The method of claim 7, wherein:
in accordance with a determination that the movement input satisfies first criteria, updating the value of the first parameter to the second value of the first parameter includes changing the first parameter to a respective value of the plurality of values of the first parameter; and
in accordance with a determination that the movement input satisfies second criteria, updating the value of the first parameter to the second value of the first parameter includes changing the first parameter to a value of the first parameter different from the respective value of the plurality of values of the first parameter.

10. The method of claim 5, wherein the first gesture includes movement of the first portion of the user on the support element of the computer system with less than a threshold velocity, and the second gesture includes movement of the first portion of the user on the support element with greater than the threshold velocity.

11. The method of claim 10, wherein:
performing the third operation corresponding to changing the first parameter of the at least the portion of the environment in the first manner includes changing a value of the first parameter from a first value to a second value, different from the first value, wherein a difference between the first value and the second value is based on a distance of movement of the first portion of the user, and
performing the fourth operation corresponding to changing the first parameter of the at least the portion of the environment in the second manner includes changing the value of the first parameter from the first value to a respective value of a plurality of values of the first parameter, wherein a difference between the first value and the respective value is independent of a distance of movement of the first portion of the user.

12. The method of claim 11, wherein the plurality of values of the first parameter includes a maximum value of the first parameter and a minimum value of the first parameter.

13. The method of claim 11, wherein the plurality of values of the first parameter includes one or more intermediate values between a maximum value of the first parameter and a minimum value of the first parameter.

14. The method of claim 1, wherein:
the environment viewing component includes a display generation component,
the environment includes one or more virtual objects displayed via the display generation component, and
the first operation is performed on at least a portion of the one or more virtual objects in the environment.

15. The method of claim 14, wherein the one or more virtual objects include one or more virtual elements, and updating display of the at least the portion of the one or more virtual objects includes navigating through the one or more virtual elements.

16. The method of claim 14, wherein the one or more virtual objects include one or more selectable options, and updating display of the at least the portion of the one or more virtual objects includes selecting a selectable option of the one or more selectable options.

17. The method of claim 1, wherein performing the second operation includes changing a first parameter of the at least the portion of the environment corresponding to a visual emphasis of the at least the portion of the environment.

18. The method of claim 17, wherein the first parameter is an optical focus based on which the at least the portion of the environment is visible from the current viewpoint of the user.

19. The method of claim 18, wherein:
the environment viewing component includes a variable optical component, and
the optical focus is changed using the variable optical component.

20. The method of claim 17, wherein the first parameter is a brightness of the at least the portion of the environment.

21. The method of claim 17, wherein changing the first parameter of the at least the portion of the environment includes continuously changing the first parameter of the at least the portion of the environment while detecting the first input.

22. The method of claim 17, wherein changing the first parameter of the at least the portion of the environment includes changing a value of the first parameter from a first value to a respective value of a plurality of values of the first parameter.

23. The method of claim 1, wherein the first input is an input of a first type, the method further comprising:
after detecting the first input, detecting, via the one or more input devices, a second input on the support element of the computer system corresponding to an input of a second type; and
in response to detecting the second input, performing a third operation, different from the first operation and the second operation, that changes an appearance of the at least the portion of the environment when viewed via the environment viewing component.

24. The method of claim 1, further comprising:
in response to detecting the first input:
in accordance with a determination that the first input includes contact on multiple respective surfaces of the support element concurrently, performing a third operation, different from the first operation and the second operation, that changes an appearance of the at least the portion of the environment when viewed via the environment viewing component.

25. The method of claim 24, wherein the multiple respective surfaces of the support element are the second surface of the support element and a third surface, different from the first surface and the second surface, of the support element.

26. The method of claim 25, further comprising:
in response to detecting the first input:
in accordance with a determination that the first input includes contact on the third surface of the support element without including contact on the first surface of the support element or the second surface of the support element, forgoing performing an operation that changes the appearance of the at least the portion of the environment when viewed via the environment viewing component.

27. The method of claim 1, further comprising:
after detecting the first input, detecting, via the one or more input devices, a second input corresponding to a request to perform an operation that changes an appearance of at least a portion of the environment when viewed via the environment viewing component; and
in response to detecting the second input:
in accordance with a determination that the second input includes a first gesture performed by a portion of a user of the computer system on a surface of the support element, performing a third operation that changes an appearance of at least a portion of the environment when viewed via the environment viewing component; and
in accordance with a determination that the second input includes the first gesture on a surface of a second support element, different from the support element, of the computer system, performing a fourth operation, different from the third operation, that changes an appearance of at least a portion of the environment when viewed via the environment viewing component.

28. The method of claim 1, wherein the first input on the support element is detected while the computer system has a first spatial relationship with a first portion of the user of the computer system, the method further comprising:
after detecting the first input, detecting, via the one or more input devices, a second input on the support element while the computer system has a second spatial relationship, different from the first spatial relationship, with the first portion of the user of the computer system; and
in response to detecting the second input, forgoing performing one or more operations that change an appearance of at least a portion of the environment when viewed via the environment viewing component in accordance with the second input.

29. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while an environment is visible, via an environment viewing component, from a current viewpoint of a user of the computer system, detecting, via one or more input devices, a first input on a support element of the computer system corresponding to a request to perform an operation that changes an appearance of at least a portion of the environment when viewed via the environment viewing component; and
in response to detecting the first input:
in accordance with a determination that the first input includes contact on a first surface of the support element, performing a first operation that changes an appearance of at least a portion of the environment when viewed via the environment viewing component; and
in accordance with a determination that the first input includes contact on a second surface, different from the first surface, of the support element, performing a second operation, different from the first operation, that changes an appearance of at least a portion of the environment when viewed via the environment viewing component.

30. A non-transitory computer readable storage medium storing one or more programs, the one or more programs comprising instructions, which when executed by one or more processors of a computer system that is in communication with a display generation component and one or more input devices, cause the computer system to perform a method comprising:
while an environment is visible, via an environment viewing component, from a current viewpoint of a user of the computer system, detecting, via one or more input devices, a first input on a support element of the computer system corresponding to a request to perform an operation that changes an appearance of at least a portion of the environment when viewed via the environment viewing component; and
in response to detecting the first input:
in accordance with a determination that the first input includes contact on a first surface of the support element, performing a first operation that changes an appearance of at least a portion of the environment when viewed via the environment viewing component; and
in accordance with a determination that the first input includes contact on a second surface, different from the first surface, of the support element, performing a second operation, different from the first operation, that changes an appearance of at least a portion of the environment when viewed via the environment viewing component.
